(19) United States
(12) Patent Application Publication
(10) Pub. No.: US 2011/0145150 A1
(43) Pub. Date: Jun. 16, 2011

(54) COMPUTERIZED VOTING SYSTEM

(76) Inventor: DANIEL WILLIAM ONISCHUK, Edmonton (CA)

(21) Appl. No.: 13/033,577

(22) Filed: Feb. 23, 2011

Related U.S. Application Data
(63) Continuation of application No. 13/007,649, filed on Jan. 16, 2011.
Application No. 13/007,649 is a continuation of application No. 12/916,640, filed on Nov. 1, 2010.
Application No. 12/916,640 is a continuation of application No. 12/860,890, filed on Aug. 21, 2010.
Application No. 12/860,890 is a continuation of application No. 12/813,519, filed on Jun. 11, 2010, now abandoned.
Application No. 12/813,519 is a continuation of application No. 12/793,694, filed on Jun. 4, 2010, now abandoned.
Application No. 12/793,694 is a continuation of application No. 12/537,657, filed on Aug. 7, 2009, now abandoned.
Application No. 12/537,657 is a continuation of application No. 12/475,444, filed on May 29, 2009, now abandoned.
Application No. 12/475,444 is a continuation of application No. 12/131,055, filed on May 31, 2008, now abandoned.
Application No. 12/131,055 is a continuation of application No. 11/765,310, filed on Jun. 19, 2007, now abandoned.
Application No. 11/765,310 is a continuation of application No. 11/738,191, filed on Apr. 20, 2007, now abandoned.
Application No. 11/738,191 is a continuation of application No. 11/627,174, filed on Jan. 25, 2007, now abandoned.
Application No. 11/627,174 is a continuation of application No. 11/555,204, filed on Oct. 31, 2006, now abandoned.
Application No. 11/555,204 is a continuation of application No. 10/908,941, filed on Jun. 1, 2005, now abandoned.
(60) Provisional application No. 60/521,625, filed on Jun. 7, 2004.

(30) Foreign Application Priority Data
Jul. 4, 2004 (CA) 2,469,598

(51) Int. Cl. G06Q 99/00; H04L 9/28

(52) U.S. Cl. 705/50; 705/12

(57) ABSTRACT

Officials send Eligible Voters encoded Voter Registration(s) and WHOLE Ballot(s) of this invention. Each WHOLE Ballot and Voter Registration has a MASTER part and at least one RECEIPT part that are correlated via a shared, unique group of symbols—a Random Symbolic Identifier (RSID)e. Each RSID is randomly generated and extremely difficult to guess, making it impossible to counterfeit any significant number of Ballots or Registrations. Anonymity is provided to Voters by optional private WHOLE Ballot exchanges among Registered Voters within their Voting Region. Completed MASTER Ballots are delivered by the Due Date to Officials by mail or electronically (using a security verification code) via Internet, Telephone, Fax, Email or interactive Television. Referring to RECEIPT Ballot(s), any Voter may use a telephone or electronic device(s) connected to the Internet to verify accurate processing of their MASTER Ballot.

For validation, after voting, Officials publish all Ballot and Registration RSID's.

### TECHNICAL PROBLEMS RESOLVED

1. improve accuracy, time and money savings of compiling voter lists;
2. extend the process of voting to encompass more voters by providing significantly easier access to the process of voting;
3. extend the process of voting to encompass candidates, proposals or any combination of candidates and proposals;
4. maintain security, privacy and anonymity of voter ballots cast;
5. enable voters to anonymously verify and correct the accuracy of official records of any ballots they have cast, by using electronic devices connected to communications networks;
6. prevent counterfeit ballots by special security elements and methods;
7. enable voters to verify ballots authenticity and validity by using electronic devices connected to communications networks;

### INVENTION USES

1. Elections to select political candidates to Government duty.
2. Corporate group of stockholders vote to elect a Chief Executive Officer.
3. Public vote on passing a Government Bill Proposal as a Public Law.
4. Stockholders vote to accept or reject proposals on business activities.

### BACKGROUND OF INVENTION

Although this invention was conceived without reference to existing patents, this invention differs from several existing patents significantly. The purpose of this patent is to overcome the following issues and limitations of existing patents:

### CROSS REFERENCE TO RELATED APPLICATIONS

| | | | | | |
|---|---|---|---|---|---|
| 3,141,976 | May 1974 | Hune | 6,688,517 | February 2004 | McClure |
| 6,640,138 | April 2003 | Hall & Schwartz | 6,457,643 | October 2002 | May |
| 6,722,562 | April 2004 | Weiss | 6,726,090 | April 2004 | Kargel |

Although Hall & Schwartz et al—U.S. Patent 60,540,138 refer to the use of scanning devices and scannable barcodes, the barcodes themselves are not easily human readable, nor easily compatible with translation for telephone use. Furthermore, the process of Hall & Schwartz et al implicitly violates Voter privacy as the there are means to link any persons vote to the ID number they are assigned for voting, such as visual observations of ID number, electronic interception of a generated ID number. Any Voter can also be linked to a ballot by witnesses as to date, time and place where the ballot is cast. The same implication of linking of a specific ballot to a specific Voter can also be said for the patent of Way—U.S. Pat. No. 6,457,643 Way remarks “7. A ballot paper as claimed in claim 5 or claim 6 wherein the unique identifier is generated from a Voter's position on an electoral roll, the date and time the ballot paper was issued, and an external value contributed by a key.”; Thus Officials could know when & where the specific ballot identifier was issued to a specific person, therefore the alleged privacy is penetrable through observation and deduction. Electronic surveillance technology could be used to detect electromagnetic waves emitted from devices issuing IDs which could then be sent to a portable computer that use software to determine an ID.

The patent of Weiss U.S. Pat. No. 6,722,562 involves the use of Automated Teller Machines also links a Voter to a specific card and their personal identity number (PIN). Although ATM voting cards could be exchanged among Voters, ATM machines have cameras which would record the Voters face, along with the location, date and time of the ballot cast from that particular ATM. The massive coordination of banks with government. computer software adaptation and privacy issues may prevent adopting this method. Furthermore, the magnetic field of ATM cards may be easily corrupted by mistake or intent. Due to some similarities, it should be re-emphasized that this patent was developed without prior knowledge of Kargel U.S. Pat. No. 6,726,090 or any of the other patents. This invention overcomes many disadvantages of Kargel and other patents by specifically defining unique methods of:

a. creating computer data lists to identify eligible Voters;
b. unique identifiers to trace/link Registration Forms to Voters;
c. unique identifiers to trace/link Ballots distribution to Voters;
d. providing Voters with information to facilitate voting;
e. decoupling Voters from specific ballots to provide vote anonymity;
f. collecting ballots and registrations from Voters and tracking the items received;
g. electronic voting (telephone, internet, fax, interactactive television, etc) that prevents Officials from linking any cast Ballot to any specific Voter (in Kargel, Officials do not know if the Voter is legitimate, and cannot protect Voter privacy when using any Voter-linked, identifiable ballot);
h. to use unique identifiers to distinguish MASTER Ballots and their duplicates to prevent multiple voting using both ballots at different voting locations;
i. of using at least one computer or telephone communication network; to facilitate ballot issuance, ballot replacement, ballot Validation, private verification of voting;
j. ensuring ballots may not be counterfeited, to prevent unfair influence in results;
k. providing ballots with Security Elements to assist with Authentication;
l. providing symbols and data on the ballot to reduce human processing;
m. voting to include people, proposals, or, any combination of people, proposals.
n. providing an expiry time and/or date on the ballot to limit ballot use;
o. providing additional information on the ballot to facilitate accurate completion;
p. providing additional information to help the Voter via a Voter Information Forms;

After considering Hune—U.S. Pat. No. 3,941,976 it should be noted this invention also adds: (i) assists the principles of democracy by making it easier for people to participate in voting, enabling the more accurate representation of Voters choices.

(ii) ensures the integrity of the ballots so that the processing and voting selections may be verified and adjusted by the Voter and Official persons upon detection of any processing errors after the ballot has been processed.
(iii) use of a Random Symbolic ID (RSID) and other security elements and processes so as to ensure the integrity of Ballots so that a WHOLE Ballot, MASTER part of a WHOLE Ballot, and the RECEIPT part of a WHOLE Ballot (and/or Voter Registration Form, or any other document—form of this invention) may not be easily duplicated in any quantity to significantly affect the overall percentage of vote tallies, and any such duplicates would be immediately detected and removed for investigation so as guarantee the integrity of the final tally and certified results.
(iv) additional security by use of n-dimensional matrices whose elements are accessed by encoding-decoding constituent components of VOTING RSID's or other Security Elements, are evaluated to determine data accuracy and/or authenticity.
(v) optionally applying tamper-proofing methods of signatures, dates, private passwords;
(vi) utilizing ballot activation documents prior to voting;
(vii) providing Voters receipts to confirm voting successful completing and a copy of voting;

### SUMMARY OF INVENTION

The present invention provides a method and system that improves and extends the tasks of certifying eligible voters, voter participation, ensuring accurate vote reception, tallying, verification, and error reporting. The major components of the method involve providing specially designed Ballots to a group of voters; recording Ballots received from the group of voters; tallying the votes from Ballots that were authenticated and validated; publishing the vote tallies from the group; verifying the published Ballot votes and tallies on a per-voter basis; and certifying the groups tallied Ballot votes were accurately recorded and counted. Systems are also taught herein for accomplishing these tasks in many ways, namely by use of:

1. acquiring information from computer databases and other sources to organize and construct any number of Lists of Eligible Voters; Lists of Officials, and other data relevant to the Voting Session.
2. a Paper Voting method employing the use of a carbon copy or carbonless copy paper WHOLE Ballot which comprises of a unique identifier; furthermore that this identifier be extremely difficult to guess, such as, but not limited to: Random Symbolic Identifiers, or, sequential series of unique identifiers, or, a hybrid of random and sequential identifiers;
3. Specially designed Security Elements for authentication and LIMITS OF USE data;
4. Optical barcodes and specialized symbolic codes to facilitate computer processing and security;
5. Electronic Voting methods (internet, interactive television, telephone, fax, email) are described herein this invention;

However, the particular systems discussed herein are given as some of the illustrations of particular embodiments of the invention. Other embodiments of the invention are expected to employ differing degrees of automation in providing, validating, authenticating, recording, tallying, publishing, certifying recorded and tallied votes. The systems taught and described herein are not intended to limit the application of the method claimed. The method of the invention must involve instrumentalities and combinations having different manifestations of representation, physical sizes and characteristics to suit the many corresponding physical limitations, abilities, and requirements that bear on a particular voting session or the available technology used to achieve some purpose for any voting session. The spirit of this invention will be fulfilled as long as the principles of ensuring all Eligible Voters have anonymity when casting their initial ballots, and may anonymously verify or report errors regarding the record of their ballots, thus ensuring the election system provides the intended equality for each vote cast. Accordingly, it is an object of the present invention to provide a voting method and system that allows one or more voters to completely verify the accurate recording, tally and publication of each vote on any Proposal or Candidate or any number of combinations of candidates and proposals; and it is a further object of the invention to provide: (a) a voting method and system that allows each Voter and Official to verify their votes on any Proposal or Candidate was correctly recorded, tallied and published; (b) each voter with a private RECEIPT ballot record of the voter's MASTER ballot vote; (c) a public post-polling record of all votes cast on a proposal or candidate; (d) the capability for voters to use their private RECEIPT ballot records of their cast MASTER ballot votes to verify or authorize correction of the public record of all ballots and votes cast; (e) the capability for voters to use the verified or corrected public record of all votes cast to verify or authorize correction of the tallies or summaries of votes; (f) vote verification and/or vote correction capabilities in a voting method or system that utilizes any physical, or, electronic, or, optical means of providing, receiving, recording validating, verifying, authenticating, tallying, summarizing, publishing and certifying: votes, ballots records, tallies, summaries or results; (g) a voting system the capability for voters to use the records of all Eligible Voters to verify or authorize correction of their name and contact information to any list of Eligible Voters; (h) vote verification and/or vote correction capabilities in a voting method or system that utilizes any physical, or, electronic, or, optical means of providing, receiving, recording validating, verifying, authenticating, tallying, summarizing, publishing and certifying any records, tallies, summaries or publications of any List of Eligible Voters. In addition to the foregoing, further, objects, features, and advantages of the present invention should become more readily apparent to those skilled in the art upon a reading of the following detailed description in conjunction with the drawings, wherein there are shown and illustrated as examples of embodiments of the invention. It is evident that those skilled in the art may now make numerous other uses and modifications of and departures from the specific embodiments described herein without departing from the inventive concepts. This invention is to be construed as embracing each novel feature or novel combination of novel features present in or possessed by the methods and techniques herein disclosed and is not to be limited to the spirit or scope of only these descriptions, disclosures, appended claims or drawings.

There are 29 (TWENTY-NINE) drawings included for this invention:

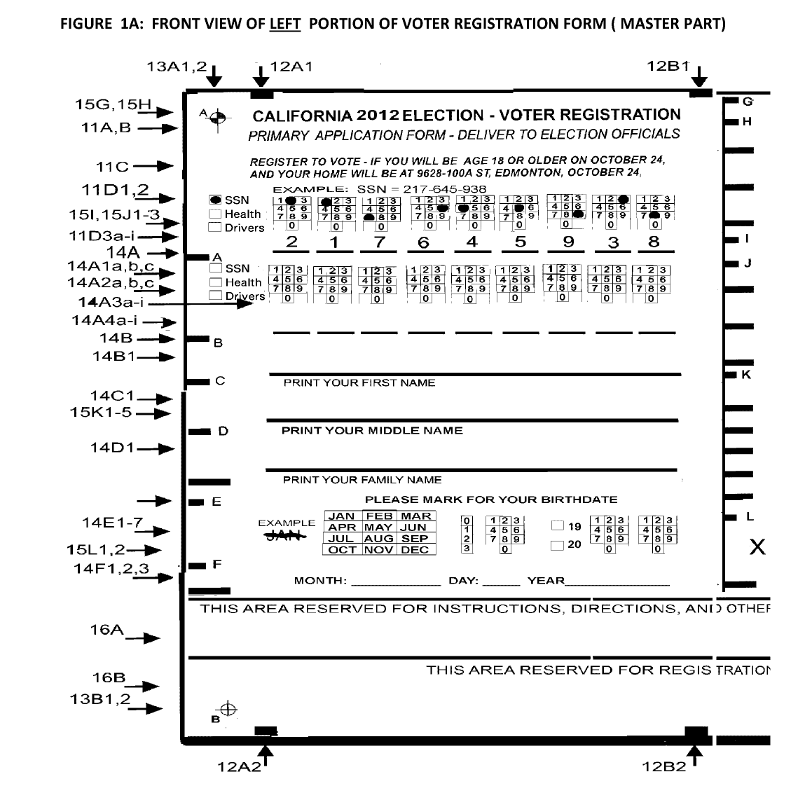

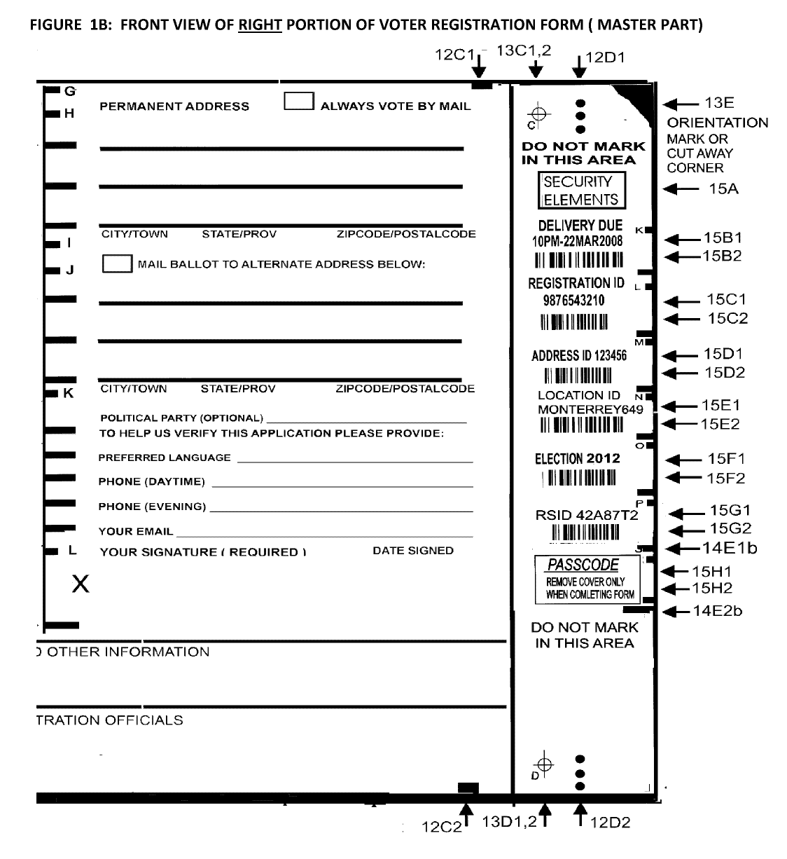

FIG. 1A: a site plan view of a FIRST embodiment of the FRONT LEFT portion of a MASTER part of a WHOLE Voter Registration Form.

FIG. 1B: a site plan view of a FIRST embodiment of the FRONT RIGHT portion of a MASTER part of a WHOLE Voter Registration Form.

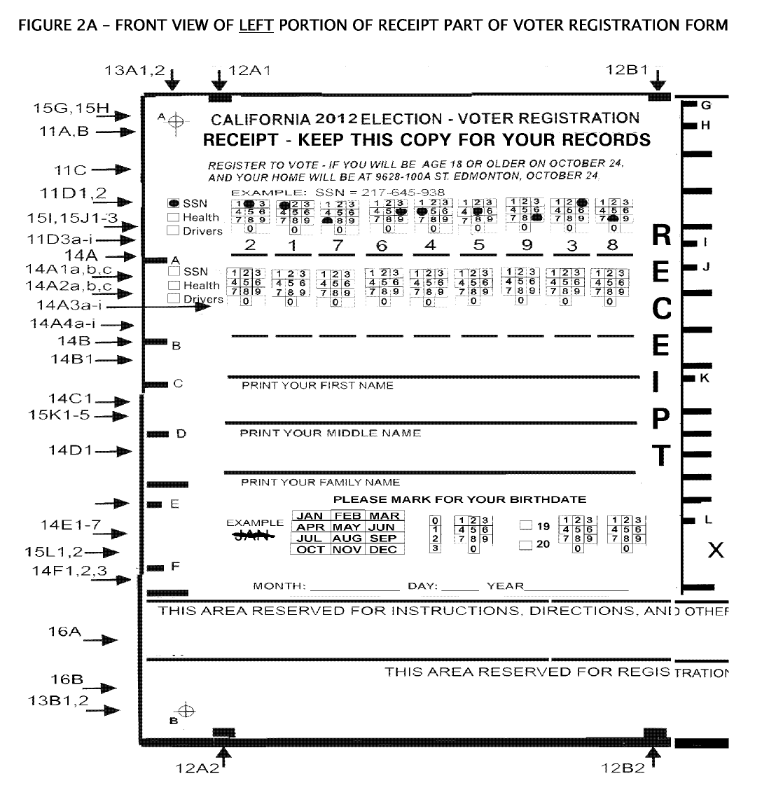

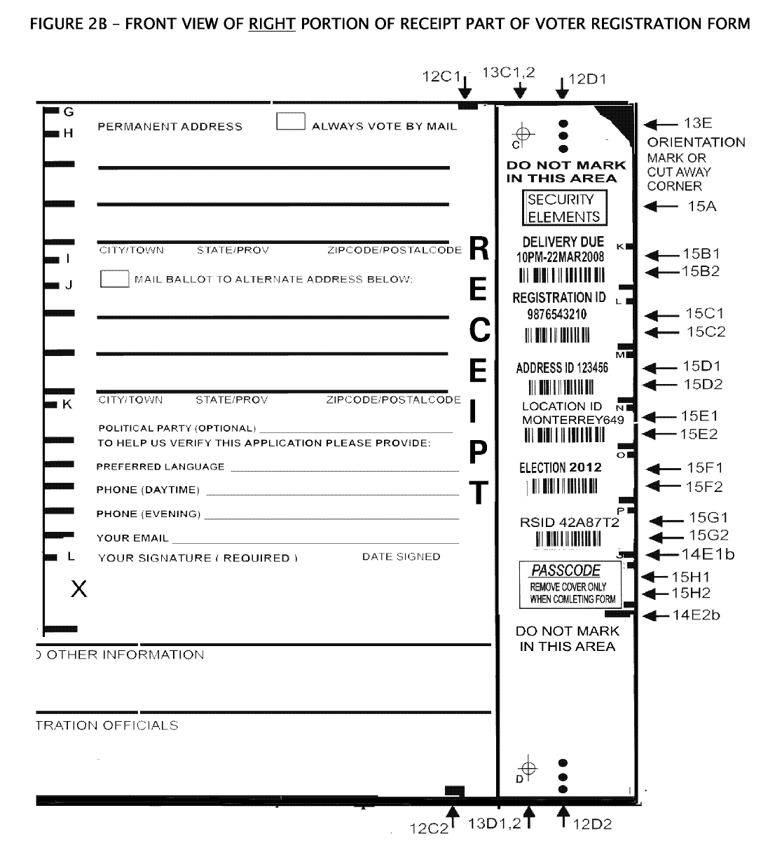

FIG. 2A: a site plan view of a FIRST embodiment of the FRONT LEFT portion of a RECEIPT part of a WHOLE Voter Registration Form.

FIG. 2B: a site plan view of a FIRST embodiment of the FRONT RIGHT portion of a RECEIPT part of a WHOLE Voter Registration Form.

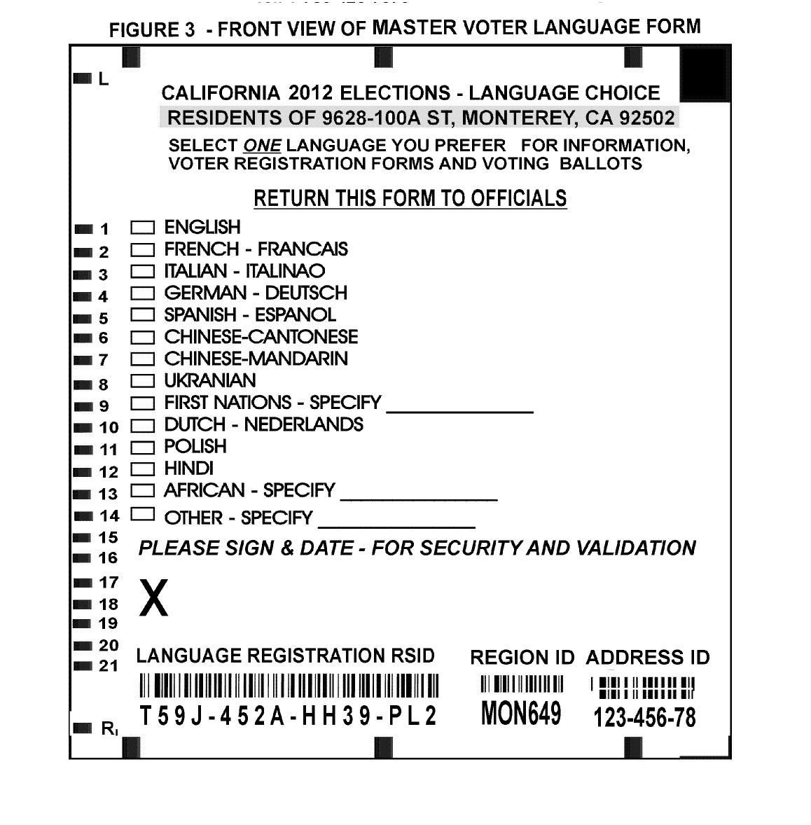

FIG. 3: a site of view for the FRONT side of a FIRST embodiment of a MASTER Voter Language Registration part of the WHOLE Voter Language Registration;

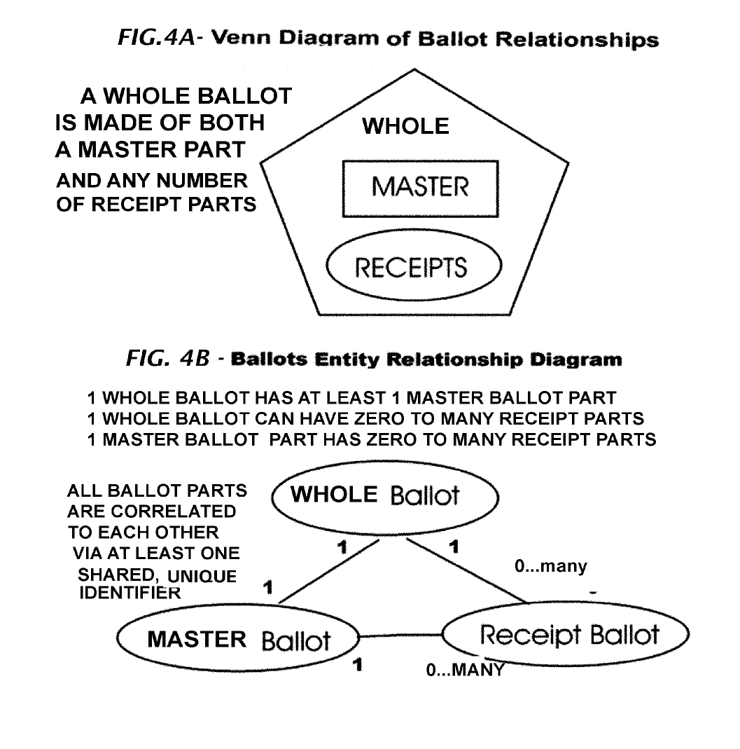

FIG. 4A: a FIRST embodiment of Venn Diagrams of Ballot parts;

FIG. 4B: a FIRST embodiment of Entity Diagram Relationships of Ballot Parts;

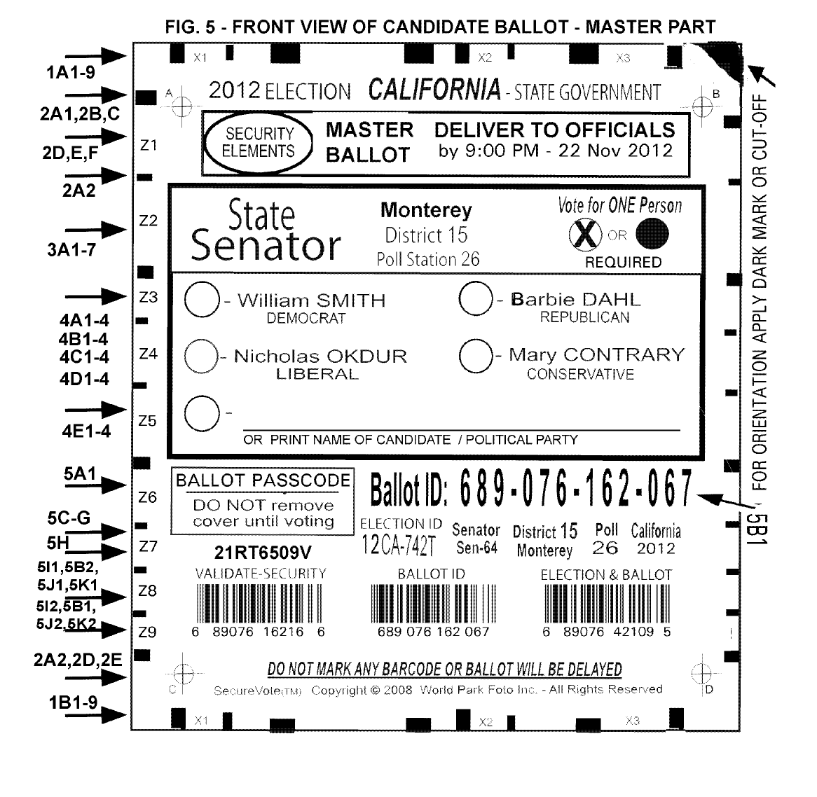

FIG. 5: a site plan view for the FRONT side of a FIRST embodiment of a MASTER Ballot part of a WHOLE Ballot of the invention.

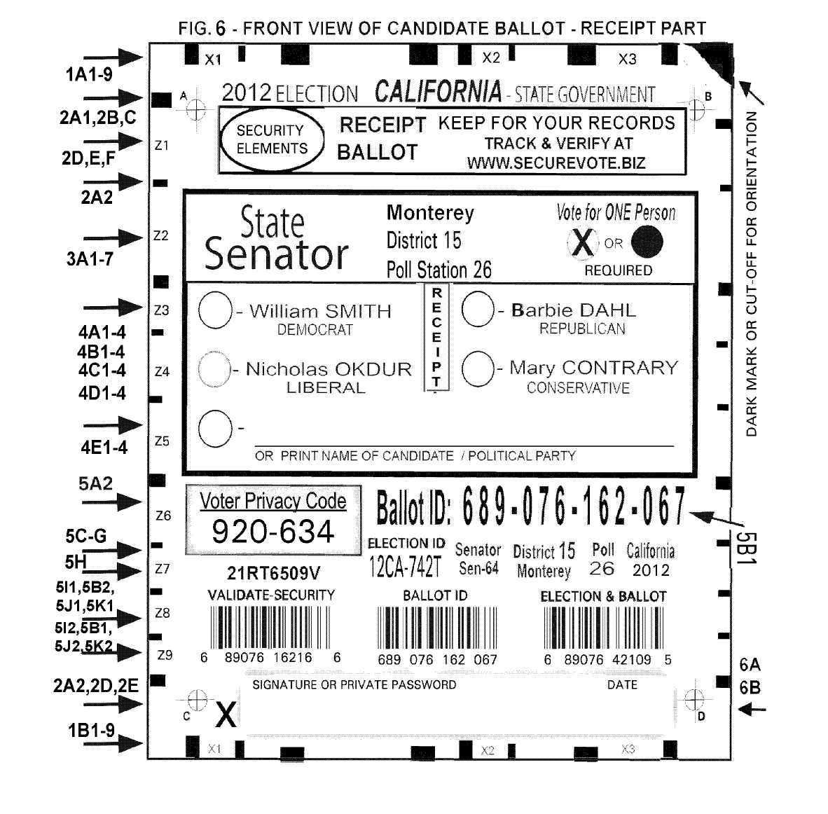

FIG. 6: a site plan view for the FRONT side of a FIRST embodiment of a RECEIPT Ballot part of a WHOLE Ballot that is correlated to FIG. 5 of this invention.

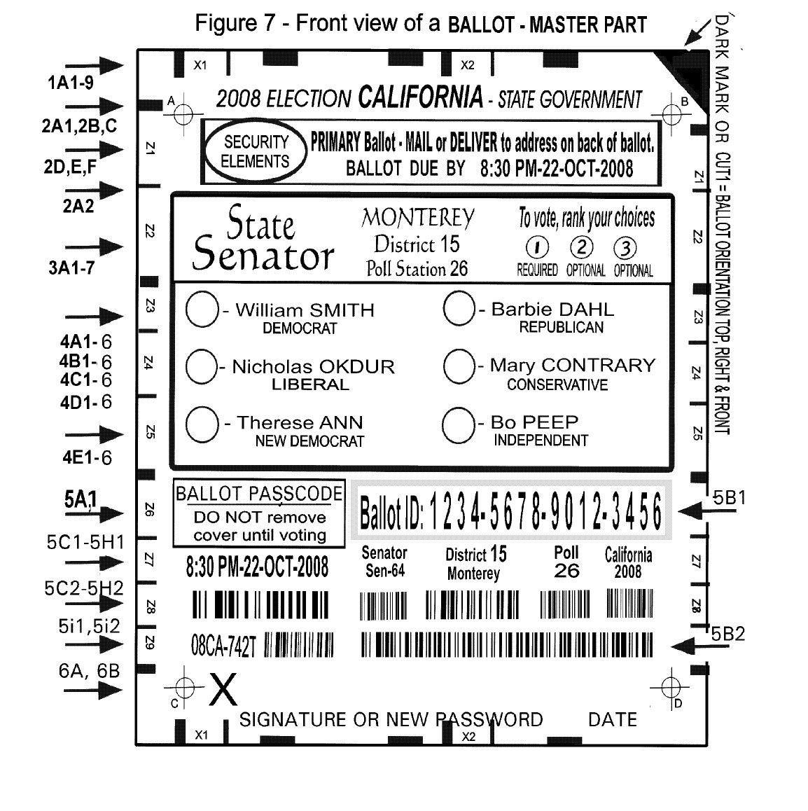

FIG. 7: a site plan view for the FRONT side of a SECOND embodiment of a MASTER BALLOT part of a WHOLE Ballot of this invention;

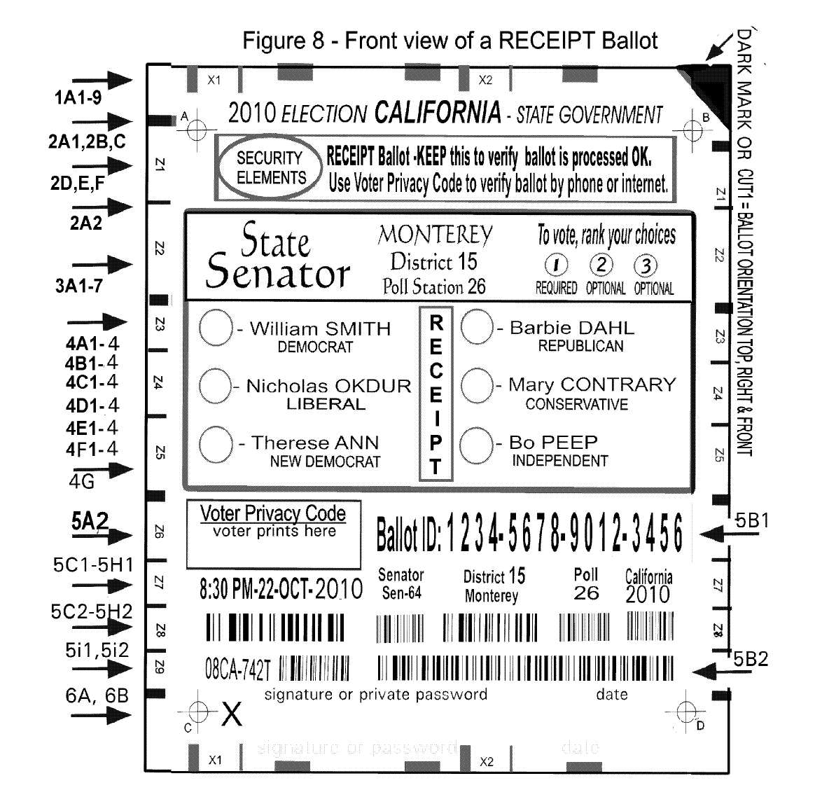

FIG. 8: a site plan view for the FRONT side of a SECOND embodiment of a RECEIPT BALLOT part of a WHOLE Ballot correlated to FIG. 7 of this invention.

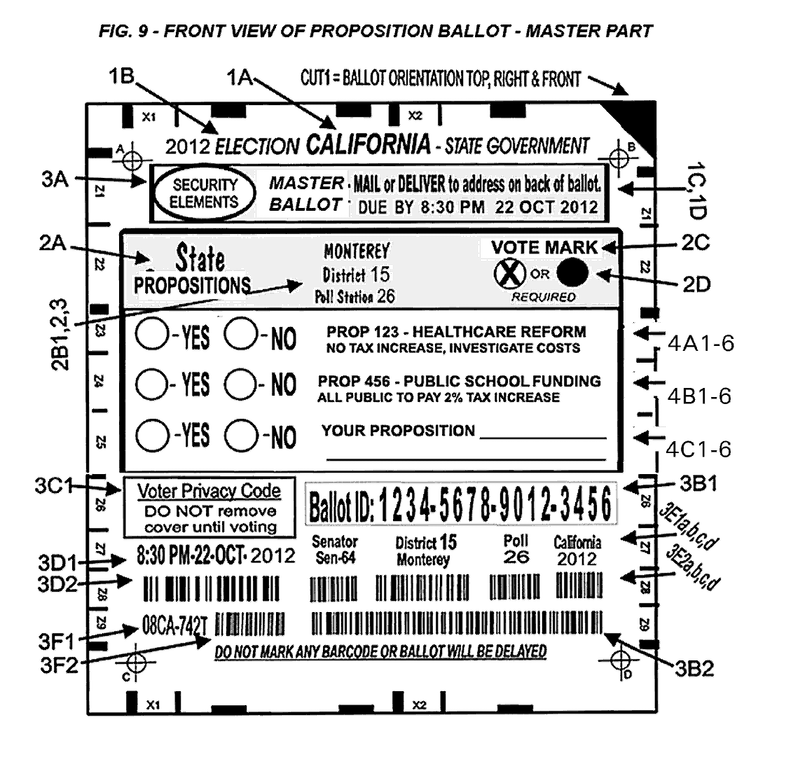

FIG. 9: a site plan view for the FRONT side of a THIRD embodiment of a MASTER BALLOT part of a WHOLE Ballot of the invention.

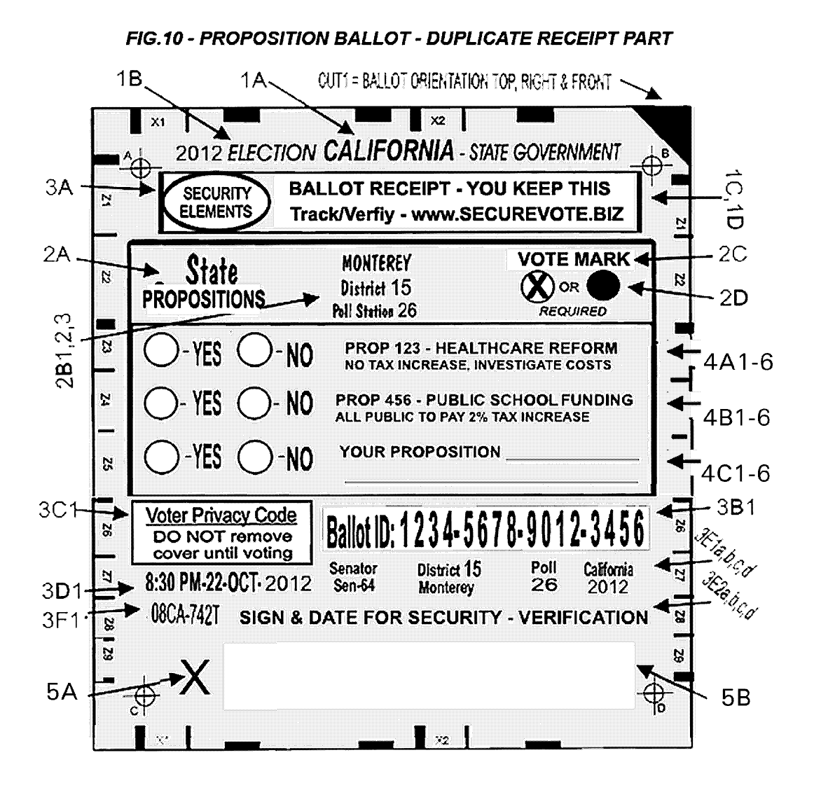

FIG. 10: a site plan view for the FRONT side of a THIRD embodiment of a RECEIPT part of a WHOLE Ballot correlated to FIG. 9 of the invention.

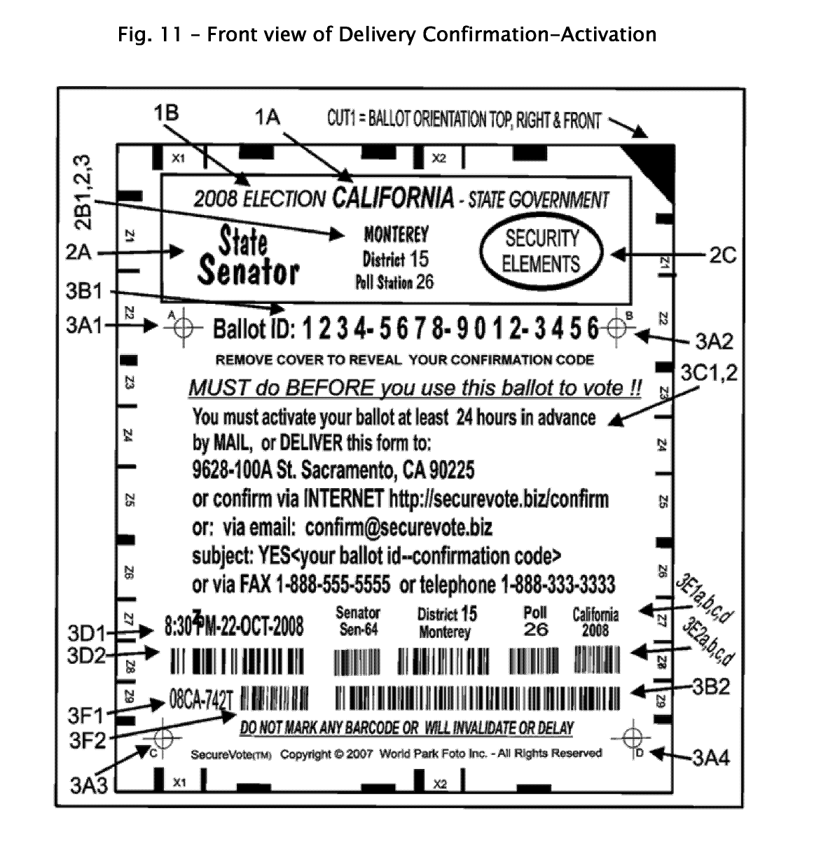

FIG. 11: a site plan view for the FRONT side of a first embodiment of a Delivery Confirmation—Activation for a WHOLE Ballot of this invention;

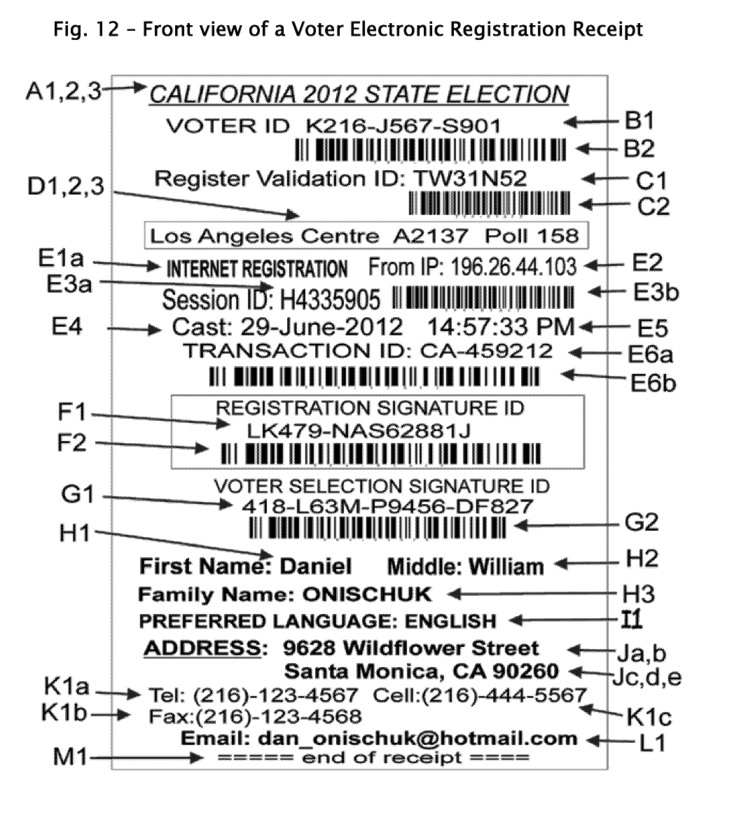

FIG. 12: a site plan view for the FRONT side of a first embodiment of a Voter Electronic Registration Receipt of the invention.

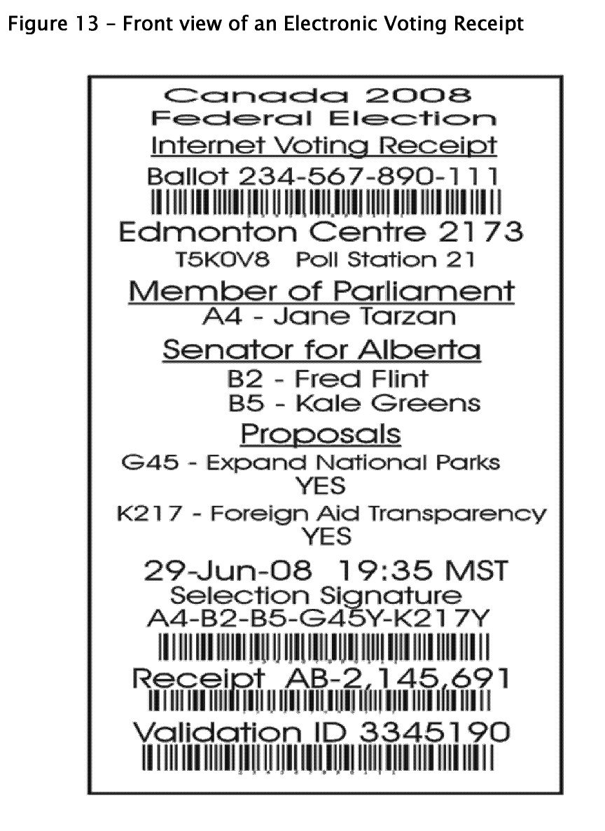

FIG. 13: a site plan view for the FRONT side for a first embodiment of an Electronic Voting RECEIPT of this invention, correlated to FIGS. 5,6,8,9,10,17,18,19,20 and with further modifications, may be correlated to FIG. 3,4,11,21,22,25.

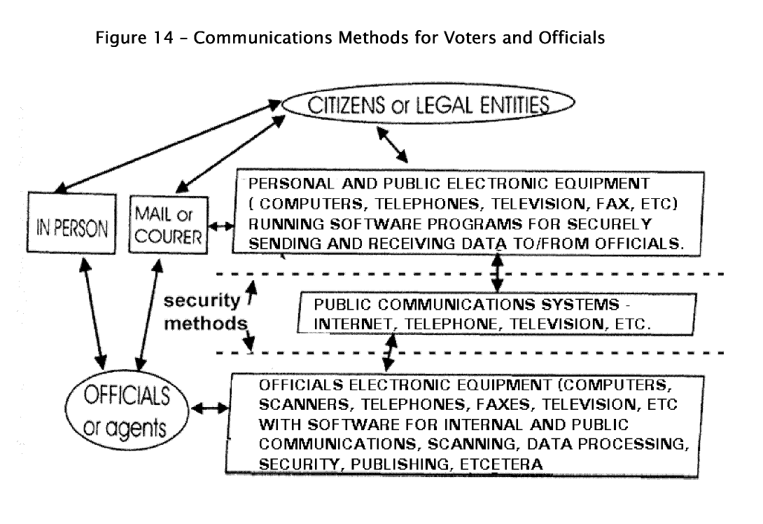

FIG. 14: a site plan view of a FIRST embodiment of a generalized information flow diagram of Communications Methods for Voters and Officials.

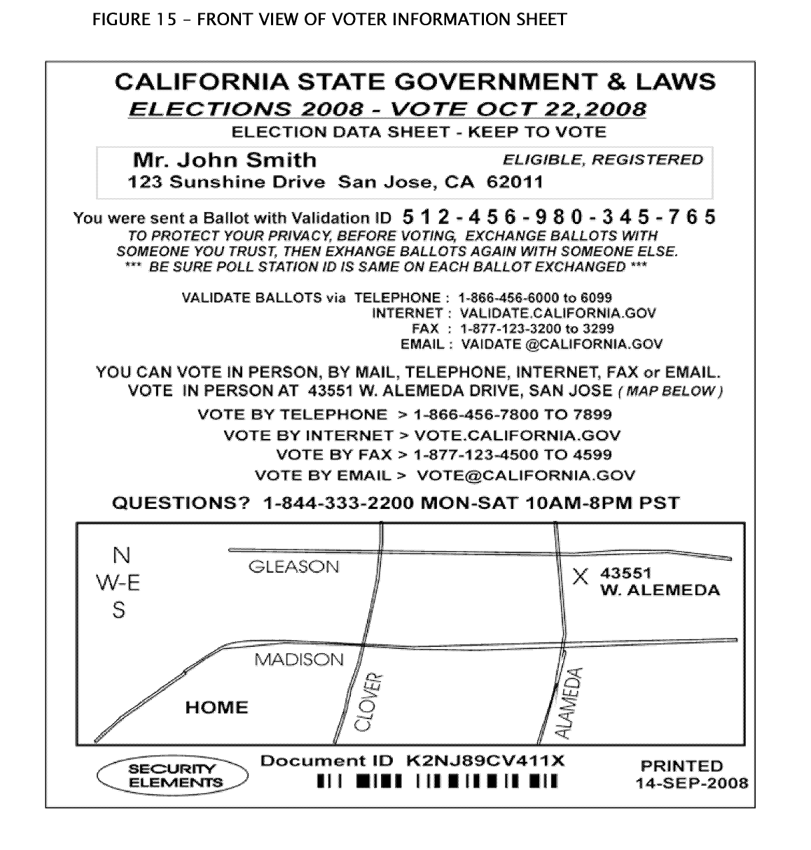

FIG. 15: a site plan view for the FRONT side of a FIRST embodiment of a Voter Ballot Information Sheet document of the invention.

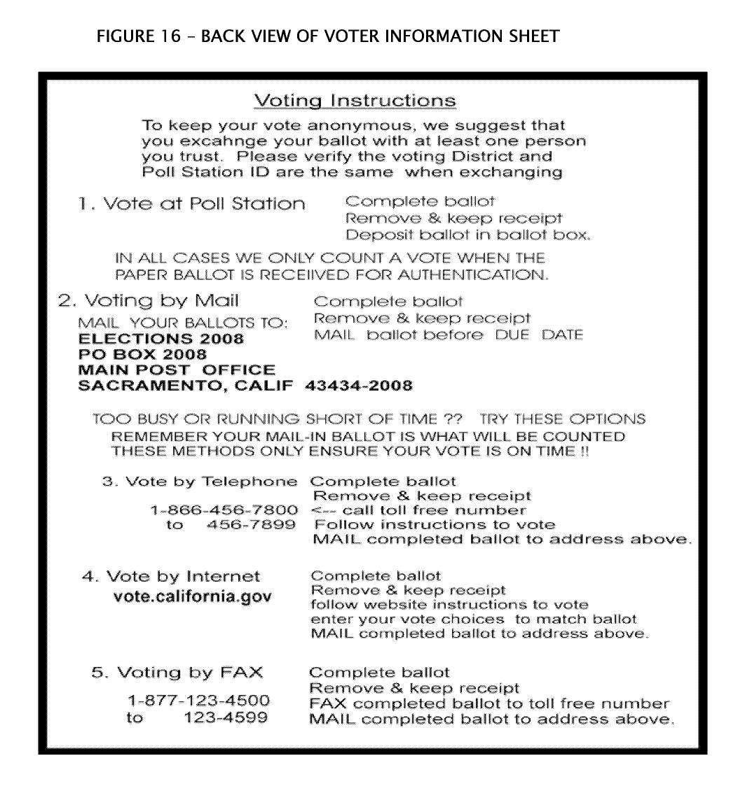

FIG. 16: a site plan view for the BACK side of a FIRST embodiment of a Voter Ballot Information Sheet document of the invention.

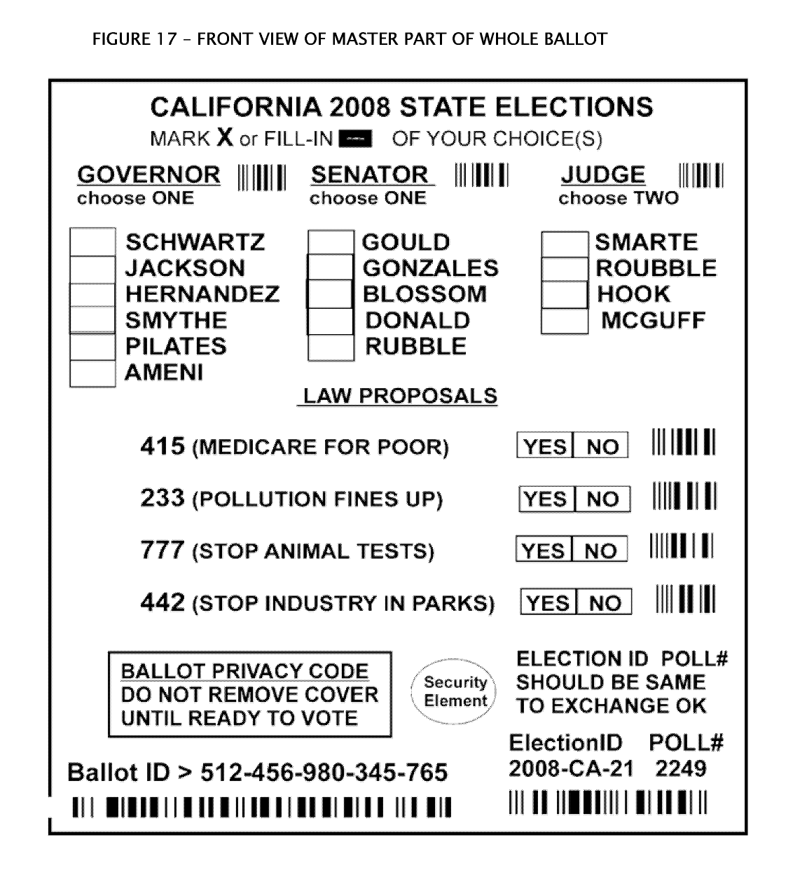

FIG. 17: a site plan view of the FRONT side of a FOURTH embodiment of a MASTER Ballot part.

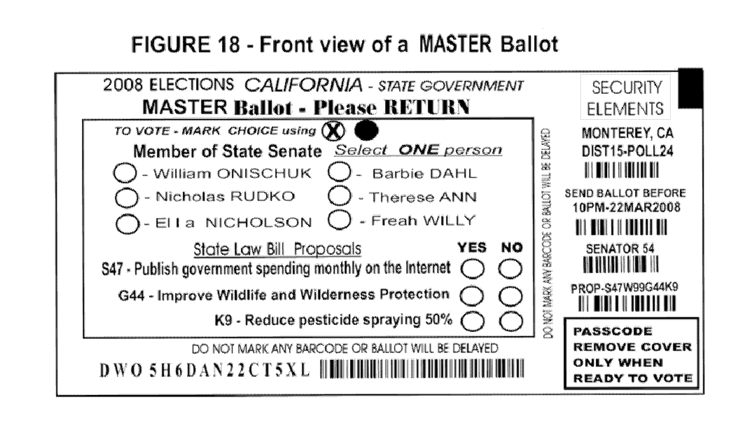

FIG. 18: a site plan view for the FRONT side of a FIFTH embodiment of a MASTER Ballot part.

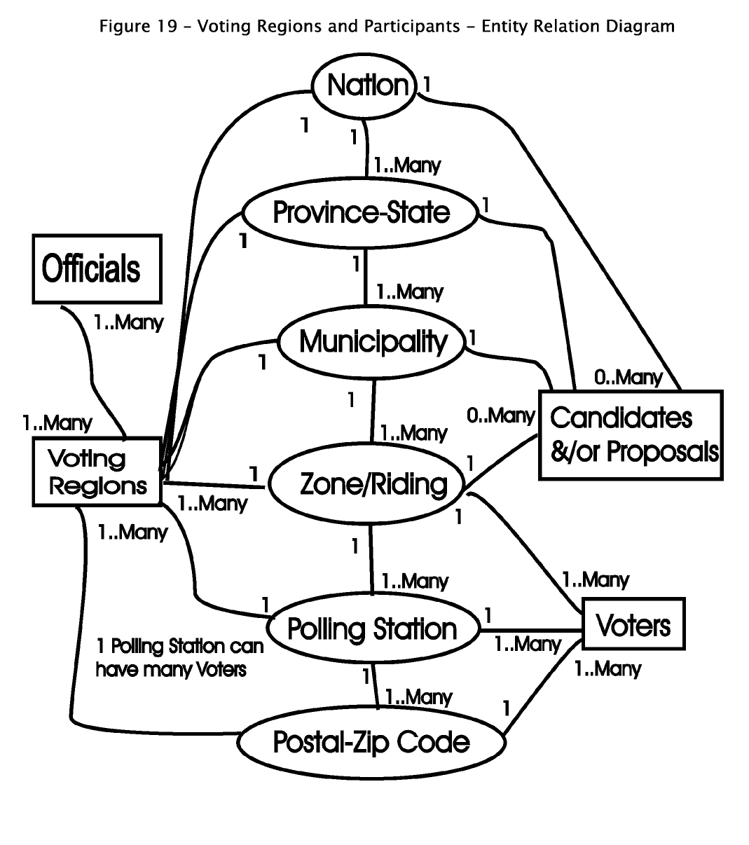

FIG. 19: a plan view of an Entity Relation Diagram of Voting Regions and Participants.

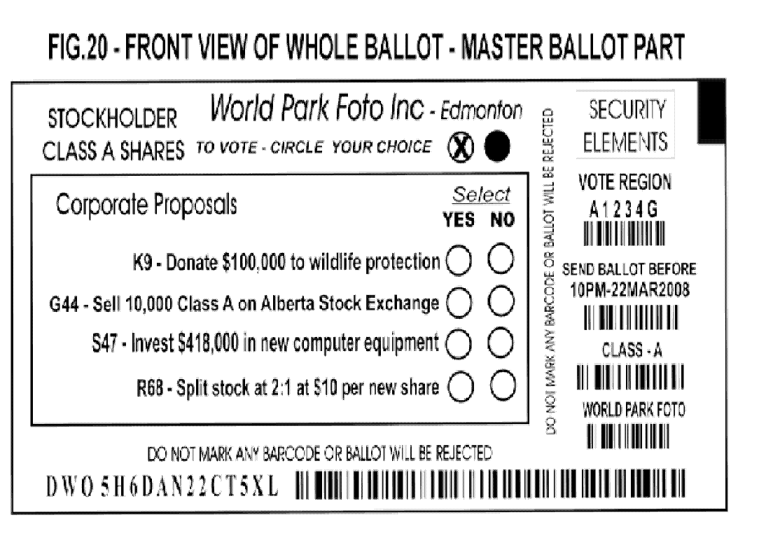

FIG. 20: a site plan view for the FRONT side of a SEVENTH embodiment of a MASTER Ballot part.

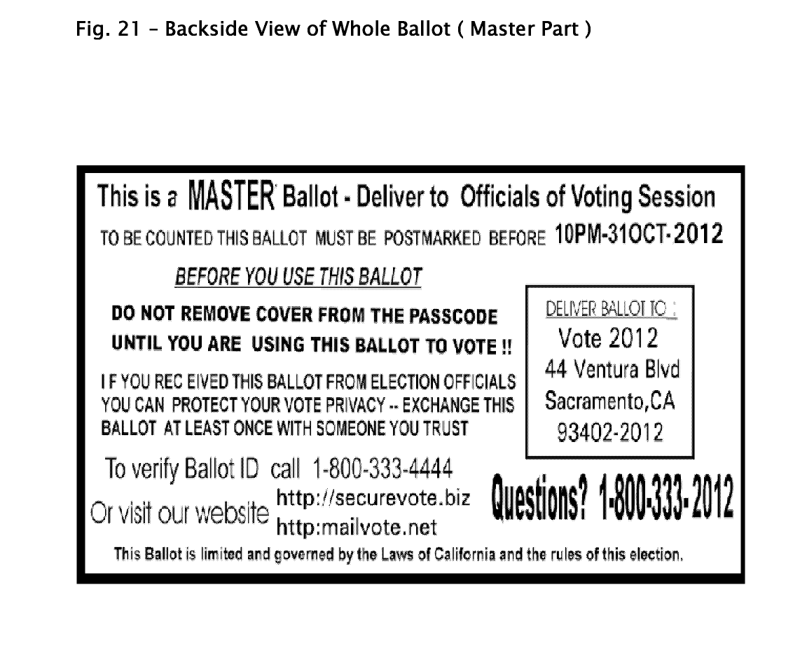

FIG. 21: a site plan view for a FIRST embodiment of the BACK side of a MASTER Ballot, OPTIONALLY correlated to FIGS. 5,7,9,17,18,19,20 of this invention; and with further modification, FIG. 21 may be alternatively be correlated to FIGS. 1A,1B for each Voter Registration Form—MASTER part, or alternatively correlated to FIG. 3 for the Voter Language Form—MASTER part.

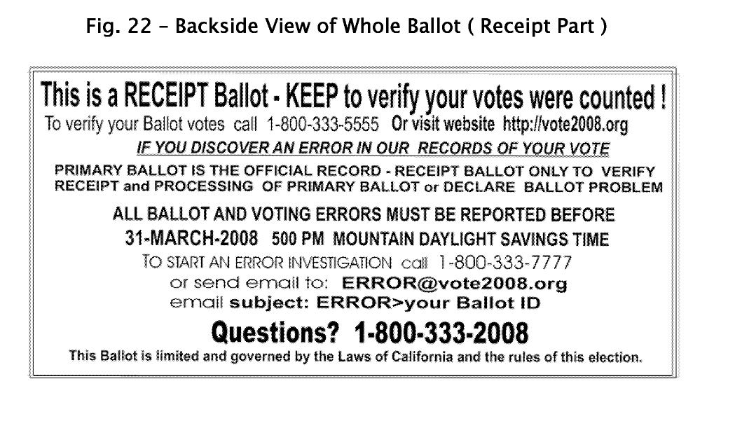

FIG. 22: a site plan view for a FIRST embodiment of the BACK side of a RECEIPT Ballot, correlated to FIGS. 6,8,10 of this invention; and with further modifications,

FIG. 22 may be correlated to FIGS. 2A,2B for Voter Registration—RECEIPT part, and/or, to an embodiment of a Voter Language Form—RECEIPT part.

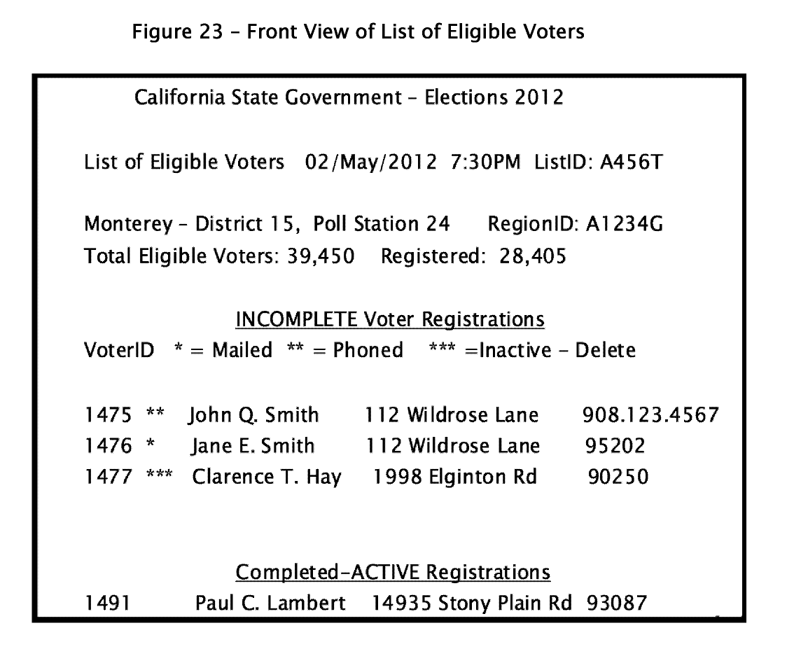

FIG. 23: a site plan view of a FIRST embodiment of a List of Eligible Voters of this invention;

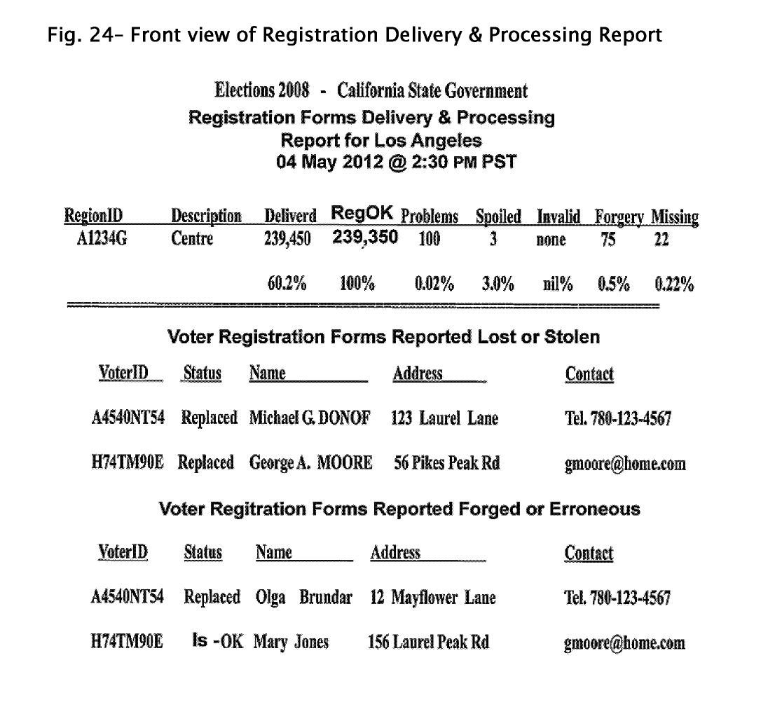

FIG. 24: a site plan view for the FRONT side of a first embodiment of a Voter Registration Forms Delivery and Processing Report of the invention;

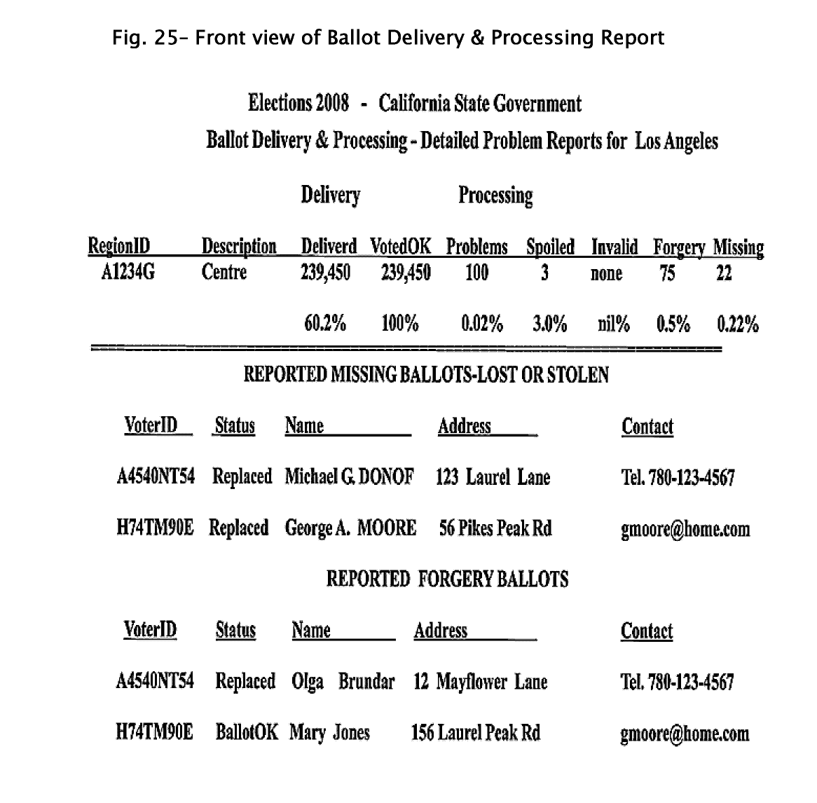

FIG. 25: a site plan view for the FRONT side of a first embodiment of a Ballot Delivery and Processing Report of the invention;

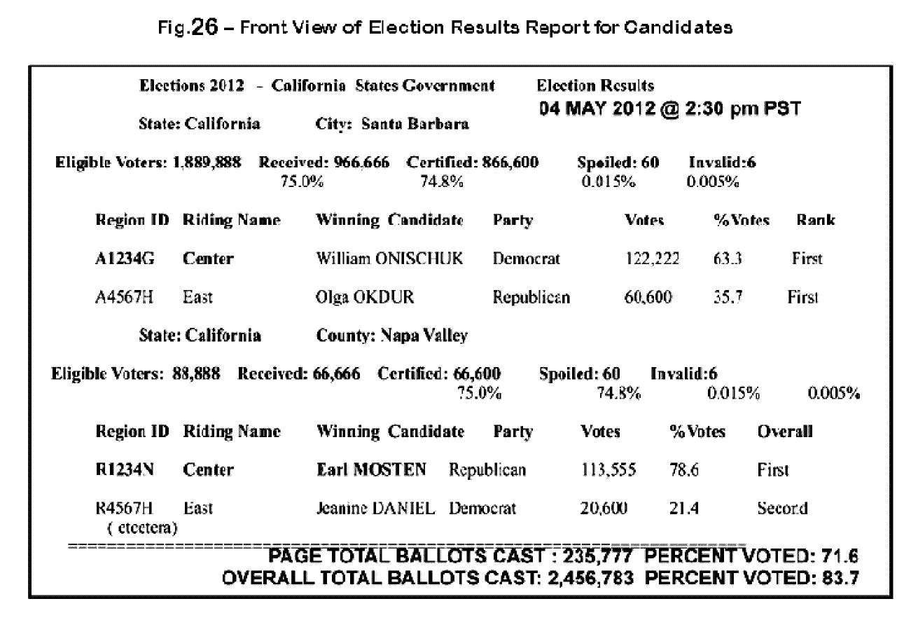

FIG. 26: a site plan view for the FRONT side of a first embodiment of a a Candidates Election Results Report of the invention;

### DISCLOSURE OF INVENTION

The methods and steps involved in the assembly of a List of Eligible Voters is unique and the first of many improvements to existing patents in this scope of invention.

### A) DEFINITIONS OF TERMS

1) Official, or, Officials—refers to any number and any combination of:
2) persons, devices, computer systems or communication networks appointed by the Hosts of the Voting Session to participate in at least one role or function to facilitate the Voting Session;
3) Voter, or, Voters, Eligible Voter, or, Eligible Voters—refers to any number of, persons, or, business entities, or any group of people or business entities, that are, or may be, entitled to participate in the Voting Session for the purpose of select any number of candidates and/or proposals, thereafter delivering their ballots to Officials for authentication and tallying;
4) Voting Session—refers to a process or series of steps and methods for at least one purpose: (i) to select candidate(s), or, (ii) to select to affirm or deny proposal(s), or (iii) any combination of selecting any number of candidates and to affirm or deny any number of proposals;
5) Voting Region is used to describe the Scope of a Voting Session—refer to Entity-Relation Diagrams of FIG. 15. Voting Region may also refer to a variable group of attributes—Province/State, Municipality, Zone, Poll Station, Postal or Zip Code.
6) The attributes are used for data storage, and may also be components of the Voting REGION, depending on the Scope of the Voting Session. Any number of Voting Region attributes may be visible on Ballots, Reports, Calculations, Tallies, Summaries, etc. set by Officials to meet Voting Session goals.

### B) DISCLOSURE OF INVENTION

### Details

B) i) an initial assessment is made to define the required tasks and estimate the labor time required to complete the required tasks to complete the Official Voting Session in the time allotted, to justify the acquisition of materials, devices and people required to timely complete the Voting Session;
B) ii) people, computers, devices, software programs, and communication systems are acquired and developed to complete the tasks of the Official Voting Session;
B) iii) a determination is made for the number of Potential Voters that could participate in the Voting Session, using data from reliable sources (such as census population data, immigration data, social security numbers or tax data for governments, stockholders or employee data for businesses; membership data for groups or professional associations;
B) iv) Officials enquire about remote sources of information that could be used to identify Potential Voters or Eligible Voters, then contact owners of each selected remote data source to obtain agreements, access permissions and methods. A unique source identifier (SID) is assigned to each remote source permission is obtained by, from, or for.
B) v) for a remote source of records to be accepted, it undergoes a preliminary inspection to assess whether it will meet standards for acceptable regarding the relative age of the data, reliability, consistency of data among records, or other quality control methods;
B) vi) remote sources of data that DO NOT pass preliminary inspection requirements are ignored or designated for further investigation at some later time and date;

For remote sources of data which DO meet First Inspection requirements:

B) vii) to determine which people or businesses are eligible to vote, Official people, or, Official computers running software programs designed to determine who are Eligible Voters, access computer databases such as those affiliated with sources such as census population data, immigration data, social security and tax data for governments; stockholders or employee data for corporations or businesses; memberships data for groups or organizations, and other information sources (e.g. paper records, microfilm) which contain relevant data about Voters;
B) viii) to accurately determine and make verifiable records of people and/or business entities that are eligible to vote, remote data source(s) records containing data about people or business entities are retrieved by Official people, and/or Official computers running software programs;
B) ix) remote source records that contain sufficient data to identify and fulfill the requirements for an Eligible Voter record, are duplicated; and the duplicate copy is verified, then transferred to the record storage facilities and computer data storage systems of the Officials of the Voting Session; furthermore, each of the records transferred is assigned a unique Potential Voter Identifier (PVID), and is marked with a remote datas source identifier (RDSID) so as to describe the information as being from a remote source, as well as date and time of transfer, and the identities of which Officials authorized the transfer and data acceptance.
B) x) remote source records that are missing data are then marked as; Research; Voter for further investigation, and each Research Voter record is assigned a unique identifier (RVID); each Research Voter record is unique in every List of Eligible Voters, and is further unique among all pluralities of Lists of Eligible Voters;
B) xi) Officials assigned to investigate, update, report on each Research Voter record;
B) xii) when each Research Voter record is updated, it is also checked to determine whether it contains sufficient information to satisfy the requirements of data acceptance standards of an Eligible Voter; if so, then it is copied, the original Research Voter record status is marked RESEARCH-ELIGIBLE, the copy record is marked as Eligible Voter, then the copy record is added to the group of Eligible Voter records; and assigned a unique Eligible Voter Identifier (EVID), retaining each RVID identifier to enable auditing;
B) xiii) Official people or Official computers running software programs, determine which Research Voter records and which Potential Voter records meet the criteria of the Voting Session to be assigned the designation of Eligible Voter; furthermore, each voter meeting the criteria is designated an Eligible Voter record, and assigned a unique Eligible Voter ID;
B) xiv) Official people or Official computers running software programs, assemble and organize at least one List of Eligible Voters based on Voting Session criteria, comprised of: at least, the names of the voter; and may also include their last known physical address for mail delivery; electronic address or any other method for delivery (such as a private fax machine number, or, forwarding contact address); furthermore, each List of Eligible Voters is assigned an Eligible Voter List Identifier (LEVID); for example, each List of Eligible Voters may be organized by any number of applicable sub-groups of political areas, geographic areas (e.g. electoral boundaries) or people (e.g. citizens of a country, group membership, stockholders voting shares) for any Voting Session.
B) xv) identical, duplicated records of Eligible Voters found in any one, or existing within several, Lists of Eligible Voters, are removed so that only one instance of a unique Voter remains, so as to prevent multiple ballots delivery to a single voter;
B) xvi) if the rules of the Voting Session, or, any group of people or business entities, or members of a business allow multiple listing of a unique Eligible Voter, then that instance is also an instance or part of this invention; and preceding step B)xv) will be done in another manner so as to accommodate the integrity of the Voting Session, for any group of people or business entities, or any members thereof;
B) xvii) Officials publish any number of List(s) of Eligible Voters via media such as Internet webpages;
B) xviii) Officials advertise the location and methods of accessing each List of Eligible Voters; this step may include sending confirmation notices to each Eligible Voter on each List of Eligible Voters, or, alternatively, placing the responsibility upon eligible voters to remain informed and take any required “self-service” steps to register for voting;
B) xix) Officials provide means and opportunities to all Potential Voters and Eligible Voters to verify or amend each List of Eligible Voters;
B) xx) Officials provide means and opportunities to any subset of any, or, all Potential Voters, Research Voters, and Eligible Voters to contact Officials to amend the List of Eligible Voters—by telephone, Internet, postal Mail, electronic mail, facsimile (fax) transmission, or in person.
B) xxi) Officials investigate each Potential Voter, Research Voter and Eligible Voter request for amendment and report the findings to Officials and the voter;
B) xxii) Officials amend any number of Lists of Eligible Voters;
B) xxiii) Officials and Voters verifies the amendments are completed accurately;
C) i) Official people or Official computers run software programs to design, and produce any form of specially designed WHOLE Ballots; using the official language of the Voting Session; or language selected by the Eligible Voter;
C) ii) Official people or Official computers run software programs to print or generate any form of representation, of specially designed WHOLE Ballots; using the official language of the Voting Session; or, language selected by the Eligible Voter;
C) iii) the number of WHOLE Ballots printed or generated is determined by the number of Eligible Voters plus an estimated number to accommodate Lost, Stolen, Damaged, or Spoiled Ballots, and an estimated number of additions to every List of Eligible Voters used for each Voting Session;
C) iv) each WHOLE Ballot is tested to be both VALID and AUTHENTIC;
C) v) for each WHOLE Ballot is passing tests to be AUTHENTIC and VALID according to step C) vi) the further step of designating the WHOLE Ballot, and its constituent parts, to having a Verification Status identifier designated as CERTIFIED;
C) vii) Delivery Status identifier of WHOLE Ballots of step 3.e. designated as READY;
C) viii) Activity Status identifier of WHOLE Ballots of step 3.f. is set to be DORMANT;
C) ix) the number of WHOLE Ballots printed or generated is very carefully controlled, monitored and regulated by Officials of the Voting Session;
C) x) Official people or Official computers run software programs to arrange delivery of any number of WHOLE Ballots to each Eligible Voter on every Eligible Voter List;
C) xi) as each WHOLE Ballot is processed through the final steps for delivery, the value of the Delivery Status identifier changes from READY to DELIVERED;
C) xii) as each WHOLE Ballot is processed through the final steps for delivery, the value of the Activity Status identifier changes from DORMANT to ACTIVE;
D) i) Officials prepare and publish any number of Voter Data Sheets which describes any combination of candidates, proposals, voting session rules, voting instructions, polling station maps, etc. This may also be repeated on the Officials website.
D) ii) Eligible Voters receive at least one WHOLE Ballot from Officials or appointees;
D) iii) Eligible Voters receive any number of optional, Voter Data Sheets;
D) iv) Eligible Voters receive any number of MASTER Ballot return envelopes;
E) i) Any Eligible Voter or Official may obtain a replacement WHOLE ballot in exchange for a DAMAGED or SPOILED ballot that has an Activity Status of ACTIVE;
E) ii) any number of Voters (Applicants) or Officials (Applicants) deliver any number of, and any number of types of WHOLE, MASTER, RECEIPT Registrations, and/or Ballots submitted IN-PERSON, by MAIL, PHONE, or INTERNET to any number of Officials;
E) iii) Voters or Officials use the pre-marked or otherwise properly mark, affix sticker labels, associate electronic data, include Voter Information documents, and optionally place their personal signature or private password INSIDE or OUTSIDE of each VOTER REGISTRATION RETURN CONTAINERS and/or upon each Voter Registration Form;
E) iv)a) Voters then mail or otherwise deliver to any number of Voter Registrations;
E) iv)b)i) Officials receive any number of Registrations and/or Ballots from Applicants;
E) iv)b)ii) Officials and/or subordinate electronic devices running computer programs use information of the RETURN CONTAINERS to sort, verify, process each Voter Registration;
E) iv)c) Officials record at least the names and address of each Applicant requesting Ballot Replacement; as well as the date and time of filing the request for replacement; as well as additional identification such as social security number, drivers license number, passport ID, may be recorded;
E) iv) d) if the Applicant claims to be an Eligible Voter, Officials search each current List of Eligible Voters for that Voting Session until a determination can be made;
E) iv) e) if the Applicant claims to be an Official of the current Voting Session, other Officials search each List of Officials of the Voting Session for a verification;
E) iv) f) Each Qualified Applicant becomes a Registered Voter status, and is then given or sent at least one specially marked and unique WHOLE Ballot with which to vote with;
E) iv) g) Each Registered Voter then marks the Master Ballot part of their WHOLE ballot, and manually or automatically, generates a duplicate copy on the RECEIPT part of the WHOLE ballot.
E) iv) h) Each Voter then uses the MASTER BALLOT RETURN CONTAINER (which is pre-marked or alternatively the Voter properly marks and/or affixes sticker label(s) to the external surface, or otherwise associates electronic data to their personal BALLOT RETURN CONTAINER, and may also optionally include a duplicate or RECEIPT of their MASTER Voter Registration, and the further step for each Master Ballot part of optionally placing their signature or private password and date on the INSIDE (or the OUTSIDE) of any number of MASTER BALLOT RETURN CONTAINER(S) that are then sent to Officials for authentication, tallying and reporting.
E) iv)b)ii) Officials and/or subordinate electronic devices running computer programs use information of the MASTER BALLOT RETURN CONTAINERS to sort, verify, process any verification of any included Voter eligibility information (Voter Registration copy-receipt, Voter signature, etc.) prior to SEPARATE processing for each MASTER BALLOT part.
E) v) a) Officials accept or reject each received MASTER ballot based on the findings of tests applied to confirm the authenticity and validity of each ballot; for example, by verifying Security Element of the Ballot; verifying the Random Symbolic Identifier is Officially valid; verifying LIMITS OF USE (Preamble-data acquisition, transmission, etc.);
E) v) b) Officials may further accept or reject each received ballot based on the Activity Status attribute of the ballot, whereby the Officials accept VALID, ACTIVE ballots;
E) v) c) i) Providing the Applicant, Affidavit, and Ballot submitted are all valid, the ballot receiving Officials cancels the correlated ballots (for example by referring to the Ballot Random Symbolic Identifier), and records the relevant details of each ballot cancellation;
E) v) c) ii) Officials amend all Voting Session records for ballot Activity Status attribute as being designated CANCELLED for all MASTER ballots with identical RSID's;
E) v) c) iii) Officials verify the SPOILED or DAMAGED Ballot Activity Status attribute is designated as CANCELLED, on all Voting Session records.
E) v) c) iv) Officials select one WHOLE Ballot, designated as a REPLACEMENT Ballot, for each Ballot that was CANCELLED; whereby each REPLACEMENT Ballot is identical to the CANCELLED ballot, except for at least one Random Symbolic Identifier of the REPLACEMENT Ballot being distinctly different from every Random Symbolic Identifier of the CANCELLED Ballot; each REPLACEMENT Ballot is tested to be both VALID and AUTHENTIC; each REPLACEMENT Ballot passing tests of preceding steps has a Verification Status designated as ACTIVE;
E) v) c) v) at least one Official delivering, or arranging the delivery of, a correlated number of REPLACEMENT Ballots to each Applicant; whereupon the Ballot is now designated as a WHOLE ballot, and Delivery Status attribute of each delivered REPLACEMENT Ballot becomes DELIVERED;
E) v) c) vi) any number of Officials record the quantity and type of REPLACEMENT—WHOLE Ballots delivered to every Applicant;
E) v) c) vii) any number of Applicants receive any number of uniquely different REPLACEMENT—WHOLE ballots of the same type submitted for replacement;
E) v) c) viii) Any Eligible Voter or Official may obtain a replacement WHOLE ballot in exchange for any LOST or STOLEN ballot having an Activity Status of ACTIVE;
E) vi) a) any number of Voters (Applicants) or Officials (Applicants) deliver any number of WHOLE, MASTER, RECEIPT, PHONE, INTERNET Ballots to any number of Officials;
E) vi) b) Officials receive any number of Ballots of the preceding steps;
E) vi) c) Officials record at least the names and address of each Applicant requesting Ballot Replacement; recording the date and time of filing the Affidavit along with additional identification such as social security number, drivers license number;
E) vi) d) any number of Officials provides any number of Applicants with at least one Affidavit form for the purpose of declaring a Ballot to be either LOST, or, STOLEN;
E) vi) e) each Applicant completes the Affidavit of previous step E)Vi)d) whereby:
E) vi) f) each Applicant provides their full legal name with the Affidavit;
E) vi) g) each Applicant provides their address, when applicable, with their Affidavit;
E) vi) h) each Applicant provides at least one form of Voter identification to verify their identity according to the Affidavit;
E) vi) i) each Applicant signs the Affidavit, physically, electronically, or by any other acceptable means according to the Rules of the Voting Session;
E) vi) j) each Applicant delivers, or arranges delivery of their Affidavit to Officials;
E) vi) k) Officials receives any number of Affidavits and identification;
E) vi) l) if the Applicant claims to be an Eligible Voter, Officials determine if the claim is valid by searching every List of Eligible Voters for that Voting Session;
E) vi) m) if the Applicant claims to be an Official of the current Voting Session, other Officials determine whether the Applicant is valid by searching every List of Officials for that Voting Session until a determination can be made;
E) vi) n) Officials may further accept or reject each received ballot based on the Activity Status attribute of the ballot, accepting to tally only ACTIVE ballots;
E) vi) o) any number of Officials, computers, optical or electronic devices, or humans accepts or rejects all other information provided for each Applicant, Affidavit or Ballot; (Recal; Preamble—data acquisition, transmission, etc.);
E) vi) p) for each valid Applicant whose Affidavit that has been sufficiently verified, at least one Official amends the Voting Session computer records to CANCEL each LOST or STOLEN Ballot that was previously delivered to the Applicant;
E) vi) q) at least one Official verifies that each LOST or STOLEN Ballot according to the preceding steps, is designated as CANCELLED on all Voting Session records; and the Activity Status attribute for each CANCELLED ballot record is set to CANCELLED;
E) vi) r) at least one Official replaces or arranges to replace each LOST or STOLEN ballot, comprising of at least the steps whereby: 5.b.11.a. selecting one WHOLE Ballot designated as a REPLACEMENT Ballot for each Ballot that was CANCELLED; 5.b.11.b. each REPLACEMENT Ballot is identical to the CANCELLED ballot, except for at least one Random Symbolic Identifier of the REPLACEMENT Ballot being different from every Random Symbolic Identifier of the CANCELLED Ballot; each REPLACEMENT Ballot of claim is tested to be both VALID and AUTHENTIC; each REPLACEMENT Ballot passing tests has a Verification Status designated as CERTIFIED; the REPLACEMENT Ballot of Activity status is set to ACTIVE;
E) vi) s) for each verified Applicant whose Affidavit was also verified, at least one Official delivers, or arranges delivery of, at least one, REPLACEMENT Ballot to the Applicant(s);
E) vi) t) at least one Official delivers, or arranges the delivery of, any number of REPLACEMENT Ballots; whereupon delivery, the Ballot is now designated as a WHOLE ballot; and the Delivery Status attribute of each delivered REPLACEMENT Ballot is now DELIVERED; E) vi) u) any number of Officials record the quantity/type of REPLACEMENT-WHOLE Ballots delivered to every Applicant;
E) vi) v) any number of Applicants receive any number of unique, different REPLACEMENT-WHOLE ballots of the same type submitted for replacement;
F) WHOLE Ballot Exchange—this method is unique among registered US patents, and provides a significant improvement in the arts pertinent to this invention.
F) a) Eligible Voters are entitled to exchange with someone they trust, any number of WHOLE Ballots they possess for identical, authentic WHOLE ballots that are valid per the LIMITS OF USE. Voters can authenticate the ballot in person, by telephone or Internet by verifying the Random Symbolic Identifier. Security Elements may be used to determine if a ballot is a forgery.
F) b) The further steps and methods, unique among inventions, is to effectively preserve the anonymity of each Voter, whereby any Registered Voter may privately communicate with any other Voters in their Voting Region to privately exchange their Whole Ballot(s)—treating Ballots like monetary currency. Since Registered Voters take time to register to vote, they generally value their right to vote, and will predominantly exchange their WHOLE Ballot(s) only for valid, authentic WHOLE Ballot(s) from people they trust. To further protect privacy, Voters are allowed to swap their Whole Ballot any number of times. This random, private ballot exchange decouples the Ballot recipient from the Eligible Voter List that was used to deliver the unique BALLOT VOTING RSID to a specific person and address. The privacy of the Voter is still enabled even if a Voter does not exchange WHOLE Ballots, as the Voting Session Officials have no easy method to determine how many Voters exchange Ballots, or whether or not any specific WHOLE Ballot was exchanged by a specific Registered Voter before the MASTER Ballot part is submitted for tallying. Voting Session Officials cannot determine how many or which Voters exchanged Ballots, and Voters cannot know if their exchanged Ballot was further exchanged again. Thus each and every Voter is generally assured of anonymity and privacy of their ballot vote by the existence and implicit practice of this ballot exchange option.
G) a) Each WHOLE Ballot has two parts—a MASTER Ballot and at least one RECEIPT Ballot (refer Entity Relation Diagram describing WHOLE Ballot and constituent parts)
G) b) Each WHOLE, MASTER and RECEIPT Ballot has at least one status attribute each attribute remains static in value until redefined by Officials;
G) c) The paper version of a WHOLE, MASTER, or RECEIPT Ballot shall include any number of alignment marks and indices for orientation of optical, magnetic, electronic scanning device(s) so as to facilitate the accurate scanning of data on any reasonable ballot.
G) d) Each part of the WHOLE Ballot, both the MASTER Ballot and any number of RECEIPT Ballots, share an identical, unique group of symbols as a correlating identifier.

A unique feature of this invention is a Random Symbolic Identifier (RSID) as the recommended unique correlating identifier, discussed in following section H).

G) e) the second ballot part of the WHOLE Ballot is referred to as a RECEIPT Ballot; a unique feature of this invention is that each RECEIPT Ballot is manufactured so as to be easily and readily distinguishable from the MASTER Ballot, to the unaided human eye using any combination of methods described herein so as to readily distinguish a RECEIPT Ballot part from the correlated MASTER Ballot part;
H) a) To understand the MASTER Ballot part referred to in G) a), G) b) (refer to FIGS. 5,6,7,8 site plans for embodiment of MASTER and RECEIPT parts of a WHOLE Ballot of the invention).
H) b) BALLOT HEADER portion—this portion improves the invention of Kargel by providing information to enable the voter to independently make clearly informed decisions regarding the ballot by providing information to the voter: (i) as to the source of the ballot (FIG. 5 item 2A1,2,B,C=Ballot Source); (ii) defining the purpose of the ballot (FIG. 5 item 3A1-7=ballot purpose) including specific information as to the title of political position (FIG. 5 item 3A1,2=candidate position description), the political voting region details (FIG. 5 items 3A3,4,5=voting region info) for which the candidates of FIG. 5, items 4A1-4 to 4E1-4 are applying for as correlated to the political position of FIG. 5, items 3A1,2); (iii) clearly identifying the type of ballot (FIG. 5 item 2E-ballot type); (iv) instruction as to what to do with the completed ballot (FIG. 5 item 2F-ballot delivery instruction). FIG. 5 items 3A1-5 can be further correlated to 5C-G.
H) c) BALLOT VOTING portion—this portion (FIG. 5, items 4A1-4 to 4E1-4) improves the invention of Kargel by providing vital information to enable the voter to independently make clearly informed decisions regarding the ballot selection options by providing specific instructions (i) as to how many candidates to select (FIG. 5 item 3A6=voting instructions); (b) and information as to how to properly select the candidates of choice (FIG. 5 item 3A7=candidate selection methods) which pertains to the correlated Candidates Selection Area (FIG. 5, Item 4A1 to 4E1=candidate selection area) that is used for marking to select any number of candidate(s); (iii) and specific descriptions of each candidates to significantly reduce selection errors (FIG. 5 item 4A2,3 to 4E2,3=candidate names) (iv) with an optional description of the candidate political party affiliation (FIG. 5—items 4A4 to 4E4); (v) and the further degree of democratic freedom of choice is given in FIG. 5 whereby a voter may print the name and/or political party description of their preferred candidate(s) or political party(s) for their voting region that are not already printed on the ballot, and thereafter vote for or against their “write-in” candidate(s) and/or political party(s).
H) d) BALLOT ID portion—this portion is unique among registered patents, providing significant improvements by this invention in the arts of invention of this invention type.
H) e) Although this invention was conceived without knowledge of Kargel's invention, there is a common thread whereby each WHOLE ballot, and the constituent parts comprising the MASTER Ballot, and any number of RECEIPT Ballots, share an identical, identifier. However, Kargel does not specify any characteristics of his identifier, and only a few unrelated details of implementation;
H) e) 1) This invention improves significantly on Kargel by the use of Random, Symbolic Identifiers (FIG. 5 items 5B, 5J2-BALLOT ID in the form of a Random Symbolic Identifier). The Random Symbolic Identifier (RSID) is comprised of a group of randomly selected symbols, which are arranged in a combination that is unique among all RSID's of a Voting Session. Thus each MASTER Ballot part and each RECEIPT Ballot part(s) that comprise a WHOLE Ballot are uniquely identifiable among all ballots (and is also unique among all Voter Registration Forms) of a Voting Session.
H) e) 2) The RSID of FIG. 5—item 5B, 5j2 is encoded and correlated to a unique barcode FIG. 5—item 5j1 so as to facilitate rapid, automated optical scanning.
H) e) 3) A unique aspect and benefit of this invention is that the RSID is a random identifier which prevents anyone with any ballot from fabricating a series of ballots, by incrementing or decrementing values in reference to any known ballot identifier.
H) e) 4) This invention shall also include the provision to include a sequential series of symbols, or a repeatable pattern of symbols, should the Officials of the Voting Session desire such a feature. It should be noted that an implementation of either would require corresponding adjustment to this invention, including the understanding that the term RSID would imply either a sequence or pattern for this invention document; It is beyond the scope of this document to speculate at all the possible combinations of symbol sequences or patterns may created for either potential request.
H) e) 5) Furthermore, this invention shall also include the methods whereby no group of unique symbols are assigned to uniquely identify any ballot—authentication thereby relies primarily upon the Security Elements of the Ballot. The steps of research, computerized data mining of Eligible Voters, mailing ballots, exchanging ballots, and any parts of this invention would include any “no ballot id” version of this invention.
H) e) 6) This document considers use of the RSID of steps H)e)1) to H)e)4), with the implied claims to include other Ballot ID methods that may be applied instead (such as, but not limited to: sequential symbols/numbers in lieu of RSID(s)).
H)f)1) A very significant improvement of this invention is to make each RSID of this invention to be extremely difficult to guess. The purposes of the RSID is to enable verification by computer of the ballot identity as an authentication test of validity and to prevent counterfeiting of a multitude of ballots. The actual number of symbols to use for the RSID of this invention must be calculated, based on the number of voters anticipated, perception of security desired for making the RSID extremely difficult to guess, balanced with the data storage needs, scanning error rate, computer processing error rate and extra communication required for having a large number of symbols comprising each RSID; also taking into consideration the total number of ballots issued, expected replacements, anticipated number of enquiries, verifications, authentications, publications, etc.

Using at least one, and possibly two, or more, concatenated symbolic characters as a Random Symbolic ID (RSID) would provide unique identity security of every single ballot (depending on the number of ballots issued) for a single Voting Session. To understand how this is so, consider that ONE symbolic character can be represented by a unique combination of a sequence of eight (or more) computer binary digits ranging from 00000000 to 11111111. Each sequence of binary digits has a Base 10 counting system numeric equivalent value.

| ASCII characters | Binary code | Base 10 value |
|---|---|---|
| A | 01000001 | 65 |
| B | 01000010 | 66 |

Concatenating characters increases the number of binary digits that can be interpreted to represent larger binary and numeric (base 10) numbers, as well as for a plurality of counting base methods such as base 8 (octal), base 16, etcetera.

| ASCII characters | Binary code | Base 10 value |
|---|---|---|
| BA | 01000010 01000001 | 16961 |
| AB | 01000001 01000010 | 16706 |

Each unique concatenation is a unique combination of symbolic characters. The positional ordering sequence of the concatenated symbolic characters has a unique binary value and a correlated unique, equivalent numeric value used to identify a specific sequence of concatenated symbolic characters. Therefore each and every unique concatenation of symbolic characters also has a unique numeric value associated only with that specific combination of symbolic characters when using a consistent method of assigning each character symbol to only one binary value. (1×10E3=1,000 1×10E4=10,000 the maximum value of the most significant digit of the binary number is calculated by 2EX where X=number of binary digits.) Consider the following:

| ASCII | Binary | Total “N” | 2 exp “N” = |
|---|---|---|---|
| Characters | Digits | Binary Digits | Maximum Value |
| 16 × | 8 = | 128 | 3 × 10E38 |
| 24 × | 8 = | 192 | 6 × 10E57 |
| 32 × | 8 = | 256 | 1 × 10E77 |

To understand how large these numbers are, consider that the Planet Earth has about 3.6×10E51 atoms; the entire Universe about 10E78 to 10E81 atoms.

(2004) reference note 1—http://mathforum.org/library/drmath/view/59178.html

How effective is a 16 character (128 binary digits) RSID (3×10E38) for voters?

If we divided RSIDs among the entire human population of Earth: 7,000,000,000 3×10E38/7×10E9=4.28×10E28=42,800,000,000,000,000,000,000,000,000 unique RSID combinations available to EACH person on Earth. Guess which ONE their Ballot was given! A super-computer capable of 4.28×10E12 guesses per second=4.28×10E28/4.28×10E12=1×10E16 seconds/(365 days×24 hours×3600 seconds)=317×10E6=317,000,000 YEARS to enumerate each possible RSID available for ANY Ballot given to each person on Earth!! At best it may take a 100 years to lucky guess one valid RSID—but then who has that ballot?! So forgery on any large scale (or even of a single ballot) is essentially eliminated!! Especially when used in conjunction with other security elements such as embedded holograms, privacy passcodes, etc.

H)f)2) This inventions unique application of these mathematical facts and estimates are such that any attempts to counterfeit any Ballots are futile, as without a valid RSID, a ballot is rejected by the Voting Session computers. There is no point trying to fake multiple copies of a known BALLOT VOTING RSID, as only one BALLOT VOTING RSID is considered in the vote records and tallies. When two or more ballots having an identical BALLOT VOTING RSID are detected, the ballots prior and subsequent votes are nullified, then all ballots with the identical BALLOT VOTING RSID are extracted and processed electronically and/or manually to inspect each Ballot composition and Security Elements for Authentication and Validation to certify which ONE ballot to tally for a Vote. Other steps such as including the Voter Registration card with each Ballot acts to pre-screen possible forgeries and also trace sources of forgery if necessary.

Therefore it is also absolutely vital that ALL valid BALLOT VOTING RSID's created by the Voting Session Officials be kept absolutely secret before and during the voting session.

H)f)3) In one application of use of this invention, only the person casting their MASTER Ballot should know the BALLOT VOTING RSID being used when casting their vote. The optional use of a VALIDATION RSID can further help to enable Voters to check their Ballot is valid for use, without revealing the final BALLOT VOTING RSID. To ensure that each Ballot VOTING RSID is kept private and secure, each Whole Ballot may optionally be delivered inside a Whole Ballot Data Container (physical, electronic) that has a unique Ballot Validation RSID which is readily viewable and is correlated to the enclosed Whole Ballot Voting RSID, and so the Ballot Validation RSID may be used to authenticate the internally held Ballot Voting RSID is valid and ready for use without revealing the Ballot Voting RSID.
H)f)4) Alternatively, in another application of this invention, the BALLOT VOTING RSID is readily visible and is used for both pre-vote validation and also for casting the Ballot. This method may rely upon the use of extra Security Elements (holograms, anti-counterfeit materials, etc.).
H)f)5) For any applications of this invention, each ballot may optionally only be recorded as cast with the additional use of a BALLOT PASSCODE RSID (a.k.a. Voter Privacy Code—FIG. 5,6 item 5A) that is similar to bank ATM card PIN=personal identifier number which is kept hidden until the ballot is ready to be used for voting.
H)f)6) Even if a Ballot Voting RSID and/or Ballot PassCode RSID were revealed, each Voter considering to exchange or to use a Ballot can first determine electronically (telephone, internet, etc.) or by personal visit to Officials, whether their WHOLE Ballot has been used to cast a Vote.
H)f)7) Another “random symbolic” option is that during the process of voting, any number of Registered Voters may sign their ballot, or, provide their own private password(s) or symbol(s) to further authenticate that the Ballot they submitted was processed, by later viewing their ballot submission electronically and/or in-person.
H) g) To further reduce errors in computer ballot processing a warning is included (FIG. 5, item 2D=ballot processing warning), to reduce the amount of manual processing.
H) h) To further reduce and detect errors, each type of RSID symbols (FIG. 5, items 5B, 5J2 are also scanned and compared to each other as well as the RSID derived from the correlated barcode (FIG. 5, item 5J1) for corroboration of the RSID.
H) i) SECURITY ELEMENTS portion—This is another unique feature of this invention with respect to other inventions of the scope of this art. This feature is a vital feature to ensure the integrity of the ballot, in order to guarantee the final vote tallies are not unfairly influenced by the creation of fictitious voters. Security Elements (such as, but not limited to: FIG. 5 item 2D, 5H, 5I1, 5I2; Voter signature/private voter password and date ballot cast as per FIG. 6 items 6A,6B in correlation-comparison with Voter Registration FIGS. 1A,1B, items 15L1, 15L2) are designed to assist with authentication of any Ballot, whereby the Security Elements may also be comprised of any number of components such as, but not limited to: Random Symbolic Identifier codes of steps H)e) to H)h), sequential symbolic identifiers, grouped symbolic identifiers, physical characteristics or devices, optical characteristics, structures or devices, electronic characteristics, devices or structures, magnetic characteristics, fields or devices, organic or inorganic chemicals, biological materials, genetic materials or genetic structures or genetic sequences, special materials, crystal structures, plastics, metals, gas emissions, electromagnetic radiation, radioactive materials, optical emissions, natural fibers, man-made fibers, microfilm dots, microscopic writing, embossing, impressions, watermarks, seals of authenticity, and any other physical structures, or any other properties, affixed or associated with any ballot; and options for decoding-encoding elements of the BALLOT VOTING RSID to be coordinates to the elements within any number and types of data structures, such as, but not limited to: n-dimensional matrices/n-trees used for data correlation and security-authentication;

### H) j) LIMITS OF USE Portion

The variety of Voting Sessions possible requires that this section of the Ballot be considered as a variable data area. The LIMITS OF USE area of the Ballot contains several data fields, whereby any single data field may be displaying any number of any data fields, in any number of combinations of data fields, having correlated data for each data field logically inter-related to each other and furthermore defining the correlation for each distinct group of ballots, using correlated information derived from various sources of information. The LIMITS OF USE area may also be considered a generic “BALLOT DATA SUB-CONTAINER” that is separate and distinct from both the “BALLOT SENDING DATA CONTAINER” and the “BALLOT RECEIVING DATA CONTAINER” when using methods of marking, identification, encapsulating or otherwise hiding ballot internal details (eg such as, but not limited to RSID) when implementing printing, distributing, receiving, sorting, validating, tallying, certifying, error detecting/correcting of any number of documents such as, but not limited to: WHOLE ballots, MASTER BALLOT parts, RECEIPT BALLOT parts, WHOLE Voter Registrations, MASTER Voter Registration parts of WHOLE Registrations, or any other documents and components. Voting Region sub-portion (FIG. 5, items 5C, 5E, 5F, 5G, 5K1, 5K2=ballot region info) identified within the LIMITS OF USE portion of a Ballot is used to describe the Scope of a Voting Session sub-portion (FIG. 19—ER Voting Regions). Voting Region also refers to a variable group of attributes—Province or State, Municipality, Zone, Poll Station, Postal or Zip Code. The groups of Voting Region attributes are used for data storage, and may also be components of the Voting Region, depending on the Scope of the Voting Session. Any number of Voting Region attributes may be visible on Voter Registration (FIGS. 1,2) or Voter Language Forms (FIG. 3), MASTER Ballots (FIGS. 5,7,9, 17,18, 20) and their correlated RECEIPT Ballots (FIGS. 6,8,10,13,22) Delivery Confirmation/Ballot Activation Forms (FIG. 11), Electronic Voting RECEIPTS (FIG. 12,13), Voting and Process Reports, Calculations, Tallies, Summaries (FIG. 23-26), or as specified by Officials to meet the needs of any Voting Session.

H) j) 1) VOTING REGION IDENTIFIER (FIG. 5—items 3A3,4,5 and FIG. 5, items 5E,F,G=VotingRegionID) sub-portions of the LIMITS OF USE portion is a unique identifier or group of identifiers used to further define the scope of application of the ballot such that it is correlated to (but not limited to) a geographic area, or, a subset of a group of people or legally recognized entities, etcetera; as correlated to FIG. 19; and also whereby FIG. 5—items 5K1 is a composite barcode correlated to the values of FIG. 5—FIG. 5, items 5E,F,G which can alternatively be displayed as separate barcodes as per FIG. 9, items 3E2b,c,d correlated to FIG. 9 items 3Eb,c,d.
H) j) 2) Referring to FIG. 9—item 3E1b,c,d forms a Voting Region Name Description for ease of human interpretation to facilitate ballot exchanges and other human processing; and 3E2b,c,d are correlated barcodes to facilitate electronic-optical machine processing. Refer to FIG. 9—item 3E1b1 is the Zone Identifier Number; item 3E1b2 is a Zone Name Description for item 3E1b1; item 3E2b1 is a barcode for items 3E1b1 and/or 3E1b2;
H) j) 3) Refer to FIG. 9—Item 3E1c1 is a Polling Station identifier, an attribute (component) of the Voting Region identifier, used to organize Ballots and facilitate analysis. Item 3E1c2 is a barcode correlated to the value of item 3E1c1.
H) j) 4) Refer to FIG. 9—item 3E1d1 is a Province-State attribute of the Voting Region (as correlated to FIG. 15); item 3E1d2 is a Date component of the Voting Session; item 3E2d2 is a barcode correlated to the value of the concatenated items 3E1d1 and 3E1d2. Item 3E1d1 & 3E1d2 may also be considered as the Voting Session Host Identifier (VSHID) used to uniquely identify, distinguish & organize a variety of ballots per any past, presenter future Voting Session.
H) j) 5) an optional item is a Postal-Zip Code identifier (as referred to by FIG. 19), an attribute (or component) of the Voting Region and of the ZONE ID to facilitate analysis of voter responses. Postal-ZipCode Identifier may also have a barcode correlated to description values.
H) j) 6) Refer to FIG. 9, item 3E1a is a Title of the Elected regarding the purpose of the ballot being a Candidate Election to fulfill the elected Duty. Item 3E1a2 is the abbreviation e symbols for the UNIQUE code associated to the Political Duty, which may be used for election accounting of ballots, or verification for ballot exchange, other ballot processing, or ballot cost accounting. Item 3E1a3 is a barcode correlated to the value of item 3E1a2.
H) j) 7) Refer to FIG. 9—item 3D1a,b refers to Ballot Delivery Due Time and Due Date identifiers—Delivery Due Date (item 3D1a) and Delivery Due Time (item 3D1b) describes the latest date and time the ballot is required to be delivered to the designated receiver(s) of the Voting Session, in order for the Ballot to be considered for any Official processing. Item 3D2 is a barcode with value correlated to concatenated or numeric value(s) of 3D1a,b.
H) j) 8) So far descriptions have looked at the constituent components of various types of ballots which have general groupings, such as, but not limited to: whereby FIGS. 5, 7, are examples of “Candidate Ballots”; whereby FIG. 9, 20 is an example of a “Proposal Ballot”; FIG. 17,18 are comprised of Candidates and Proposals (“Hybrid” Ballot).
H) j)9) In the case of a Proposal Ballot (FIGS. 9, 20), any number of proposals are presented and each are given AT MOST ONE unique proposal identifier (PropID) that is correlated to the ONE correlated proposal, and further correlated to the sub-portion allocated to record the voters choice(s). Each proposal unique identifier (PropID) may also be assigned any number of barcodes correlated to the value of the associated PropID, and/or to any number of the value(s) of the voter choice(s) available; and the further degree of democratic freedom of choice is given in FIG. 9 whereby a voter may print the name and/or description of their preferred proposal(s) not already printed on the ballot, and thereafter vote for or against their “write-in” proposal(s).

Proposal Ballot Security Elements (such as, but not limited to: Voter signatures and dates as FIG. 10 items 4A4, 4A5 in correlation-comparison with Voter Registration FIG. 1, items 15L1, 15L2) are designed to assist with authentication of any Ballot,

H) j)10) FIG. 17,18-Hybrid Ballot of Candidates and Proposals (“Hybrid” Ballot), a Voter may mark to select the desired number of candidates and/or proposals;
H) j)11) VOTING REGION—refers to FIG. 5 (items 3A3,4,5 5E,F,G), FIG. 9 (items 2B1,2,3, 3E1b,c,d), FIG. 17 that correlates to FIG. 19 “Voting Region”—is used to reduce human error when exchanging or processing ballots; an alternative is the use of an integrated Region-Poll Identifier (FIG. 5—items 5j1,2 and 5K1,2), (FIG. 18, top right barcode and text) that identifies any number of sub-regions within a Zone or Region ID; whereby the Region Name description eases human interpretation. For each figure, each barcode or group of amalgamated/combined barcodes is correlated to the values of (but not limited to):Region Name, Region ID, Poll Station ID.
H) k) To further reduce and detect errors, the identifier symbols of any descriptive human readable text of any ballot, form or document fields may also be scanned at the same time and compared to values of the respective scanned barcode(s) values for corroboration—and the additional options for decoding-encoding and evaluating the aforementioned identifier symbols to the data contained by the elements within any number of n-dimensional matrices of the correlated VOTING RSID via associated decoded-encoded coordinates referred to in H)i) or any other data of this invention;
H)j) As the steps, means methods and processes described involve people and devices that are not perfect in design, function or operation, all aspects of this invention shall also include, but not otherwise be limited to:
1) All methods within the broad scope of data processing tasks may be applied to this invention; in particular this invention includes the means and methods of acquiring data from any remote or local data source, or any type of ballots conforming to the specifications of the Voting Session;
2) The steps of locating, detecting, reading, receiving, interpreting, translating, correcting, and transmitting any number of, and any combination of: symbolic codes, physical characteristics, physical structures, optical structures, optical devices, electronic devices, electronic structures, magnetic fields, magnetic devices, organic chemicals, inorganic chemicals, biological materials, genetic materials or genetic structures or genetic sequences, special materials, crystal structures, plastics, metals, gas emissions, electromagnetic radiation, radioactive materials, optical emissions, natural fibers, natural or synthetic fibers, microfilm dots, microscopic writing and any other physical structures associated directly with a ballot or a plurality of WHOLE Ballots, MASTER Ballots, RECEIPT Ballots, Voter Registration Forms, Voter Registration RECEIPTs physical or electronic data containers, or any other type of documents or containers;
3) the tasks of locating, reading, receiving, detecting, translating, correcting, interpreting and transmitting are performed by any combination of:
a) any number of Official(s) of any type;
b) any number of data acquisition devices;
c) any number of electronic, optical or biological computing devices;
d) any number of communication networks;
e) any number of other man-made device or plurality of devices;
f) the methods of transmitting data to, and receiving data from, any number of humans, computers, devices, telephones, the Internet or any other communications networks; including the methods of translating human and device readable codes to any number of methods, modes, protocols, of data communications, data-signal error corrections;
g) the methods of locating, receiving, detecting, interpreting, translating, reporting, and transmitting error free data and of correcting compromised, erroneous or duplicate data;
h) any methods of verifying and reporting the effects of any corrections applied;
i) optionally applying tamper-proofing methods of Voter signatures, dates, private passwords;
j) utilizing ballot activation documents (e.g. FIG. 11) prior to voting;
(k) providing Voters receipts to confirm voting successful completing and a copy of voting;
4) the steps and methods further described in the following claims of this invention;

What is claimed is:

1. The steps and methods of conducting a Voting Session such that:
(A) any type of and any number of: Voting Session Officials, Officially designated appointees, and/or any number of Officials subordinate devices (such as, but not limited to: any number of—computers running computer software programs, communications systems, security devices, security software, optical-electronic document scanners, fax machines, counting machines, sorting machines, printing devices, photocopiers)—are, in all claims of this invention, hereafter referred to individually, or, collectively as a group, by the word “Officials”;
(B) and the further steps and methods whereby the aforesaid Officials take all steps necessary to ensure all types of Voters (such as, but not limited to: Eligible Voters, Proxy Voters) are given a fair, timely opportunity to register to vote and to vote;
(C) and the further steps and methods whereby the aforementioned Officials use any parts of the steps and methods of claim 9 to identify, research and assign any number of people or other legal entities to assemble any number of various types of Voters Lists (such as, but not limited to: Research Voters List, Eligible Voters List #1, Eligible Voters List #2, Proxy Voters List, Potential Voters List, or Ineligible Voters List); and
(D) the further steps and methods whereby each type of Voters List is assigned a unique symbol or group of symbols (for example—such as, but not limited to: Research Voters List ID—RVLID) to be unique and distinguish it among all Voter Lists;
(E) and the further steps and methods of any number of Officials creating any number of duplicate copies of any number of any type of Voters Lists, and the further steps and methods of Officials processing any number of any type of Voters Lists;
(F) and the further step whereby each Voter of any type (such as, but not limited to: Eligible Voter, Proxy Voter, Potential Voter, Research Voter, or, Ineligible Voter is assigned one unique identification symbol or groups of symbols (such as, but not limited to: Research Voter ID (RVID), Eligible Voter Identifier (EVID)) so as to uniquely identify each person or legal entity from all other voters and all other legal entities on any Voters List of the Voting Session;
(G) and the further steps and methods whereby any number of Officials correlates any number of, and any type of Voter Identifiers (such, but not limited to: Eligible Voter Identifier—EVID) to any number of, and any type of Voters Lists; (H) and the further steps and methods whereby any number of Officials correlates any number of, and any type of Voter Identifiers (such, but not limited to: Eligible Voter Identifier—EVID) to any number of WHOLE Voter Registration Forms;
(I) and the further steps and methods whereby any number of Officials creates, prints, distributes, receives and processes any number of Voter Registration forms (FIG. 1,2) whereby each WHOLE Voter Registration form is comprised of at least two parts, whereby one part is a MASTER Voter Registration form (FIGS. 1A,1B) and the second part is comprised of any number of RECEIPT Voter Registration form(s) (FIGS. 2A,2B);
(J) and the further steps and methods whereby each MASTER and RECEIPT parts of each WHOLE Voter Registration is assigned at least one unique identifier known as a Voter Registration Number (VRN) to distinguish each WHOLE Voter Registration form (and its constituent MASTER, RECEIPT constituent parts) from all other WHOLE Voter Registrations forms;
(K) and the further steps and methods whereby for each WHOLE Voter Registration form, the component MASTER Voter Registration form and all component RECEIPT Voter Registration forms (for the same WHOLE Voter Registration form) are correlated to each other by sharing the same unique Voter Registration Number (VRN) identifier that is directly printed, embedded, affixed or otherwise electronically linked to each constituent part (MASTER, RECEIPT(s)) for each WHOLE Voter Registration form;
(L) and the further steps and methods whereby each RECEIPT Registration form is manufactured so as to be easily distinguishable from the MASTER Registration form using methods such as, but not limited to: any combination of word markings (e.g. RECEIPT), any number of different colors, different texture, or different materials, different physical, electronic, electromagnetic, or optical representation, or any other form of representation or markings that differs from that which is used to manufacture or identify the MASTER Registration form, so as to distinguish each RECEIPT Registration form from every MASTER Registration form;
(M) and the further steps and methods such as, but not limited to: printing, affixing, attaching, linking, correlating or embedding any number of Security Elements of claim 6 for each part of each WHOLE Voter Registration form (MASTER, or RECEIPT); (m) and the further steps and methods whereby each WHOLE Voter Registration form (and each MASTER part and each RECEIPT part) is comprised of any number of portions, such as, but not limited to: at least one portion containing elements of voting information (such as, but not limited to—voting session name, voting session type, Voter Registration Number (VRN), at least one portion for recording voter identification, at least one portion for recording the voters legal name(s), any number of portions for recording the voter signature (such as, but not limited to FIGS. 1,2 item L1), at least one portion for recording the date of Registration form completion (such as, but not limited to FIGS. 1,2 item L1);
(N) and the further steps and methods for each Voter Registration form of allocating identical portions for Voters or Officials to mark and record information elements such as, but not limited to: any number of personal identifiers, any number of printed names, any number of signatures, any number of date information, any number of location information; any number of other contact data (such as, but not limited to: home/work/cellular telephone, e-mail address);
(O) and the further steps and methods of assigning at least one portion to any number of Voter Permanent Address Identifier (VPAID) with any number of portions for additional physical address information elements—whereby each Voter Permanent Address Identifier is unique among all VAIDs and among all addresses, yet the VPAID is not unique among voters as several voters may reside at the same VPAID address;
(P) and the further steps and methods of assigning at least one portion to any number of Voter Mailing Address Identifier (VMAID) with any number of portions for additional physical address information elements—whereby each Voter Mailing Address Identifier is unique among all VMAIDs and among all addresses, yet the VMAID is not unique among voters as several voters may reside at the same VMAID address;
(Q) and the further steps and methods of correlating each Voter to any number of Voter Permanent Address Identifiers (VPAIDs);
(R) and the further steps and methods of correlating each Voter to any number of Voter Mailing Address Identifiers (VMAIDs);
(S) and the further steps and methods of providing any number of portions for any number of other types of useful, relevant information;
(T) and the further steps and methods whereby for each Voter Registration form are correlated to any number of electromagnetically detectable (such as, but not limited to: magnetic field) and/or readable optical symbolic codes (such as, but not limited to: barcodes);
(V) and the further steps of processing according to claim 9, for any number of Voter Registration Forms (WHOLE, MASTER or RECEIPT) and any number of Voter Registration Data Containers (such as, but not limited to: SENDING, RETURN);
(W) and the further steps and methods whereby any number of Officials optionally pre-sort any types of Voter Address Identifiers and apply the further steps to correlate any number of, and any type of Voter Identifiers (such as, but not limited to: Eligible Voter IDs=EVIDs) to each appropriate Voters List (such as, but not limited to: all EVIDs to Eligible Voter List #2—EdmontonCentre);
(X) and the further steps and methods of Officials applying any parts of claims 4,5 then delivering (directly, indirectly or by proxy service) to any number of Voters—any number of Voter Registration form(s), any number of Voter Registration Data Return Container(s);
(Y) and the further steps and methods of any number of Voters: (i) applying claims 7,8 when completing their Voter Registration form, (ii) making and keeping any number of duplicate RECEIPT copy(s), (iii) separating MASTER from RECEIPT copy(s); and, (iv) the further steps and methods according to claims 4,5,7,8 of applying any number of markings on any number of RETURN Data Containers; and (v) the further steps and methods return delivering (directly, indirectly or by proxy service) any number of their MASTER Voter Registration form(s) to Officials, via any number of Voter Registration (VR) RETURN Data Container(s).

2. The steps and methods whereby any number of Officials creates, prints, distributes, receives and processes any number of WHOLE Voter Language Selection forms whereby:
(A) each WHOLE Voter Language Selection form is comprised of at least two parts—(i) whereby one part is a MASTER Voter Language Selection form (FIG. 3) and (ii) the second part is comprised of any number of RECEIPT Voter Language Selection form(s) (such as but not limited to—simply another color or darker shading of FIG. 3 with the word RECEIPT prominent);
(B) and the further steps and methods whereby each MASTER and RECEIPT parts of each WHOLE Voter Language Selection form is assigned at least one unique identifier known as a Voter Language Selection Number (VLSN) to distinguish each WHOLE Voter Language Selection form (and its correlated MASTER, RECEIPT) from all WHOLE Voter Language Selection forms;
(C) and the further steps and methods whereby for each WHOLE Voter Language Selection form, the component MASTER Voter Language Selection form and all component RECEIPT Voter Language Selection forms (for the same WHOLE Voter Language Selection form) are correlated to each other by sharing the same unique Voter Language Selection Number (VLSN) identifier that is directly printed, embedded, affixed or otherwise electronically linked to each constituent part (MASTER, RECEIPT(s)) for each WHOLE Voter Language Selection form;
(D) and the further steps and methods whereby each RECEIPT Language Selection form is manufactured so as to be easily distinguishable from the MASTER Language Selection form using methods such as, but not limited to: any combination of word markings (e.g. RECEIPT), any number of different colors, different texture, or different materials, different physical, electronic, electromagnetic, or optical representation, or any other form of representation or markings that differs from that which is used to manufacture or identify the MASTER Voter Language Selection (VLS) form, so as to distinguish each VLS RECEIPT part from any VLS MASTER part of the VLS form;
(E) and the further steps and methods whereby each WHOLE Voter Language Selection form (and each MASTER part and each RECEIPT part) is comprised of portions, such as, but not limited to: at least one portion containing elements of voting information (such as, but not limited to—voting session name, voting session type, Voter Registration Number (VRN), and the further steps of assigning at least one portion for recording voter identification, any number of portions for recording the voters legal name(s), any number of portions for recording the Voter language preference(s), any number of portions for recording the voter signature (FIG. 3);
(F) and the further steps and methods of printing, assigning, linking, correlating or embedding any number of Security Elements of claim 6 (such as, but not limited to RSID, holograms) for each part of each WHOLE Voter Language Selection form (MASTER, or RECEIPT); and the further steps and methods for each Voter Language Selection form of allocating identical portions for Voters or Officials to mark and record information elements such as, but not limited to—any number of personal identifiers, any number of printed names, any number of signatures, any number of date information, any number of location information; any number of non-address contact information (such as, but not limited to: telephone, cellphone, e-mail address);
(G) and the further steps and methods whereby each Voter Language Selection form is correlated to any number of detectable symbolic codes (such as, but not limited to: barcodes, electro-magnetic fields) that are printed, embedded or associated with each form;
(H) and the further steps of processing according to claim 9, for any number of Voter Language Selection forms (WHOLE, MASTER or RECEIPT) and any type of, and any number of Voter Language Selection Data Containers;
(I) and the further steps and methods whereby Officials provide any number of Lists of Languages and correlated languages;
(J) and the further steps and methods whereby any number of Officials correlates any number of Languages and language translated documents (such as, but not limited to: ballots, registration forms, internet web-pages, emails) to each List of Languages;
(K) and the further steps and methods whereby each Voter Identifier (such, but not limited to: Eligible Voter Identifier=EVID) of claim 1 is correlated to any number of items of this invention, such as, but not limited to: lists, forms, information documents, ballots, data containers, faxes, internet web-pages, internet emails, and in particular, to any number of (WHOLE, MASTER, RECEIPT) Voter Language Selection form(s) (FIGS. 2A,2B,3), Voter Registration forms (FIG. 1,2) and Voter Ballots, and to any number of any type of data in any form;
(L) and the further steps and methods of correlating for each Voter, every language selection marked or acquired from each VLS form (FIG. 3) or Voter Registration form (FIG. 1,2);
(M) and the further steps and methods so as to actively link and provide to each Voter, each the appropriately translated documents (such as, but not limited to: Voter Registration forms, WHOLE ballots, web-pages, information documents and any other types communications) to match the language(s) selected by each Voter;
(N) and the further steps and methods of Officials applying any number of steps and methods according to claims 4,5 and then acting to deliver (directly, indirectly or by proxy service) to any number of Voters—any number of Voter Language Selection form(s), and any number of Voter Language Selection Data Return Container(s);
(O) and the further steps and methods of any number of Voters: (i) apply claims 7,8 when completing their Language Selection form, (ii) making and keeping any number of duplicate RECEIPT copy(s), (iii) separate MASTER from RECEIPT copy(s), (iv) return deliver (directly, indirectly or by proxy service) any number of their MASTER Voter Language Selection form(s) to Officials, via any number of Voter Language Selection (VLS) Data Container(s) with markings per claims 4,5,7,8.

3. The steps and methods whereby any number of Officials creates, prints, distributes, receives and processes any number of WHOLE BALLOTS, whereby:
(A)(i) each WHOLE Ballot is comprised of at least one part, whereby one part is the MASTER Ballot FIG. 5,7, 9, 17,18, 20) and any number of RECEIPT Ballot parts (FIG. 6, 8,10);
(B) and the further steps and methods such that each MASTER and RECEIPT parts of each WHOLE Ballot are assigned at least one shared, yet unique Ballot Random Symbolic Identifier (BALLOT VOTING RSID), which is prominently visible on the WHOLE Ballot (and component MASTER and RECEIPT parts) so as to distinguish that WHOLE Ballot (and all of its component parts) from all other WHOLE Ballots (and their component parts);
(C) and the further steps and methods whereby for each WHOLE Ballot component MASTER Ballot and all of the RECEIPT Ballots of the same WHOLE Ballot are correlated to each other by sharing the same unique BALLOT VOTING RSID identifier that is printed, embedded or linked or displayed prominently on each MASTER and RECEIPT Ballot parts of each WHOLE Ballot;
(D) and the further steps and methods such that each RECEIPT Ballot is manufactured so as to be easily distinguishable from the MASTER Ballot to the using any combination of—additional word markings (such as but not limited to: word RECEIPT), raised symbols (such as, but not limited to Braille codes), any number of different colors, different texture, or different materials, different physical, electronic, electromagnetic, or optical representation, or any other form of representation that differs from that which is used to manufacture the MASTER Ballot, which may include items such as, but not limited to any number of Security Elements of claim 6;
(E) and the further steps and methods, properties, materials, representational forms described in claim 1 that are used to differentiate MASTER Registrations from RECEIPT Registrations may also be applicable to distinguish RECEIPT Ballots from MASTER Ballots;
(F) and the further steps and methods whereby at least one BALLOT VOTING RSID is comprised of numbers, symbols or a group of numbers and symbols, randomly generated to be of a length, content, and construction as to be extremely difficult to guess by chance or to determine (even when assisted by at least one computer running software programs for such purpose), and the further steps and methods whereby any number of unique codes (such as, but not limited to—a binary digital numeric code, a binary digital ASCII code) are consistently created, assigned, associated, stored, retrieved, communicated and processed according to claim 9, for each unique group combination of BALLOT VOTING RSID numbers, BALLOT VOTING RSID symbols or BALLOT VOTING RSID groups of numbers and symbols;
(G) and the further steps and methods whereby each BALLOT VOTING RSID is correlated to any number of, and any type of optically and/or electronically scannable identification marker codes or any other symbolic codes, optical barcodes or electromagnetic codes which are correlated and attached or embedded to each ballot;
(H) and the further steps and methods whereby at most one CURRENTLY VALID PassCode RSID is correlated to each BALLOT VOTING for the purpose of providing additional security for the Vote Casting task of each Voting Ballot (MASTER, RECEIPT);
(I) and the further steps and methods whereby each PassCode RSID is comprised of numbers, symbols or a group of numbers and symbols, that is randomly generated to be of a length, content, and construction as to be difficult to guess or determine;
(J) and the further steps and methods whereby any number of unique codes (such as, but not limited to—a binary digital numeric code, a binary digital ASCII code) are consistently created, assigned, associated, stored, retrieved, communicated, processed according to claim 9 for each unique group combination of PassCode RSID numbers, PassCode RSID symbols or PassCode RSID groups of numbers and symbols;
(K) and the further steps and methods such that each PassCode RSID is correlated with one MASTER Ballot, and each RECEIPT Ballot for each WHOLE Ballot and Ballot Data Container (such as, but not limited to: sending, receiving);
(L) and the further steps and methods whereby each Ballot PassCode RSID is hidden from viewing by a removable covering or openable container such that the only way for the PassCode RSID to be viewable will automatically create evidence of having been revealed, thereby indicating the Voting Ballot may be later used without actual possession of the Voting Ballot;
(M) and the further steps and methods, for each Ballot PassCode RSID, the actions such as, but not limited to: printing, linking, correlating or embedding, of any number of Security Elements of claim 6 (such as, but not limited to BALLOT VOTING RSID, Validation RSID, PassCode(s), hologram(s)) for each correlated Ballot (WHOLE, MASTER, or RECEIPT);
(N) and the further steps and methods of correlating each Ballot PassCode to any number of, and any type of optically and/or electronically scannable identification marker codes, any other symbolic codes, optical barcodes or electromagnetic codes correlated, attached or embedded to each ballot;
(O) and the further steps and methods for each Ballot of allocating identical portions for Voters to mark and record information comprising of, but not limited to—having any number of portions for selecting any number of candidates, any number of portions for selecting any number of proposals, or any number of portions for selecting any number of candidates and any number of proposals, as well as at least one portion containing elements of voting information, correlated to any number of barcodes or other optical scanning markings or electronic processing elements, at least one portion containing additional information;
(P) and the further steps and methods for each printed WHOLE Ballot of printing, attaching or embedding, any number of electronic processing elements (such as, but not limited to: magnetic fields, electronic circuits, embedded software programs), optical scanning markings for data detection for any number of portions of any number of and any type of document (such as, but not limited to: Master Ballot, Voter Registration form, Ballot Return Data Container) such as, but not limited to: data start markers (FIG. 5—item 2A1), data stop markers (FIG. 5—item 2A2), combined data start/stop markers (FIG. 1—item 14B which marks the start of 14B and implicitly marks stop at 14A);
(Q)(i) and the further steps and methods of optical alignment (a.k.a. skew) detection markings to ensure proper optical scanning detection for any number of portions of any number of and any type of document (such as, but not limited to: Master Ballot, Voter Registration form, Ballot Return Data Container) such as, but not limited to: alignment error detection, alignment error measurement, alignment error messaging, alignment error correction; (ii) and the further steps and methods of applying any number of computers running software programs to provide any number of data processing steps and methods such as, but not limited to: automatically providing data extraction, alignment measurement, data alignment correction, data orientation measurement, data orientation correction for any number of portions of any number of and any type of document (such as, but not limited to: Master Ballot, Voter Registration form, Ballot Return Container);
(R) and the further steps and methods of consistently marking, shaping, or cutting any number of corners of each WHOLE Ballot (and thus each MASTER Ballot, and optionally each RECEIPT Ballot part) so as to enable a consistent method to identify and/or sort based on the orientation markings (such as, but not limited to: FIG. 5, item 1A9) to assist in sorting, organizing, scanning, counting by any human, or any number of human-made combinations of types of devices (such as, but not limited to: mechanical-electronic, optical-mechanical) for processing steps such as, but not limited to claim 9;
(S) and the further steps and methods whereby each MASTER Ballot and each RECEIPT Ballot part of the WHOLE Ballot is subdivided into, and comprised of, at least one portion, such that, but not limited to: (a) Election Info portions—these portions provide information to enable the voter to independently make clearly informed decisions regarding the ballot such as, but not limited to: (a1) the source of the ballot (FIG. 5 item 2A1—ballot source, and optionally, FIG. 5—items 5C-5G) and (a2) a unique Voting Session Identifier (FIG. 5—items 5C) and any number of correlated Voting Session Details Identifiers (FIG. 5, items 5D, 5E, 5F, 5G) which may be distinctly unique (FIG. 7), or, optionally merged and encoded (FIG. 5—item 5K1), so as to be correlated to any number of, and any type of optically and/or electronically scannable identification marker codes or any other symbolic codes, optical barcodes (such as but not limited to: FIG. 5—item 5K1), or electromagnetic codes correlated and attached or embedded to each Voting Ballot, so as to facilitate automated processing according to (but not limited to) claim 9; (a3) any number of correlated human-readable symbolic values (such as, but not limited to: alpha-numeric character symbols—e.g. FIG. 5, item 5K2) that are correlated to any number of Voting Session Identifiers identification marker codes and any number of Voting Session Detail Identifiers marker codes (such as, but not limited to: FIG. 5—item 5K1); (a4) defining the scope of the ballot application (FIG. 5—items 2A1, 2B, 2C, 3A1-3A5, 5D-5G); (a5) identifying the type of ballot (FIG. 5 item 2E); (a6) instruction for the completed ballot (FIG. 5 item 2F); (b) Vote Selection portion—this portion provides information to enable the voter to independently make clearly informed decisions regarding the ballot selection options by providing specific information such as (but not limited to): (b1) the title of political position (FIG. 5 item 3A1) which may optionally be repeated ad also include a Candidate Position Identifier (FIG. 5-5D) which may be further correlated to any number of scannable barcodes, electromagnetic or optical codes and materials, or other symbolic identifiers (FIG. 5-5K1) embedded or attached to each Voting Ballot; (b2) description of the voting region the ballot is correlated to, such as, but not limited to: name of the voting region (FIG. 5—3A3, 5E) the number of the Voting Region (FIG. 5—3A4, 5F) and the Poll Stations ID (FIG. 5—3A5, 5G), that may optionally be repeated (FIG. 5—5E, 5F, 5G) and further correlated to any number of scannable marker codes such as, but not limited to: barcodes (FIG. 5—5K1, FIG. 7) or other symbolic codes so as to facilitate automated processing according to, but not limited to: claim 9; (b3) specific instructions as to how many candidates to select (FIG. 5 item 3A6); (b4) to how to properly select the candidates of choice (FIG. 5 item 3A7); (b5) specific descriptions of the candidates to significantly reduce selection errors (FIG. 5 items 4A2, 4B2, 4C2, 4D2—candidate first names and correlated family names items 4A3, 4B3, 4C3, 4D3); (b6) any number of optional description(s) of each candidate's political party affiliation (FIG. 5—items 4A4, 4B4, 4C4, 4D4); (b7) correlated candidates selection area containing exactly ONE designated area for marking the voter's candidate(s) of choice (FIG. 5—items 4A1,4B1,4C1,4D1); (b8) any number of areas to write or print the given legal first and family names (FIG. 5, items 4E2—first name, 4E3—family name) and/or optionally the political party (FIG. 5. Item 4E4) that are the alternative voter's preferred choice; (b9) exactly ONE area for each voter write/print in name to be used to mark the voter selection (FIG. 5—item 4E1) that is further correlated to each correlated voter write/print candidate legal names (FIG. 5—item 4E2,3) and correlated political party (FIG. 5-4E4); (c) Ballot ID portion—(c1) Security Elements (FIG. 5—item 2D, 5A, 5B. 5I1, 5I2) according to claim 6, such as, but not limited to: holograms, embedded threads, electronic circuitry are embedded or associated in some way as to be inextricably linked to the Ballot, for the purpose of authenticating the Ballot for the Voting Session; (c2) Ballot Identifier (FIG. 5 item 5B)—such as, but not limited to: Random Symbolic Identifier, or, Sequential Symbolic Identifier, or, Group Pattern Sequential ID, or Group Pattern Random Sequential ID which are ALL interchangeably referred to in this version of the patent description as RSID) such that the Ballot ID (a.k.a. Ballot RSID) is comprised of a unique group of symbols which are arranged in a combination that is unique among all Ballot RSID's of each Voting Session, such that each MASTER and RECEIPT Ballots that comprise a WHOLE Ballot are uniquely identifiable among all MASTER and RECEIPT Ballots of a Voting Session, and for example, is described in FIG. 5, item 5B which may be further encoded and correlated to a unique marker symbol (such as, but not limited to: barcode symbol—FIG. 5, item 5j; (c3) BALLOT PASSCODE (Ballot PassCode RSID, a.ka.a Voter Privacy Code FIG. 5,6—item 5A1) that is used in several ways such as, but not limited to: (a) enable the Ballot Voting RSID to be used for voting electronically, and, (b) to prevent unauthorized access to electronic reporting of the Ballot Selections for a Ballot Voting RSID; (c4) whereby the Voting PassCode RSID may be optionally hidden (FIG. 5, item 5A) to enable Ballot Validation without revealing how to enable the Ballot for Voting or access to reporting selections; (c5) whereby the Ballot PassCode RSID (FIG. 5, item 5A) is constructed to be sufficiently different in length and/or composition so as to not be easily confused with the Ballot Voting RSID (FIG. 5—item 5B); (d) LIMITS OF USE portion—(d1) Expiry Date, Time—(FIG. 5—item 2F) is the final date and/or time when the Ballot is no longer useful for the Voting Session, and thus must be received by Officials on or before the Expiry Date & Time to be accepted for processing and tallying; and, optionally, any number of Due Dates and/or Due Times for any approved method of voting such as, but not limited to: Internet Voting, Mail Voting, etc; (d2) may also include (b2) of this claim; (e) the further steps and methods for the any version of any number of WHOLE, MASTER, or RECEIPT Ballots or any other objects, (such as but not limited to: documents, forms or containers) whereby each shall include any number of but not limited to: alignment marks (FIG. 5—items 1A1-1A8, 1B1-1B8), alignment graphics (FIG. 5—items 2B,2C, 2A2,2E) electronic encoding, magnetic fields, and/or any form of index identifiers for orientation of optical, magnetic, electronic scanning device(s) so as to facilitate the accurate scanning of data on any ballot in reasonable condition; (e) and the further steps and methods for printed ballots of including such as, but not limited to) a darkened, highlighted or cut-away corner so as to enable identical orientation of ballots to prepare for faster scanning, such as, but not limited to: FIG. 5—item 1A9); (e) Signature Portion—any number of spaces allocated for the Voter to place their personal signature mark or private voter password directly upon, or otherwise correlated to, any number of their master ballots (FIG. 7) and/or any number of their receipt ballots (FIG. 6—item 6A) so as to provide further means of authentication and ballot tamper proofing; (f) Signature Date portion—any number of spaces allocated for the Voter to write or print the date that they signed their ballot and/or ballot receipt (FIG. 6.—items 6B, FIG. 7) as per step (f);
(T) and the further steps and methods whereby a removable covering of any type (such, as, but not limited to: paper, electronic) may be applied to the front of a MASTER ballot or any other document such that the cover obscures essential, private information and may also reveal any amount of public, necessary to know information, using methods such as, but not limited to: (i) completely obscured BALLOT VOTING RSID that is within a sealed SENDING BALLOT DATA CONTAINER, or, (ii) partially visible BALLOT VOTING RSID that can be partly detected through a viewing window or audio recording of the sealed SENDING BALLOT DATA CONTAINER, such that the partial Whole Ballot RSID provides enough data for verification, with disclosing the entire Voting Ballot RSID, or, (iii) completely visible WHOLE BALLOT VOTING RSID paired with a completely obscured BALLOT PASSCODE RSID that can be discerned only by the detectable removal of its temporary cover;
(U) and the further steps and methods of encoding the BALLOT VOTING RSID, in whole or in part, as a derivable component of any number of digital files (such as, but not limited to: an encrypted email message with an encrypted file attachment; a mailing paper envelope or electronic container EXTERNALLY marked with a unique, CONTAINER RSID BARCODE and any number of correlated CONTAINER RSID symbols of claims 4,6;
(V) (i) and the further steps and methods of encapsulating (using methods such as, but not limited to: paper envelopes, electronic data containers) any number of Voting Ballots and each ballots correlated constituent components so as to facilitate processes such as, but not limited to: physical printing, electronic printing, physical distribution, physical receiving, electronic distribution, electronic receiving, physical security, electronic security, ballot contents anonymity, Voter anonymity; (ii) and the further steps and methods of marking the external portion of any number of encapsulating containers (such as, but not limited to: paper envelopes, electronic data containers) of prior step “(U)” with any number of, and any type of marking such as, but not limited to: optically and/or electronically scannable identification marker codes, symbolic codes, optical barcodes or electromagnetic codes and materials, or any number of Security Elements of claim 5; (iii) and the further steps of correlating, recording and attaching or embedding to each encapsulated ballot of prior step “(U)” with the identification marker codes, symbolic codes, optical barcodes or electromagnetic codes and materials of prior step “(V)”; (iv) and the further steps and methods of decoding and/or encoding and/or evaluating any number of elements of the VOTING RSID to be coordinates to any number of correlated elements within any number of correlated “parent” n-dimensional matrices and methods of claims 4,5,6;
(W) and the further steps and methods of providing data decoding, encoding, correlation, comparisons, evaluations for security-authentication of any number of VOTING RSID's and/or and number of Security Elements of claims 5,8 for any number of Data Security, Data Integrity, Data Storage, Data Transmission methods as may be applied collectively, redundantly or independently according to any number of processing steps and methods such as, but not limited to: VOTING RSID's, Security Elements, Data Storage, Data Security, Data Transmission, Data Reception in accordance with claims 5,6,9 of this invention;
(X) and the further steps and methods to enable rapid automated optical scanning, electro-magnetic field processing, or high speed photographic picture taking and analysis scanning—for any number of and any type of documents of this invention (such as, but not limited to: Ballots, Voter Registration, Language Selections, Data Containers); and the further steps and methods of whereby any number of Officials correlate any number of WHOLE Ballots and Whole Ballot constituent parts (MASTER, RECEIPT) of claim 3 to any number of unique Registered Voter Identifiers (RVID's), any number of Voters Lists, any number of WHOLE Voter Registrations of claim 1, and to any number of Voter Language Selections of claim 2;
(Y) and the further steps and methods of Officials use any number of marking methods according to claims 4,5 then send or deliver (directly, indirectly or by proxy service) to any number of Eligible, REGISTERED Voters (as determined by claims 1,2) any number of WHOLE Ballots, and any number of and any type of BALLOT Data Return Container(s);
(Z) and the further steps and methods of any number of Voters applying the steps and methods according to claims 7,8 when completing their Ballots, (ii) providing, enclosing or attaching the required information, (iii) return delivering (directly, indirectly or by proxy service) any number of, and any type of Ballots(s) to Officials, via any number of MASTER Ballot Voting (MBV) Data Container(s) that are properly addressed, marked per claims 4,5 applying claims 7,8.

4. The steps and methods whereby Officials create and apply any number of, and any type of Security Elements to preserve the integrity of Voting Session components such as any documents, data, data communications, data containers (such as, but not limited to: physical, electronic) labels-markings, any number of documents of this invention (such as, but not limited to: Ballots of claims 3, Language Selection forms of claim 2, Voter Registrations of claim 1, Voter Lists of claim 1, Voter IDs of claim 1, Data Containers Identifier labels or marks) whereby Security Elements: (A) can be items such as, but not limited to: (FIG. 5 items 2D, 5A, 5B, 5H, 5i1, 5i2, 5J1, 5J2) may be comprised of any type of Random Symbolic Identifiers (RSIDs) such as, but not limited to: BALLOT VOTING RSID's (FIG. 5, items 5B,5J1,5J2), PassCode RSID's (a.k.a. Voter Privacy Code) (FIG. 5,6,7,8—item 5A, FIGS. 9,10—item3C1);
(B) and the further steps and methods whereby Security Elements may be comprised of items such as, but not limited to: physical characteristics or properties of materials, man-made devices (such as, but not limited to: embedded micro-electronic devices), holograms, Braille code embossing, optical structures or devices, electronic devices or structures, magnetic fields or devices, organic or inorganic chemicals, biological materials, genetic materials or genetic structures or genetic sequences, special materials, crystal structures, plastics, metals, gas emissions, electromagnetic radiation, radioactive materials, optical emissions, natural fibers, man-made fibers, microfilm dots, microscopic writing, embossing, photon-sensitive symbols, photon-sensitive text, or infra-red radiation sensitive (text, symbols or images) on/in materials, electronic codes, optical codes, optical or digitized pictures, codes embedded within optical pictures or digitized pictures, watermarks, impressions or seals of authenticity integral, affixed or associated, and any other physical, electronic, electromagnetic, optical, chemical or biological structures, devices or properties;
(C) and the further steps and methods of creating any number of any type of RSID (such as, but not limited to: Random Symbolic Identifier, Sequential Symbolic Identifier, Group Pattern Random Symbolic Identifier, Group Pattern Sequential Symbolic Identifier) used in any type of document or items of this invention (such as but not limited to ballots, documents, forms, containers) such that the steps in creating each RISD and/or group of RSIDs are done logically, such as, but not limited to:
(a) defining the maximum number of Random Symbolic Identifiers needed to ensure that any one RSID is unique and extremely difficult to guess by considering relevant data such as, but not limited to: the number of Potential Voters according to Research steps of claim 1, the number of correlated RSIDs per each type of document of this invention;
(b) officials correlate the total number of RSIDs to the computing systems internal processing numeric system (such as, but not limited to: binary 0, 1) or any other Officials chosen numeric system, and thereafter calculate the quantity of base digits required to create a sufficient quantity of character symbol permutations (such as, but not limited to: 32 binary digits gives about 4,000,000,000 unique RSID combinations, but 8 binary digits are required to encode each symbolic character to an ASCII character code—example binary 10000001 equates to ASCII character “A”) so as to completely accommodate the total number of Random Symbolic Identifiers required, of which only a portion may be usable, non-repetitive patterns, non-confusing symbol codes;
(c) whereby officials determine, perform manual calculations, and/or use any number of computers running software programs to apply mathematical concepts in calculating the number of unique RSID symbols needed to enable generating a sufficiently usable number of unique permutations (example two letters A, B yields 4 unique permutations AA, AB, BA, BB) of RSIDs to be assigned to any number of documents (such as, but not limited to: Ballots, Registrations SEN/RECEIVE/RETURN DATA CONTAINER ID);
(d) Officials use existing symbols (such as but not limited to: numbers, characters of an alphabet, etc.) or design new symbols, ensuring there is a large set of unique symbolic characters to choose from (also eliminating symbols that have a similar appearance so as to avoid misinterpretation or confusion) when randomly selecting or constructing any number of RSIDs, random symbols, random codes;
(e) Officials assign ONE unique data value of any type to each symbol of the set (d) above;
(f) Officials limiting the number of times a single symbol, or group of symbols, is repeated in a series of symbols so as to avoid confusion, optimize uniqueness;
(g) and the further steps and methods of correlating any number of RSIDs to:
(1) any number of alpha-numeric symbols or any other types of language graphical or imagery symbols (such as, but not limited to: English language alpha-numeric characters, Japanese language symbols);
(2) any number of any types of barcode graphical symbolic representations;
(3) any number of calculated or derived barcode values as symbolic characters;
(h) Officials then organize each type and group of RSID's to be rapidly retrievable via time and data optimized processing so as to enable rapid authentication and validation, which may be accomplished by methods such, but not limited to: merging implementations of hybrid n-tree search methods (such as but not limited to: auto-sorting, weighted n-tree beam search, storage, retrieval) that is then applied to any number of, and any type of data storage methods and structures (such as, but not limited to: n-dimensional sparse matrices associated to computer software programs such as, but not limited to: (i) relational databases (ii) n-dimensional sparse matrices), whereby any number of computers are connected to any number of other computers, and any number of other computer related processing devices (such as, but not limited to: optical scanners, printers, CD player-writer, DVD player-writer, facsimile machines), using any number of communications systems (such as, but not limited to: local area networks, wide area networks, Internet, telephone system, cellular phone system) by employing and applying any number and any type of communication devices (such as, but not limited to: routers, modems, cable modem devices, telephony devices) security devices and software (such as internet firewall security routers, dongles, security keys, data encryption-decryption software) to effectively and efficiently process data for optimal data storage, retrieval, integrity, longevity, security, privacy;
(D) and the further steps and methods whereby officials assign any number of RSIDs, to any number of documents and data containers of this invention (such as, but not limited to: steps and methods whereby Officials associate, affix, and/or correlate:
(1) AT MOST ONE unique Ballot VOTING RSID to each WHOLE BALLOT, and thus to each correlated MASTER BALLOT VOTING RSID, and to each correlated RECEIPT BALLOT;
(2) ANY NUMBER of BALLOT VALIDATION RSIDs for each unique WHOLE BALLOT and parts thereof;
(4) AT MOST one initial BALLOT PASSCODE RSID for each WHOLE BALLOT and parts thereof;
(5) AT MOST ONE unique Voter Registration RSID to each Voter Registration;
(6) AT LEAST ONE unique RSID or other ID to each RETURN DATA CONTAINER ID;
(7) for each RETURN DATA CONTAINER (such as, but not limited to: BALLOT RETURN DATA CONTAINER, VOTER REGISTRATION RETURN DATA CONTAINER has AT MOST ONE unique VOTER REGISTRATION ID or RSID, any number of correlated VOTER REGISTRATION ID barcode graphics, any number of correlated VOTER REGISTRATION RSID barcode graphics;
(E) and the further steps and methods whereby: (1) ALL valid RSID's created by Officials, except for any RSIDs received by all Registered Voters, or used for examples or testing purposes, are kept absolutely secret from all other Voters before and during the voting session;
(2) any public RSID used for testing or examples or information purposes is disallowed in all Eligible Voter Registrations and Voting Ballot counts and tallies;
(F) and the further steps and methods to securely mark, record, associate, attach, enclose, encrypt, embed any number of RSIDs and any number of other private, personal identifying information (such as, but not limited to: a private password, RSID) to any number of documents (such as but not limited to: MASTER Ballots, RECEIPT Ballots, Voter Registrations, internet web-pages, internet emails, Data Send/Return Containers, audio records), any number of data transmissions, any type of voting, any type of registration, or any other steps and methods of this invention.

5. The steps and methods according to claim 4, whereby any number of Officials performs steps and methods such as, but not limited to:
(A) utilizes any number of Voter lists of claim 1 to calculate and generate an estimated number of required RSIDs of claim 4, so as to accommodate all of document creations, labeling-marking, data communications and data processing needs of the invention;
(B) at least one Official takes steps to determine, assign, sort, organize, package, deliver or transmit or process any type of documents of this invention, prepared or submitted in any format, (such as, but not limited to: electronic Ballots of claim 16, paper Voter Registrations of claim 1, Voter Language forms of claim 2), and any number of any type of Data Containers prepared or submitted in any format such as, but not limited to: internet web-pages, encrypted emails, encoded electronic faxes, paper envelopes, telephone audio/text messages;
(C) and the further steps and methods of permanently recording all crucial data derived from and for generating, printing, distributing, receiving, processing of each valuable document (such, as but not limited to: Ballots of claim 2, Voter Registrations of claim 1);
(D) and the further steps and methods whereby any number of Officials provide (i) ELIGIBLE VOTERS, (ii) Officials—with the means, materials, steps and methods (such as, but not limited to: pre-printed adhesive stickers), so as to enable any number of Voters, any number of Proxy Voters, any number of Officials, to visibly mark, invisibly mark, electro-magnetically mark—on the OUTSIDE or EXTERNAL VIEW of each RETURN DATA CONTAINER (such as, but not limited to: MASTER BALLOT RETURN PAPER ENVELOPES, RECEIPT VOTER REGISTRATION ELECTRONIC DATA CONTAINER, DOCUMENT RETURN ENVELOPES, FORMS RETURN ENVELOPES, BALLOT RETURN ENVELOPES) with any number of unique RETURN DATA CONTAINER IDENTIFIER BARCODE(s), and any number of correlated RETURN DATA CONTAINER IDENTIFIER SYMBOLS that are correlated to their respective RETURN DATA CONTAINER IDENTIFIER BARCODE(s), for any number of RETURN DATA CONTAINER IDENTIFIER VERIFICATION VALIDATION text, numbers and/or symbols);
(E) and the further steps and methods whereby any number of Officials and/or any number of Officials, Official appointees/designates, Officials subordinate electronic devices actively sends, transmits, or delivers, in person or by mail or designated third party, and/or delivers according to (but not limited by) claim 9, or, by any other acceptable means conveys, any number of and any type of items of this inventions such as, but not limited to: BALLOTS, DOCUMENTS, FORMS, DATA CONTAINERS, internet web-pages, internet emails, facsimile machine transmissions (faxes) to any number of interested parties (such as, but not limited to: Voters, Media, Political Candidates, Government Officials, Voting Session Officials);
(F) and the further steps and methods whereby any number of Officials prepare and distribute to Voters, any number of BALLOT ACTIVATION document(s) such as, but not limited to: FIG. 11;
(G) and the further steps and methods of subsequently modifying and recording all the important data associated with any number of attributes associated with each Eligible Voter, each Potential Voter—in correlation with, or independent of, each type of crucial voting document (such as, but not limited to: each MASTER Ballot, each WHOLE Voter Registration Form, each Voter Language Selection form, each RECEIPT Ballot, or any other documents or “Data Containers”) using at steps and methods of processing such as, but not limited to: claim 9.

6. The steps and methods of whereby any number of Voters or Officials performs steps and methods such as, but not limited to:
(A) Receiving or accepting any number of any type (WHOLE, MASTER, RECEIPT) of Ballots of claims 3, or, receive any number of any type (WHOLE, MASTER, RECEIPT) of Voter Registration forms of claim 1, or, accepts any number of any type (WHOLE, MASTER, RECEIPT) of Voter Language Selection forms of claims 2, or, for any number and any types of DATA CONTAINERS or any number of any other type(s) of documents relevant to this invention;
(B) and the further steps and methods whereby for any number of Ballots received, any number of Official may optionally first determine if the ballot has previously been activated for use by applying the steps and methods of each correlated BALLOT ACTIVATION DOCUMENT (such as, but not limited to: FIG. 11), then act accordingly as per Voting Session Rules for Ballot processing;
(C) and the further steps and methods of Voters and Officials acting to determine the usefulness and validity of any number of the aforementioned Ballots, Forms, Data Containers, or any other documents by referring to their unique Security Elements of claim 5 (such as, but not limited to: BALLOT RSID, BALLOT PASSCODE, DATA CONTAINER IDENTIFIER) or by referring to non-security portions (such as, but not limited to: Election Information portion, or the Due Date portion, or the Due Time portion, or any other information provided), whereby confirmation employs, but is not limited to: the steps and methods of correlating and comparing any number of Security Elements of claims 1 to 5 to the Official records and may utilize any number of combinations of—Officials, Voters, telephones, computers, computer software programs, communications networks, fax machines or fax emulation software, cable television systems, electronic mail, optical scanners, or digital cameras, internet servers—to transmit and receive information, as well as confirmation, rejection, or error messages as to the validity of the Ballot, form, document, data container, or any other documents of this invention.

7. The steps according to claims 1,2,6,8 whereby any number of Voters, or, any number of Officials performs steps with methods such as, but not limited to:
(A) determine whether any number of WHOLE Ballots or constituent parts (MASTER, RECEIPT) were already used to cast a Vote by performing any number of additional steps (such as, but not limited to: claims 12, 15, 16) before revealing their Ballot Voting RSID (FIG. 5,6—item 5B) and PassCode RSID (FIG. 5,6—item 5A), and Ballot Voting Choices;
(B) and the further steps that if the Ballot is confirmed as not previously having been used to vote, any number of Voters may exchange (like monetary currency), within their official Voting Region (FIG. 19), any number of times, any number of unused WHOLE Ballots they possess for any number of unused WHOLE Ballots possessed by any other trusted Registered Voters, Voting Session Officials, or Voting Session designated agents;
(C) and the further step whereby the Voter optionally does NOT open the sealed or encrypted WHOLE Ballot Container to verify the validity of the Ballot according to claims 7,15;
(D) and the further steps and methods whereby each the Voter according to claims 3 to 15, DOES use any number of BALLOT VALIDATION RSIDs (in whole or in part), and/or any number of BALLOT VALIDATION PASSCODES (in whole or in part), as well as any number of other information and security elements displayed to verify Ballot usability and validity;
(E) and the further steps and methods whereby each BALLOT VALIDATION RSID and any number of correlated BALLOT VALIDATION PASSCODES or SENDING BALLOT CONTAINER ID are used to authenticate and verify exactly one WHOLE Ballot Container and any number of WHOLE BALLOT VOTING RSIDs within the correlated WHOLE Ballot Container, without revealing any WHOLE BALLOT VOTING RSID to anyone handing or exchanging any number of WHOLE Ballot Containers, until such time a WHOLE Ballot Container is opened at least one (WHOLE, MASTER, RECEIPT) BALLOT VOTING RSID(s) are revealed and further authenticated in correlation with any number of associated BALLOT VALIDATION RSID(s) and any other information associated with the WHOLE Ballots or WHOLE Ballot Container from which the WHOLE Ballot was extracted;
(F) and the further steps and methods of any number of Voters and any number of Officials and any number of any other Interested Parties validating according to claims 5,6 any number of: (i) Voting Ballot RSIDs (in whole or in part), (ii) Voting Ballots correlated Ballot PassCode RSIDs—by comparing to Official records using any number of communications methods (such as, but not limited to: the internet, telephone, fax, postal mail, in-person);
(G) and the further steps and methods whereby if it is determined that a Ballot Voting RSID has not been used to vote, then any number of Eligible, Registered Voter then completes any number of WHOLE Ballots whereby each Voter does any number of combinations of these following sub-steps (a), (b), (c) whereby for sub-step: (a)(i) each Voter chooses any number of pre-defined Candidates (FIG. 5—item 4A1,4B1,4C1,4D1) and/or (a)(ii) chooses any number of pre-defined Proposals (FIG. 7) on their MASTER ballot—by marking the MASTER part of the WHOLE Ballot, whereby the mark may be a circle, X, filled in circle, line, or any other style of mark in any form (e.g. such as but not limited to: pencil mark, electronic mark, symbol drawing, symbol completion) per Voting Session Rules;
(a)(iii) thus manually or automatically creating a duplicate mark on each RECEIPT part (such as, but not limited to: FIG. 6,8,10) of every correlated WHOLE ballot that shares the same RSID;
(b)(i) any Voter may be given the option to manually print or write-in, or use a typing device or electronic device interface to type in on the Voter's MASTER part of their WHOLE Ballot, (FIG. 5—items 4E2,4E3) any number of Candidate names and/or any number of Proposals (FIG. 10);
(b)(ii) whereby any number of Voters then chooses any number of their newly printed-written-in Candidates and/or any number of their newly printer-written-in Proposals of sub-step (b)(i) by marking the MASTER part of the WHOLE Ballot, whereby the mark may be a circle, X, filled in circle, line, or any other style of mark, in whatever form (e.g. such as but not limited to: pencil mark, electronic mark) as per Rules of the Voting Session,
(b)(iii) thereby manually or automatically creating a duplicate entry of their Voting Choice on each RECEIPT part of (such as, but not limited to FIGS. 6,8,10) of the WHOLE Ballot that shares the same RSID or any other method of MASTER-RECEIPT parts of every RSID correlated WHOLE Ballot;
(c) and the further steps and methods whereby any number of Voters mark and/or correlate their (i) personal signature, or, (ii) any other private identifying information (such as, but not limited to: a Voter Private Password) according to claim 5—parts C,D to any number of MASTER Ballots (e.g. near bottom of FIGS. 7, 9) and to any number of RSID or otherwise correlated RECEIPT Ballots (near bottom of FIG. 6—item 6A, FIGS. 8, 10);
(d) and the further steps and methods whereby any number of Voters mark and/or correlate the date and/or any other time identifying data to any number of MASTER Ballots (FIG. 7,9) and/or any number of RSID or otherwise correlated RECEIPT parts of each WHOLE Ballots;
(e) and the further steps and methods whereby any number of Voters mark and/or correlate RECEIPT Ballot, any number of: (i) personal signatures, or, (ii) Voter Private Password(s) and/or Symbolic Passcodes (FIG. 6—item 6A); (ii) and the further steps and methods whereby any number of Voters mark and/or correlate the date the ballot was signed or cast (such as, but not limited to FIG. 10, item 4B) and/or any other time identifying information to any number of RECEIPT Ballots (FIG. 6—item 6B, FIG. 8,10); (iii) and the further step whereby any number of Voters keep any number of RECEIPT Ballots that are correlated to completed MASTER Ballots;

8. The steps and methods whereby any number of Voters, Proxy Voters and any number of Officials take steps to ensure privacy, such as, but not limited to—
(A) mark and/or correlate their personal signature or any other private identifying information (such as, but not limited to: social security number, private password) and any number of Security Elements (such as, but not limited to: Ballot RSID, Ballot passcode) to be hidden from visibility and contained on the INSIDE of any number of, and any type (such as, but not limited to: paper, electronic) of SENDING DATA CONTAINERS and any type of RETURN DATA CONTAINERS (such as, but not limited to: MASTER Ballot Return Envelopes, Electronic Ballot Data Containers;
(B) and the further steps and methods according to claim 4 whereby any number of ELIGIBLE VOTERS apply and utilize the Official given means and methods (such as, but not limited to: pre-printed adhesive stickers) to actively mark, on the OUTSIDE or EXTERNAL VIEW of each RETURN DATA CONTAINER (such as, but not limited to: MASTER BALLOT RETURN PAPER ENVELOPES, RECEIPT VOTER REGISTRATION ELECTRONIC DATA CONTAINER, DOCUMENT RETURN ENVELOPES, FORMS RETURN ENVELOPES, BALLOT RETURN ENVELOPES) EACH with: (i) any number of unique RETURN DATA CONTAINER RSID BARCODE(s); (ii) any number of RETURN DATA CONTAINER RSID SYMBOLS that are correlated to the value of the RETURN DATA CONTAINER RSID BARCODES;
(C) and the further steps and methods of enclosing, attaching or correlating:
(i) any number of any type of documents (such as, but not limited to: VOTER REGISTRATION MASTER part(s), VOTER REGISTRATION RECEIPT part(s), MASTER BALLOTS, RECEIPT BALLOTS);
(D) and the further steps of correlating any number of RSIDS (such as, but not limited to WHOLE BALLOT VOTING RSID, VOTER REGISTRATION RSIDs), and any correlated SYMBOLS and alpha-numeric values thereof, to be further correlated to any number of BARCODES (such as, but not limited to: WHOLE BALLOT RSID BARCODE, VOTER REGISTRATION RSID BARCODE), with any type (such as, but not limited to: SENDING, HOLDING, RETURN, VERIFY, COUNT, CERTIFIED, FINAL TALLY, STORAGE) DATA CONTAINER(s) (such as, but not limited to BALLOT RETURN DATA CONTAINER(s)), MASTER BALLOT RETURN DATA CONTAINER(s)) and the associated DATA CONTAINER RSID(s) with correlated DATA CONTAINER BARCODE(s) and any other types of DATA CONTAINER MARKING SYMBOLS;
(E) and the further steps and methods whereby any number of Voters (or Voter Proxies) actively sends, transmits, or delivers, in person, by mail, by designated third party, or electronically according to claims 16 (using methods such as, but not limited to: internet email, internet webpages, interactive television, facsimile machines, telephone text messages), or, by any other acceptable means conveys, according to (but not limited by) claim 9—(i) any number of any type(s) of Voter Registration forms, (ii) any number of any type(s) of Ballots, (iii) any number of, and any type of documents or forms (such as, but not limited to: LANGUAGE SELECTION FORMS (FIG. 3), Ballot Activation Forms (FIG. 11); and (iv) any number of any type of DATA CONTAINERS of this invention; —to any number of Officials, Voters, and any number of any types of entities such as, but not limited to: public, news media, politicians, shareholders.

9. The steps and methods whereby any number of Officials, Officials appointees, Officials subordinate devices SENDS, RECEIVES or PROCESSES any number of, and any type of documents such as, but not limited to: (WHOLE, MASTER, RECEIPT) Voting Ballots, Voter Registration forms (such as, but not limited to: Identity-Registration, Voter Language, Political Party), DATA CONTAINERS, electronic data transmissions (such as electronic mail (email), faxes, audio recordings) and any number of document portions thereof, (such as, but not limited to portion elements, barcodes, electronic data representations, portion alignment markings, document orientation markings); and the further steps and methods whereby any number of Officials, as well as any number of, and any types of correlated information elements that applies to each, the further steps and methods such as, but not limited to: researching, identifying, defining, designing, verifying, correlating, authenticating, amending, certifying, preparing, organizing, sorting, assembling, recording, storing, printing, publishing, distributing, receiving, creating, assigning, attaching, linking, embedding, encoding, decoding, encrypting, decrypting, compressing, decompressing, converting, accepting, receiving, recording, electronic scanning, optically scanning, recording, enhancing, storing, creating any number of identical duplicate backup copies, correlating, tallying, counting, calculating, correlating, associating, searching, sorting, organizing, marking, labeling, tagging, identifying, acknowledging, error identification, error recording, error correction, error transmission, error reception, error reporting, authenticating, verifying, validating, certifying, summarizing, reporting, communicating, printing, publishing, transmitting, receiving, compressing, decompressing, encrypting, decrypting, interpreting, converting, locating, detecting, reading, receiving, interpreting, translating, transmitting data to, and receiving data from, any number of—humans, legal entities, computers, electronic, mechanical or optical devices, telephones, communications networks and is to include all steps and methods of translating human and device readable codes to modes, protocols or methods of communication, transmission, reception, decryption, encryption, compression, decompression, as well as, (but not limited to) the steps and methods of locating, receiving, detecting, interpreting, translating, reporting, and transmitting error free data, and the further steps of locating, receiving, detecting, interpreting, translating, reporting transmitting, and correcting compromised data, erroneous data, duplicate data or duplicate transmissions; and the further steps and methods, whereby the aforementioned functions, operations and processing of this claim are performed by (but not limited to) any combination and any number of any plurality of—Official persons, designated agents, data acquisition devices, electronic, electromagnetic, optical or biological or other computing or analytical devices, communication networks, any other man-made devices, computers, microprocessors, computer software programs, telephones, facsimile (fax) machines, fax software, optical scanners, audio recording equipment, audio playback systems, video recording equipment, video playback systems, communication networks, cable television systems, electronic mail, data encryption methods, data decryption methods, data conversion methods, data reconstruction methods, data compression methods, data decompression methods, data inventory software, data organization software, data tracking software, data retrieval software, printing software, printers, package labeling software and equipment, package identification software, package tracking software, either separately, or, in combination with of any number such as, but not limited to: Security Elements of claim 6, for any number and type of object of this invention, (such as, but not limited to: Ballots, Registration Forms); and the further steps and methods of enhancing processing speed and/or accuracy for any number of, and, any type of document(s) (such as, but not limited to: registration, ballot, data container, email, fax printout), may have printed, affixed, attached or embedded—any number of electro-magnetic fields, optical scanning markings, optical alignment markings or optical skew markings (FIG. 5—items 1A1-9, 1B1-9, 2A1,2; FIG. 1—items 12D1,12D2) to ensure proper optical scanning, and/or proper electromagnetic processing; and the further steps and methods of enabling optical or physical orientation such as, but not limited to: a darkened, or highlighted or cut-away corner (such as but not limited to FIG. 5—top right corner) that is to be consistently implemented so as to enable sorting among (such as, but not limited to: Registration form: V-notch at top-centre, Ballots notch top-right corner), and/or, identical orientation of all of the same type of document(s) (such as, but not limited to: registration, ballot, data container, email, fax printout), so as to identify a consistent orientation (such as, but not limited to: front face in view and top edge uppermost) to assist in sorting, organizing, scanning, counting and any other human, mechanical, optical, electronic or hybrid processing or other processing whereby any number of (but not limited to) the aforementioned steps and methods are used so as to enable rapid automated optical scanning using high speed scanning devices, computers, using the steps and methods according to (but not limited to) this claim; and the further steps and methods for any number of, and any type of document(s), and any number of information elements thereof (such as, but not limited to: first name, family name, social insurance number), the further steps and methods of calculating, generating, printing or displaying (on any type of, and any number of documents) any number of, and, any type of barcode symbols that are correlated to their respective source information element(s); and the further steps and methods to retrieve or scan any number of any type of data elements or groups of human readable words, numbers and symbols that are regarded as or correlated as the source for the information element for each barcode; and for corroboration of accuracy, the further steps and methods of comparing the values and/or symbolic representations of each information element to the values or symbols derived from scanning the correlated barcodes; and the further steps of recording the results of comparison, signaling any number of error messages, and option steps of error verification analysis, error correction, error correction analysis so as to facilitate the accurate scanning of data on any type document(s) (such as, but not limited to: ballots, registration forms, document(s), data containers, fax transmissions, emails, internet web-pages) that are in a good condition for processing.

10. The steps and methods of conducting a Voting Session according to claims 1 to 20, whereby according to claims 6,7,8,9 Officials do accept, receive, acknowledge, sort, organize, record, store, tally, calculate, summarize, print or publish or otherwise process according to claims 1 to 9 whereby:
(A) any number of “voting documents” such as, but not limited to: (i) Voter Lists of claim 1, (ii) any number of Voter Registrations (WHOLE, MASTER, RECEIPTs) of claims 2,7,8 (iii) any number of Voter Language Selections (WHOLE, MASTER, RECEIPTs) of claim 2,7,8 (iv) any number of Voter Ballots (WHOLE, MASTER, RECEIPTs) of claims 2,7,8 (v) or any number of Data Containers of claim 5;
(B) and the further steps and methods whereby EACH created “voting documents” (such as, but not limited to: Voter Registration forms, Voter Language form, Ballot, Data Container) is assigned at least one new, unique data record containing at least one variable content data fields, and all records are stored in at least one data system which comprises of a new record identifier, date, time, location, and any number of other attributes are updated as needed to describe the various data and status conditions for each “voting document”;
(C) (i) and the further steps and methods whereby for processing of Voter Ballots includes data fields such as, but not limited to: a portion containing any number of candidates (FIG. 5—items 4A2-4 to 4E2-4), proposals (FIG. 9—items 4A1-6, 4B1-6, 4C1-6) or any number of both candidates and proposals, which are further correlated with any number of barcodes and further correlated with a portion of the area assigned to mark or record each voter selection (FIG. 5, items 4A1-4D1,4E1-4) voting information such as, but not limited to: at least one Voting Region Identifier (a.k.a. Major Voting Zone FIG. 5. Items 2B,5G), any number of subsidiary Voting Region Identifiers (a.k.a. secondary voting regions-zones FIG. 5—items 3A3,3A4), any number of polling station identifiers (FIG. 5—items 3A5,5F) any number of Postal Code-Zip Code identifiers, any number of geographic location identifiers (FIG. 5—items 2B,3A3,3A4, 5E, 5G) any number of election type identifiers (FIG. 5—items 2C,3A1,3A2,5D) any number of due date identifiers (FIG. 5—item 2E), any number of due time identifiers (FIG. 5—item 2D), any number of activation and/or expiry date identifiers (FIG. 5—item 2F, 5I1, 5I2), any number of activation and/or expiry time identifiers (FIG. 5—item 2F, 5I1, 5I2), any number of Election Identifiers (FIG. 5.—item 5C, 5K1,5K2), any number of other codes or other identifiers (FIG. 5—items 5H, 5I1,5I2), any number of Security Elements (FIG. 5—item 2D), at least one BALLOT VOTING RSID (FIG. 5—item 5B1, 5B2) or Registration RSID, any number of VOTING Ballot PassCode RSIDs (FIGS. 6,8—item 5A2), any number of Ballot Validation Passcodes RSIDs (FIG. 5—item 5H,5I2), and the further steps of encrypting and correlating correlating any number of Ballot Validation Passcode RSIDs (such as, but not limited to: FIG. 5—item 5H encrypted and correlated to item 5I2) that may be further correlated to any number of barcodes (FIG. 5—item correlated to 5I1); (ii) and the further steps and methods of correlating and storing each item of each Voter Ballot to a data field within the same unique data system record; (iii) and the further steps and methods of providing a data retrieval key value for rapid location and retrieval of the aforesaid data-items;
(D)(i) and the further steps and methods of processing for any number of Voter Registrations includes (but is not limited to) processing any number of personal identifiers (FIG. 1—items 14A1-A4), any number of printed names (FIG. 1—items 14B1-D1), any number of signatures (FIG. 1—item 15L1), any number of date information (FIG. 1—item 15L2), any number of address information (FIG. 1—items 15H1,2,3 and 15J1,2,3); any non-mail contact information (such as, but not limited to: email address (FIG. 1—item K5), cellphone number (FIG. 1—item K3 alternative), home phone number (FIG. 1—item K4), work phone number (FIG. 5—item K3) and any number of any other types of Voter information;
and (ii) the further step of correlating and storing each item of each Voter Registration to a data field within the same unique data system record; (iii) and the further steps and methods of providing any number of data retrieval key values to expedite data storage, location and retrieval;
(E) and the further steps and methods of processing for any number of Voter Language forms and all the relevant information therein (such as, but not limited to: any number of Voter Language Selections, any number of date information, any number of location information; Voter Signature) in a manner similar to the prior steps and methods of this claim;
(F) (i) the steps and methods of processing any number of personal identifiers, as well as the steps and methods for each Ballot, Registration or Language form of correlating of each aforementioned identifier or to the respective barcodes or other optical scanning markings or encodings, or electronic processing markings or encodings; (ii) and the further steps and methods of creating, assigning, attaching, linking and processing additional encoding for electronic or optical MASTERs to ensure accurate processing according to claims 8,9;
(G) and the further steps and methods of data storage, retrieval and organization of received Ballots, Voter Registrations and Voter Language forms so as to be easier to record, tally, identify, sort, store, locate, retrieve, publish or otherwise process according to claim 9;
(H) and the further steps and methods whereby Officials create, distribute and otherwise process (according to claim 9) any number of acknowledgements for each WHOLE Voter Registrations, MASTER Voter Registrations, RECEIPT Voter Registrations, WHOLE Ballots, MASTER Ballots, RECEIPT Ballots, WHOLE Voter Language forms, MASTER Voter Language forms, RECEIPT Voter Language forms, received from any number of Eligible Voters of claim 1, any number of Potential Voters of claim 1, or any number of Ineligible Voters of claim 1, and any number of designated representatives (proxies) or any other approved legal entities of claim 1;
(I)(i) and the further steps and methods whereby Officials receiving any number of MASTER Ballots, or, any number of RECEIPT Ballots, or, any number of both MASTER Ballots and RECEIPT Ballots, and any number of any other type of object, such as, but not limited to: Voter Registration Form of claim 2; (ii) and the further steps and methods whereby at least one Official accepts or rejects the validity and authenticity of each ballot, form, document or container;
(iii) and the further step of at least one Official validating then accepting any number of AUTHENTICATED, VALID documents (such as, but not limited to ballots) for recording and tallying;
(iv) and the further steps and methods of verifying (using methods such as, but not limited to: voting officials manual visual comparisons, optical-electronic data scanning and computer running software programs performing signature-address validation comparisons) each signature and any number of contact and/or address information located INSIDE or OUTSIDE of the BALLOT RETURN DATA CONTAINER or any other type of DATA CONTAINER so as to be compared to the signature, contact, address data recorded on the MASTER Voter Registration Form submitted prior to any Ballot delivery; (v) and the further steps and methods of either accepting the ballot as being from a registered voter, and then forwarding the ballot for further processing associated with completing the voting, or, rejecting the ballot and then taking steps such as, but not limited to: either returning the ballot and ballot-address-signature card to the voter for amendment(s) or, holding the ballot and ballot-address-signature card for further processing of investigations and not associated with completing the ballot voting pending the results of investigations; (vi) and the further steps and methods whereby at least one Official determines whether each received documents (such as, but not limited to voter registrations, ballots) were previously processed or recorded in the current Voting Session; (vii) and the further steps and methods whereby at least one Official designates any number of verified, authenticated documents (such as, but not limited to voter registrations, ballots) that were submitted only once for the voting session as being CERTIFIED documents (such as, but not limited to voter registrations, ballots); (viii) and the further steps and methods whereby all Officials accept only CERTIFIED documents (such as, but not limited to voter registrations, ballots) for recording, tallying, calculating, summarizing, publishing and certifying of interim and final voting session results; (ix) and the further steps and methods whereby Officials record, tally, summarize, calculate, certify and publish any number of documents (such as, but not limited to voter registrations, ballots) received by Officials; (x) and the further step of sorting and organizing any number of received documents (such as, but not limited to voter registrations, ballots) and any other voter or other information, in any format, so as to be logical to store, locate and retrieve.

11. The steps and methods according to claims 9 and 10 whereby:
(A) any number of documents (such as, but not limited to Voter Registration, Voter Language Registration, Whole Ballots, Master Ballots) or any number of SEND or RECEIVE Data Containers (such as for, but not limited to: Ballot, Registration) that are created, printed, sent or received and found to contain an RSID or any other ID that is determined to have been previously submitted, the Ballot or form is identified, uniquely marked, recorded, tallied, removed and stored separate from all tallies of valid, authenticated, certified ballots, for further investigation along with all other Ballots sharing the same unique RSID or Voter Registration ID or Voter Language ID;
(B) and the further steps and methods of determining, any number of times, the truly authentic, valid, certifiable Ballot or Voter Registration, from a group of duplicate MASTERs;
(C) and the further step of restoring each authentic, valid, certifiable Ballot or Voter Registration or Voter Language form to normal processing steps associated with all valid, authentic, certified Ballots, Voter Registrations or Language forms or any other type of Container (such as but not limited to Ballot Container, Registration Container) in any form and in any format.

12. The steps and methods according to claims 1 to 20 whereby:
(A) any number of Voters request any number of replacements of any number of Voting Session Items such as, but not limited to: Ballots of claim 3, Registration Forms of claim 2;
(B) and the further steps whereby any number of Officials determine, for each Voter, the appropriateness to provide any number of replacement objects for any number of Voters requesting replacements; (iii) and the further steps and methods whereby any number of Officials provide any number of replacement items to any number of Voters; (iv) and the further steps and methods whereby at least one Official records ALL relevant data regarding the replacement items provided and the recipient voter the item was provided to, so as to accurately amend Official records.

13. The steps and methods of conducting a Voting Session according to claims 1 to 20, whereby according to claim 12, election officials provide any number of devices and objects which can provide a reliable, secure methods of data storage that are permanent, unalterable, immutable records (such as, but not limited to: a securely stored CDROM) of Crucial Integrity Data Items (such as, but not limited to: the Ballot Voting RSIDs, Ballot Validation RSIDs, Ballot Passcodes, Voter Registration IDs, etc., RSID Correlation Data Tables, etc.) for any number of—Ballot(s), Container(s), Voter Registration Form(s), Voter Language Form(s), or any other type of Document(s), Form(s), Container(s) or data record(s) used in each Voting Session.

14. The steps and methods according to claims 1 to 13 whereby at least one Official records and provides a RECEIPT for each Eligible Voter of claim 12, or, to each Voter of claim 1,2,3, or to any number of Officials, requesting investigation of errors or omissions pertaining to Voter Registrations (WHOLE, MASTER, RECEIPTs) or Ballots (WHOLE, MASTER, or RECEIPTs) or both Voter Registrations and Ballots, along with all relevant details, then Officials or their designated agents proceed to investigate whether to accept or reject each Voter request to amend any errors, record the Official findings of the investigation, and when required, Officials amend any number of disputed records, tallies, summaries, calculations, and publications for any number of Voter Registrations (WHOLE, MASTER, RECEIPTs) or Ballots (WHOLE, MASTER, or RECEIPTs), WHOLE Ballot Containers, Voter Information Containers, in accordance with the findings and Voting Session Rules, then any number of times, Officials verify each amendment was completed accurately, or resubmit any number of amendments, then provide a report to each complainant Voter and any number of other interested parties such as, but not limited to: news media, public, politicians, shareholders.

15. The steps and methods of claims 2, and claims 1 to 14, whereby:
(A) the WHOLE Ballot comprises of a MASTER Ballot, at least one RECEIPT Ballot, at least one unique BALLOT VOTING RSID (that is optionally extremely difficult to guess), and any number of Ballot PassCode RSID(s) (a.k.a. BALLOT PASSCODE) that is difficult to guess and kept hidden until the ballot is to be cast;
(B) and the further steps and methods whereby for each WHOLE Ballot, any number of additional BALLOT VALIDATION RSIDs (VAL-IDs) whereby each BALLOT VALIDATION RSID is unique among all VALIDATION RSIDs of any type, and each BALLOT VALIDATION RSID is also unique among all BALLOT VOTING RSIDs for that election;
(C) and the further steps and methods whereby each unique BALLOT VALIDATION RSID is correlated to exactly one WHOLE BALLOT or one WHOLE BALLOT CONTAINER and any number of WHOLE BALLOTS associated with the WHOLE BALLOT CONTAINER;
(D) and the further steps whereby each BALLOT VALIDATION RSID is further correlated to any number of WHOLE BALLOT VOTING RSIDs within a WHOLE BALLOT CONTAINER;
(E) and the further steps and methods whereby any number of BALLOT VALIDATION RSIDs are printed, embedded, attached or otherwise associated with the publicly visible exterior of a WHOLE Ballot Container (such as, but not limited to—a paper envelope, an electronic encrypted container (such as, but not limited to: an encrypted file, a secure webpage, a secure email postbox)) along with any number of details of the voting session (such as, but not limited to—election description, ballot voting political region, poll station ID, candidates, ballot due date and due time, ballot expiry date, etcetera) and any number of Security Elements of claims 2,6 (such as, but not limited to hologram, embossed letters, official document seal, Ballot VALIDATION RSID) are printed, embedded or otherwise associated and displayed clearly and prominently so as facilitate equitable ballot use and validation for exchanges by clarifying exactly which elections and voting region the WHOLE Ballot Containers internal ballot(s) and VOTING Ballot PassCodes correspond to, and what time frame these items are useful for;
(F) and the further steps whereby if the WHOLE Ballot Container is physical (such as, but not limited to: paper envelope, plastic card with embedded electronic circuits and software (such as but not limited to: Java software enabled smart card keys)), the container may also be perforated along any number of edges or otherwise may be made to access the Ballots without damaging the physical form of the MASTER Ballot(s) and RECEIPT Ballots within;
(G) and the further steps and methods whereby if the WHOLE Ballot container is electronic, that the MASTER and RECEIPT Ballot information may not be easily revealed without decryption using any number of BALLOT VALIDATION PASSCODES (whereby a BALLOT VALIDATION PASSCODE is similar to a VOTING BALLOT PASSCODE however is instead correlated to a specific BALLOT VALIDATION RSID) and/or other data manipulation steps and methods; (viii) and the further steps and methods whereby any number of Security Elements of claims 2,6 as well as any number of steps and methods of claim 9, may also be implemented consistently and effectively to ensure the protection of sensitive data (for example, but not limited to: information obfuscation or encryption/decryption) as well as ensuring other criteria such as, but not limited to: data integrity, accuracy and longevity.

16. The steps and methods according to claims 1 to 15, 17-20 whereby for any number of Registered Voters, the electronic voting methods (such as, but not limited to: internet, interactive television, fax, email, telephone voting) are such as, but not limited to:
(A)(1) any number of Electronic Voters (eVoters) uses at least one electronic device (such as, but not limited to: any number of computers running software programs, telephones, facsimile machines (fax), interactive television systems) to connect to any number of public or private communications systems, and then to further connect to at least one Official Voting Session Electronic Interface System used specifically for connecting to eVoter electronic devices (FIG. 14).
(A)(2) optionally, any number of eVoters provide EVOTES with adequate Voter Registration data to authenticate their valid participation in the Electronic Voting Session;
(A)(3) optionally, any number of Officials validate any number of Voter Registrations information to enable any Registered Voters to employ an Electronic Voting Session;
(B) any number of eVoters use their electronic device(s) to employ any number of Voting Session's Official Electronic Voting System (EVOTES) computers to verify any number of Ballot Container VALIDATION RSIDs;
(C) any number of eVoters opens any number of WHOLE Ballot Containers they possess and then verifies any number of Ballot VOTING RSID(s) obtained from any number of WHOLE Ballots therein by using their electronic device(s) to employ any number of Voting Session's Official Electronic Voting System (EVOTES) computers to verify any number of Ballot VOTING RSIDs;
(D) any number of eVoters then verifies any number of Ballot PASSCODE RSID(s) (a.k.a. Voter Privacy Code—FIG. 5,7 item 5A1, FIG. 6,8 FIG. 5A2) obtained from any number of WHOLE Ballots they possess by using their electronic device(s) to employ any number of Voting Session's Official Electronic Voting System (EVOTES) computers to verify any number of Ballot VOTING RSIDs;
(E)(1) each eVoter that submits a valid Ballot Voting RSID, and when utilized, a valid, correlated Ballot Passcode RSID (Voter Privacy Code) is enabled to cast their ballot vote(s) electronically;
(E)(2) any number of eVoters are enabled by Officials to cast their vote(s) electronically by;
(E)(3) the further steps according to claims 5-15 whereby any number of eVoters complete any number of MASTER Ballots electronically by entering data such as, but not limited to: Ballot Candidate selection(s), signature or voter private password;
(E)(4) EVOTE system enables methods for changes of data for each editable part of each eVoter Ballot, and for any number of eVoter Ballots;
(E)(5) for each eVoter, and for any number of eVoters, the EVOTE system checking for errors and omissions of data, and upon finding errors or omissions, EVOTES sends at least one message to each faulty eVoter identifying the errors and omissions and also requesting eVoter amendment(s); (E)(6) the further steps of any number of faulty eVoters successfully changing their faulty Ballot completion data, and thereafter re-submitting the corrected data to EVOTES; or, alternatively, any number of faulty eVoters fail to correct their errors in a timely manner and sent an error message and the eVoter is then disconnected from the EVOTE system, each uncorrected eVoter Ballot is marked INCOMPLETE;
(E)(6) the further steps of EVOTE system detecting no errors or omissions in the submitted eVoter Ballot, then EVOTES accepts the electronically cast ballot, marks the Ballot as COMPLETED in the EVOTE system, and sends each successful eVoter a message.
(F)(1) the further steps of the EVOTE system generating, recording, and sending to each successful eVoter, and any number of eVoters, at least one correlated RECEIPT Ballots (FIG. 13) for each COMPLETED eVoter Ballot of the preceding steps;
(F)(2) and the further or alternative steps and methods of EVOTES generating, recording and sending any number of successful completion RECEIPT CONFIRMATION documents (such as, but not limited to FIGS. 12, 13) that are delivered to each successful eVoter by methods such as, but not limited to: in person paper receipts, mail paper receipts, or electronic mail receipts, or, internet website web-page(s) whereby the Ballot Voting RSID is part of the internet address and optionally, the correlated Ballot Passcode RSID is used to gain access to see the linked Voting RSID specific webpage;
(F)(3) and the further steps of EVOTE system sending any number eVoter receipts to any number of third parties to verify the integrity of the Voting Session;
(F)(4) and the further steps whereby the EVOTE system broadcasts or makes publicly available any number of copies of each submitted electronic and printed document Ballot using methods such as internet webpages and downloadable pdf format document files.
(G) and the further steps whereby any number of eVoters appropriately mark and deliver their authentic MASTER Ballot parts to Elections for verification and corroborative tallying;
(H) and the further steps of further modifying any parts of this entire claim for application to electronic Voter Registration for any number of Eligible Voters;
(I) and thereafter modifying this claim further for use with any other type of electronic data processing of this invention;
(J) (1) and the further steps and methods whereby any number of Officials and any number of Voters employ any number of, and, any type of optical and electronic devices connected to any number of Interactive TeleVision Communication Systems (ITVCS) employed for sending, receiving, verifying, selecting choices, and further processing any number of any types of documents such as, but not limited to: Voter Registrations, Whole Ballots, Language Selection documents and their constituent parts thereof;
(J)(2) and the further steps of modifying and applying the steps and methods of INTERNET VOTING of part (K) below, and of further adapting any other part of this invention so as to facilitate accurate, electronic voting by use of Interactive Television;
(J)(3) and the further optional steps and methods of embedding encrypted signals of images of any documents of this invention, (such as, but not limited to: WHOLE Ballots) that require the use of special equipment to see and utilize (such as, but not limited to: special 3D glasses tuned to specific frequencies of light, calibrated for a specific display);
(K) the further steps and methods of INTERNET VOTING, whereby any number of eVoters perform Internet Validation (NETVAL) and Internet Voting (NETVOTE) steps and methods such as, but not limited to: (K1) use the Internet to connect to at least one Official Internet Voting Website that is secured from unauthorized manipulation; (K2) navigate from any number of webpage menus to a secure webpage form used for validation; (K3a) where upon accessing this webpage, an Internet Validation Session ID (IVALSID) is created by the Official Computers and correlated to each particular connected Voter; (K3b) obtains and utilizes any number of authentication certificates from any number of certificate authorities that are correlated to the respective IVALSID or IVOTSID; (K4) whereafter any number of connected Voters then enter a VALIDATION RSID or BALLOT VOTING RSID on their local computer Internet Browser webpage form and submit that form to the Internet Validation System (IVALS) for processing according to (but not limited to) claims 9; and (K5a) whereafter the IVALS correlates the IVALSID to the RSID submitted, records this information along with, but not limited to: the Voter computer IP address, date and time; and (K5b) the Official computer system employers computer running software programs and people to determine whether there have been statistically numerous RSID MASTERs from the Voter computer IP address for a given time period, and if so, communicates Denial Of Service (DOS) to the Voter and stops further processing of any number of offending Voter submitted RSID's; and (K5c) whereby if there is no Denial of Service, the IVALS continues to determine whether the submitted VALIDATION RSID or correlated BALLOT VOTING RSID is valid and any number of other information items; and (K5d1) whereby if the Voter enters a VALIDATION RSID that is determined to be valid, the voter is shown STATUS information of the Ballot (such as but not limited to: VOTED-OK, READY2VOTE, DISABLED) that is correlated to the VALIDATION RSID, but is NOT shown the BALLOT VOTING RSID, BALLOT PASSCODE nor any BALLOT SELECTIONS of the Voter; (K5d2) whereby if the Voter enters a BALLOT VOTING RSID that is determined to be valid, the voter is shown STATUS information of the Ballot (such as but not limited to: VOTED-OK, READY2VOTE, DISABLED) as well as the VALIDATION RSID, BALLOT VOTING RSID; and (K5d3) whereby the IVALS prompts the Voter, a limited number of times, to provide any number of BALLOT VOTING PASSCODE on a secure website form; and (K5d4) whereby any number of Official people and/or computers running software programs, determine whether the BALLOT VOTING PASSCODE provided in step (K5d3) is correlated to the BALLOT VOTING RSID of step (K5d1,2); and (K5d5) the further steps and methods of to determine whether the number of attempts to provide a VALID BALLOT VOTING PASSCODE has exceeded limitations; and (K5d6) the further steps and methods of temporarily disabling the BALLOT if the number of attempts to provide a VALID BALLOT VOTING PASSCODE if step (K5d5) are found has exceeded limitations; and (K6) and the further steps and methods according to this claim, whereby if the Voter enters a BALLOT VOTING PASSCODE RSID that is determined to be valid, and the BALLOT VOTING RSID has NOT been disabled then the voter receives the VALIDATION RSID, VOTER SELECTIONS and any number of other information items associated with of the BALLOT VOTING RSID; and (K7) the further steps and methods according to this claims whereby if the ballot has not been cast, the voter is provided (but not limited to) the options to vote or not vote; and (K7a) the further steps and methods of the choice of NOT VOTE, the Voter exits Internet Validation System (IVALS) without adversely disabling the Ballot from future use; and (K7b) the further steps and methods upon the Voter choice to VOTE: (K7b1) the Voter is connected by Official Voting Computer to the Internet Voting System (IVOTS) webpage; (k7b2) a unique Internet Voting Session ID is generated, stored and associated with the BALLOT VOTING RSID provided by the Voter; and (K7b3) the IVOTS provides the Voter with any number of choices such as, but not limited to, any number of: (K7b3i) Candidates, (K7b3ii) Proposals, (K7b3iii) related information items (such as but not limited to: web page hyper-links to Candidate biographies, hyper-links to Candidate political party affiliations and policies, hyper-links to Proposal descriptions), (K7b3iv) options to process the Voting form (such as, but not limited to: SUBMIT, CANCEL, RESET, PAUSE, SAVE, EXIT); (K7b3v) options to store and communicate selections made, such as, but not limited to: (SAVE2DISK, PRINT, PUBLISH, EMAIL); and (K7b4) the further steps and methods whereby the Voter completes and submits their Ballot selections; (K7b5) then any number of errors are detected and identified to the Voter by the IVOTS computer software, (K7b6) whereby any number of corrections are made, any number of times, by each Voter until ALL Ballot selections are error free, (K7b7) whereby the Voter submits the Ballot Selections for final processing to the IVOTS, and (K7b8) the further steps and methods whereby if the Ballot Selections are processed successfully, (K7b8i) a unique IVOTS RECEIPT ID is generated, then correlated to the IVOTS Session ID and further correlated to the BALLOT VOTING RSID and BALLOT VOTING PASSCODE, and further correlated to the BALLOT VALIDATION RSID that is correlated to the BALLOT VOTING RSID; and (K7b8ii) the further steps and methods whereby the IVOTS RECEIPT ID, Session ID, BALLOT VOTING RSID, BALLOT VOTING PASSCODE, BALLOT VALIDATION RSID, Ballot Selections and any number of other related information items are permanently and redundantly stored, then transmitted securely to, and received by, but not limited to: any number of Election Officials, Political Parties, Candidates, and any number of other approved third parties (such as, but not limited to, independent, non-partisan vote auditors, the news media), for actions such as, but not limited to: verification and accounting in any number of formats (such as, but not limited to: printed, Television Broadcast, electronic file (such as but not limited to: webpage, email, pdf, jpeg) for example, such as but not limited to: using the unique, private Ballot RSID as part of an Internet address to organize and privately store each voter webpage, as well as tallies and summaries of voter selections) employing any number of methods of processing according to (but not limited to) claims 9; and (K7b9) the further, optional, steps and methods for each INTERNET Ballot, of detecting, reporting, and stopping processing of appropriate Ballot cast via IVOTS upon detecting NOT timely receiving the PRINTED MASTER or RECEIPT Ballot, or, disregarding any number of failures of delivery of any number of PRINTED MASTER or RECEIPT Ballots that are correlated to an INTERNET Ballot cast via the Internet Voting System (IVOTS); and (K8) the further steps and methods of transmitting any number of RECEIPT CONFIRMATION documents (such as, but not limited to FIGS. 12, 13) to each voter either electronically, (using methods such as, but not limited to: webpage form, email to each voter provided email, or electronically printed paper receipt documents) to each voter who has successfully submitted their ballot(s), registration or any other document(s) in person or electronically; and (K9) the further steps of applying any number of the aforementioned steps and methods, actions, data or results any number of times, to any number of Ballots, Voters, Officials, or other legal entities, by any number of Voters, Officials or other legal entities; and
(L) the further steps and methods of TELEPHONE VOTING, whereby the steps and methods used are such as, but not limited to: (L1a) Telephone Validation—whereby any number of Voters use a telephone to first connect to the Telephone Validation System (TELVALS); and (L1b) any number of Official computers running software programs create a Telephone Validation Session Identifier (TELVALID) for each Telephone call that is automatically identity labeled and correlated to the Telephone Validation Session; (L1c) any number of Official computers running software programs obtains and utilizes any number of authentication certificates from any number of certificate authorities that are then correlated to the TELVALID; and (L1d) any number of Official recording devices are automatically connected and record the Telephone Validation Session; and (L1e) any number of Official computers running software programs optionally determine the Voter Telephone Number to detect issues such as, but not limited to: excessive RSID guessing; and (L1f) the voter uses the telephone keypad, verbally words, or any other acceptable methods to navigate through any number of menus and any number of menu options to interact with the validation menu; and (L1g) each Voter then uses an approved method (such as, but not limited to: keypad tones, verbal words, text message menu option selections) to enter a BALLOT VALIDATION RSID or BALLOT VOTING RSID; and (L1h) the TELVALS records the RSID and correlates it to the TELVALSID along with the date, time and optional voter telephone number; and (L1i) Official TELVALSID system then determines whether any statistically significant issues are related to the voter telephone number or RSID provided, and if so, then communicates a Denial Of Service to the voter; otherwise, TELVAL system proceeds to determine whether the BALLOT VALIDATION RSID or correlated BALLOT VOTING RSID are valid along with any number of other information items; (L1j) whereby if the Voter enters a BALLOT VALIDATION RSID that is determined to be valid, the voter is informed of the STATUS information of the Ballot (such as but not limited to: VOTED-OK, READY2VOTE, DISABLED) that is correlated to the BALLOT VALIDATION RSID, but is NOT informed of the BALLOT VOTING RSID, BALLOT PASSCODE nor any BALLOT SELECTIONS made by the Voter, and (L1k1) if a valid BALLOT VALIDATION RSID correlated to valid, enabled, BALLOT VOTING RSID was provided by the voter, the voter is given the option to vote via telephone such that on selecting the choice to NOT VOTE, the voter then exits the Telephone Validation System Telephone call is terminated by Officials; otherwise, (L2a) on selecting VOTE, the Voter remains connected to the Telephone Validation System (TELVALS) and (L2f) the TELVALS prompts each Telephone Voter for their Ballot PassCode; and (L2b) any number of Telephone Voters provide any number of Ballot Passcodes before the TELVALS terminates the call for issues such as, but not limited to: too much elapsed time, no response from Voter, too many attempts; and (L2c) whereafter TELVALS and any number of Officials determine whether the BALLOTPASSCODE provided by the Voter is valid and correlated to the BALLOT VOTING RSID; and (L2d) if the number of attempts to provide a VALID BALLOT PASSCODE has exceeded limits this results in disabling the BALLOT from voting for a period of time; and (L2e) whereby if the Voter enters a BALLOT PASSCODE RSID that is determined to be valid, and the BALLOT VOTING RSID has not been disabled, and if the ballot has not been cast, the voter is provided with the options to hear information, to vote or not vote whereby the choice of (L2f1) NOT VOTE, the Voter exits the TELVALS and the telephone call is terminated by Officials; otherwise (L2f2) upon the Voter choice to VOTE, the Voter is connected by Official Voting Computer to the Telephone Voting System (TELVOTS); and (L2g) the voter is given choices to select from (such as, but not limited to: voting information, a list of CANDIDATE options, a list of PROPOSITION options) that are associated with of the BALLOT VOTING RSID; and (L2h) a unique Telephone Voting Session ID is generated, stored and correlated to the originating TELVALSID and is further correlated to the BALLOT VOTING RSID originally provided by the Voter; and (L2i) the TELVOTS provides each Voter with any number of choices such as, but not limited to: Candidates, Proposals, and information such as but not limited to: menu options to hear or receive electronically: Candidate biographies, Candidate political party policies, Ballot Proposal descriptions and information; and (L2j) TELVOTS provides the Voter with menu options to make selections of Candidate choice(s) and/or Ballot Proposal choice(s) to add to the Telephone Voting form; and (L2k) the further steps and methods whereby TELVOTS also provides Voters with Ballot processing options such as, but not limited to: SUBMIT, CANCEL, RESET, SAVE, EXIT; and (L2l) TELVOTS also provides error detection and messaging to inform Voter of errors such as, but not limited to: too many Candidates selected, invalid selection; and (L2m) the further steps and methods whereby the Voter completes and submits their Ballot for final processing to TELVOTS; and (L2n) when the Ballot Selections are processed successfully, a unique TELVOTS RECEIPT ID is generated; and (L2o) each TELVOTS RECEIPT ID is correlated to the origin TELVOTS Session ID, and further correlated to the TELVALSID that is also correlated to the BALLOT VOTING RSID and Ballot PassCode, and is further correlated to any other Voting Session Identifiers or data; and (M) further steps and methods of transmitting any number of VOTING RECEIPT CONFIRMATION documents (such as, but not limited to FIGS. 12, 13) to each voter physically as a printed document or electronically, using methods such as, but not limited to: a unique webpage to the value of the Ballot VOTING RSID accessible only with the correlated Ballot PassCode, an Official Receipt Message [such as, but not limited to: text, audio] that is sent to the Voter's provided contact such as but not limited to: voter telephone number, voter email, voter fax number, voter PDA device, voter Television, voter computer, etcetera) and thus an Official Receipt Message is sent to each voter whom has successfully submitted their ballots; and
(N) the further steps and methods whereby any type of Voting System IDs and data items such as, but not limited to: the IVOTS RECEIPT ID, TELVOTS Session ID, BALLOT VOTING RSID, BALLOT PASSCODE, BALLOT VALIDATION RSID, Voter Choices of Ballot Selection options and any number of other related information items are permanently and redundantly stored, then transmitted securely to, and received by entities such as, but not limited to: any number of Election Officials, Political Parties, Candidates, and any number of other approved third parties (such as, but not limited to, independent, non-partisan vote auditors, the news media), for actions such as, but not limited to: verification and accounting in any number of formats (such as, but not limited to: printed, Television Broadcast, electronic file (such as but not limited to: webpage, email, pdf) and (O) the further steps and methods such as but not limited to: using the unique, private Ballot RSID as part of an Internet address to organize and privately store each voter webpage, as well as tallies and summaries of voter selections) employing any processing according to, but not limited to, claim 9; and
(P) the further, optional, steps and methods for each TELEPHONE Ballot, of detecting, reporting and stopping processing of the appropriate TELEPHONE Ballot cast via TELVOTS upon detecting NOT receiving the PRINTED form of the MASTER or RECEIPT Ballot(s), or, disregarding any number of failures of delivery of any number of PRINTED MASTER or RECEIPT Ballots that are correlated to a TELEPHONE Ballot cast via the TELVOTS; and
(Q) the further steps and methods of Validation and Voting by Fax or Email applying the steps and methods such as, but not limited to: (Q1) whereby the Voter applies the modified previous steps and methods of (but not limited to) Internet and Telephone Validation and Voting, such that any number of Voters generally do, but are not limited to: (Q1a) obtains and utilizes any number of authentication certificates from any number of certificate authorities; (Q1b) any facsimile device or computer running facsimile software or document processing software or email software or any other combination of electronic devices and/or software in conjunction with any number of and types of communications system and methods according to (but not limited to) claim 9, to connect to the FAX-EMAIL Validation System (FEVALS); and (Q2a) whereupon successfully connecting, a unique FAX-EMAIL Validation ID (FEVALID) is generated and associated with the fax-email session; and (Q2b) FEVALS and/or any number of Voters obtains and utilizes any number of authentication certificates from any number of certificate authorities that is correlated to each respective, originating FEVALID; and (Q2c) the type of connection is determined (FAX or EMAIL) and is logged along with the date, time, and optionally, the Voter telephone number or email address; and (Q2d) the Voter then submits the VALIDATION RSID to the FEVALS; and (Q2e) whereafter the FEVALS receives the VALIDATION RSID, or BALLOT VOTING RSID, then employs any number of steps and methods according to (but not limited to) claim 9 along with computers running software for optical image and character recognition so as to securely receive and process the faxed or emailed data (such as, but not limited to: faxed image of validation data, email text data, email attached data file, such as, but not limited to PDF image file) to validate any number data items (such as, but not limited to RSID(s) or Security Elements, PassCodes), using any number of computers, running computer software programs such as, but not limited to: optical character recognition software; and (Q2f) the further step whereby officials transmits the validation results to the voter, using the appropriate communication method based on the type of connection or response method (EMAIL, FAX or optional VOICE MESSAGE or TEXT MESSAGE); and (Q2g) whereby the Voter then receives the validation status of the ballot, form, document or container, as to whether it is valid and if so, whether the item has already been used; and (Q2h) the steps whereby if the BALLOT VOTING RSID was provided and was determined not to have been previously used and the ballot is enabled to be cast, the Voter FAX-EMAIL is automatically connected to any number of Fax-Email Voting System (FEVOTS) computers and/or Officials and automatically exited from the Facsimile-Email Validation System (FEVALS); and (Q2i) whereby, for each BALLOT VOTING RSID received, the FEVOTS system takes actions such as, but not limited to: (Q3a) create a FAX-EMAIL Voting Session ID (FEVOTID) that is correlated to the BALLOT VOTING RSID then stored and processed according to (but limited to) claims 9; and (Q3b) FEVOTS and/or any number of Voters obtains and utilizes any number of authentication certificates from any number of certificate authorities that is correlated to each respective, originating FEVOTID; and (Q3c) the FEVOTS then provides a limited number of opportunities to enter the correct Ballot PassCode before locking out the BALLOT VOTING RSID from voting until released by Officials; (Q3d) scan the Voter email or fax message to determine whether there is an image file of the Ballot showing Voting Selections of Candidates, Proposals, or other choices, along with the Ballot Voting PassCode; and (Q3e) if any number of these items are found, then the FAX-EMAIL Voting System (FEVOTS) enacts the steps and methods of (but not limited to) claim 9, to determine if the submitted BALLOT VOTING PassCode provided is valid; (Q3f) in the case the Ballot PassCode was incorrect, the Voter is notified of denial of Voting, and no further processing of the Ballot occurs, otherwise, (Q3g) if the FEVOTS determines the Ballot PassCode DOES correlate to the BALLOT VOTING RSID, then: (Q4a) the methods whereby the FEVOTS employs any number of people, and any number of computers running software programs (such as, but not limited to optical character recognition programs) to determine exactly which candidates, proposals or other choices were selected on the Ballot; and (Q4b) the further steps and methods whereby any number of errors are detected and identified to the Voter by FEVOTS computers running software programs and any number of human Officials; and (Q4c) and any other processing according to (but not limited to) claims 9; and (Q4d) whereafter any number of corrections are made, any number of times by the Voter until ALL Ballot selections are error free; and (Q5e) whereafter the Voter submits the Ballot Selections for final IVOTS processing; (Q6f) for successful processing of all Ballot Selections, a unique FEVOTS RECEIPT ID (FEVOTRECID) is generated; and (Q6g) each FEVOTSRECID is then correlated to the FEVOTS Session ID, and is further correlated to Voting System Identifiers such as, but not limited to: BALLOT VOTING RSID, BALLOT PASSCODE, BALLOT VALIDATION RSID; and (Q5) the further steps and methods of transmitting any number of RECEIPT CONFIRMATION documents (such as, but not limited to FIGS. 12, 13) to each voter either electronically, (using methods such as, but not limited to: webpage form, email to each voter provided email, or paper receipt documents) to each voter who has successfully submitted their ballots in person or electronically; and (Q6) the further steps and methods whereby any type of Voting System ID such as, but not limited to: FEVOTS RECEIPT ID, FEVOTS Session ID, BALLOT VOTING RSID, BALLOT VOTING PASSCODE, BALLOT VALIDATION RSID, Voter Choices of Ballot Selection options and any number of other related information items are permanently and redundantly stored, then transmitted securely to, and received by, but not limited to: any number of Election Officials, Political Parties, Candidates, and any number of other approved third parties (such as, but not limited to, independent, non-partisan vote auditors, the news media), for actions such as, but not limited to: verification and accounting in any number of formats (such as, but not limited to: printed, Television Broadcast, electronic file (such as but not limited to: webpage, email, pdf, jpeg) employing any number of methods of processing according to (but not limited to) claims 9; and (Q7) the further optional steps and methods of using the unique, private Ballot RSID as part of an Internet address to organize and privately store each voter webpage, as well as all actions, tallies and summaries of voter selections; and (Q8) the further, optional, steps and methods for each FAX-EMAIL Ballot, to detect, report and (Q8a) stop processing of the appropriate FAX-EMAIL BALLOT cast via FEVOTS upon detecting any types of critical failures, such as, but not limited to: failure of timely RECEIPT of the PRINTED MASTER or RECEIPT Ballot, or, (Q8b) disregarding any number of failures of non-critical events;
(R) and the further steps and methods of each voter (R1) affixing any number of personal identifiers such as, but not limited to: their personal signature, personal verification data, private password, personal email address, and any number of date or time information to any number of paper, or electronic ballots, registration forms, data containers or any other types of documents of this invention (such as, but not limited to: MASTER voter registration form, MASTER language preference form, WHOLE ballot RECEIPT part, and (R2) further steps and methods of affixing per step (R1) either INSIDE (preferred to protect private sensitive data), or, upon the OUTSIDE (such as VALIDATION RSID), or any combination thereof per items, so as to be upon or within any DATE RETURN CONTAINER (such as, but not limited to: paper ballot return envelope, email file, webpage submission form) of this invention;
(S) and the further steps of applying any number of the aforementioned steps and methods, actions, data or results any number of times, to any number and any type of documents, forms, Ballots, Voters, Officials, or other legally recognized entities of this invention;

17. The steps and methods according to claims 1 to 16 whereby Officials provide steps and methods for each Ballot, Voter Registration, Voter Language Form, or any other items related to the Voting Session that is received, such that a certified copy is made available to at each Eligible Voter for verification and error detection, and that at least one means, method and opportunity of reporting errors is provided, and the further steps and methods whereby any number of Officials, or any number of Eligible Voters, or at least one designated representative (proxy) that possess the unique combination of the BALLOT VOTING RSID and PassCode RSID for each disputed Voter Registration or Ballot submits the Voter Registration or Ballot electronically to Officials using, but not limited to, any number or combinations of: telephones, computers, computer software programs, communications networks, fax machines or fax emulation software, cable television systems, electronic mail, optical scanners, digital cameras, as well as software and devices for detecting, correcting and recording any errors of content or transmission, or, any number of errors are reported by presentation of any number of sufficiently intact physical Ballot (WHOLE, MASTER or RECEIPT) of claim 2 or any number of Voter Registrations (WHOLE, MASTER, or RECEIPT) of claim 2, or Voter Language forms (WHOLE, MASTER, RECEIPT) of claim 2, or any number of WHOLE Ballot Containers of claim 15, by any number of Potential Voters, Eligible Voters or designated representative (proxy) Voters of claim 1, for each disputed: Voter Registration, Voter Language Form, Ballot (WHOLE, MASTER, RECEIPT), or Container (such as, but not limited to: Voter Registration Container or WHOLE Ballot Container); and the further steps and methods whereby for any number of special persons or other special legal entities (such as but not limited to news media, political candidates) that are authorized by a Voter owning an appropriate, bona fide RECEIPT, to be given access to any electronic, digital, or any other transformed version of any printable Ballot, Form, Document or Container of this invention, the Officials will provide a certified copy or representation of any number of items identified as Crucial Integrity Data Items of claim 13; and the further steps and methods, according to claims 1 to 20, of conducting a Voting Session whereby at least one Official provides each Voter with at least one method, and at least one opportunity, to verify or correct the accuracy of the Official Record of any record, tally, calculation, summary, or publication pertaining to any certified ballots or certified ballot vote selections; and the further steps and methods whereby any number of Voters, or authorized legal entities, use their RECEIPT Ballot and any number of methods to verify the accuracy of ballot processing (or any other document/record processing), such as, but not limited to: using a telephone, or, a computer connected to the Internet, any number of Voters verify or reject any Official record, tally, calculation, summary, or publication of their MASTER Ballot or voting selections made on their MASTER Ballot; and the further steps and methods whereby any number of Voters notify Officials to investigate and correct any number of errors discovered; and the further steps and methods whereby at least one Official records each Voter request to investigate, with all relevant details; and the further steps and methods whereby any number of Officials proceed to investigate whether to accept or reject each Voter request to amend any number of errors, then report to any number Voters and/or authorized legal entities, as to whether an amendment is required as requested, along with each Official findings of the investigation which is all duly recorded in the official records; and the further steps and methods if required, whereby at least one Official then amends the records, tallies, summaries, calculations, and publications to correct the records and tallies of any number of MASTER Ballots, or voter selections made on the MASTER Ballots, in accordance with the findings and the Rules of the Voting Session; and the further steps and methods whereby at least one Official verifies any amendments were completed accurately; and the further steps and methods whereby at least one Officials records in the Official records, and reports to any number of Voters or other interested legal entities as to when the amendments are completed, along with the results of the Official verification of the amendments; and the further steps and methods whereby at least one Official provides each Voter with at least one method, and at least one opportunity, to accept or reject the accuracy of any amended records, tallies, summaries, calculations, or publications; and the further steps and methods whereby any number of Voters verify correctness or report errors of any number of amendments (with or without corrective data) to any number of Officials.

18. The steps and methods according to claims 1 to 20 of this invention whereby any number of Officials and/or any number of third-parties provide services such as, but not limited to: (a) Official Computer Authentication—the steps and methods whereby any number of voters using computers, telephones or any other devices are provided with—any number of secure telephone lines, internet connections (such as, but not limited to: HTTPS, SSL) and any amount of computer authentication data issued by a third party certificate authority so as to validate the authenticity of the official computers and communications systems being used for voting and communications are legitimate and authorized for use; and the further steps and methods whereby: (b) hacker protection—the steps and methods whereby any number of official computers, telephones or any other devices and communications systems are provided with enhanced security software, equipment, personnel and procedures to ensure the electronic voting systems availability and reliability for use for authorized users, and the further steps and methods of providing any number of security measures to ensure the integrity and reliability of the voting system processes, such as, but not limited to, any number of: data transmissions, data receptions, data error corrections, document processing (such as, but not limited to: document validations, certifications, calculations and publications); and the further steps and methods whereby: (c) Internet Identity Masking—the steps and methods whereby any number of voters using computers connected to the internet for voting employ IP (internet provider) masking to hide their unique voter internet address identity by enabling each internet voter to appear as another unrelated IP address to any number of election computers; and the further steps and methods whereby IP masking employs (but is not limited to) software from third parties that connect to commercial or privately owned computer and routers so as to use the third party IP addresses as an alias for the voter, &/or connect any number of public or private masking network systems (such as but not limited to: JAP, TOR) whereby internet routers encrypt the data and originating voters IP address so as to hide the voters data from internet users and further hide each voter's original IP and computer identity from the election computer systems; and the further steps and methods whereby: (d) Voting RECEIPT Encryption—to ensure data integrity of RECEIPT ballots by reducing the possibility of falsification and ballot tampering—the steps and methods whereby any number of election computers encrypt any number of ballot RECEIPT information (such as, but not limited to: ballot RSID, voter selection validation codes, RECEIPT sequence ID, RECEIPT validation code, date and time stamp) so that any number of public encrypted ballot RECEIPT codes (PUB-EBRC) are created to obscure the original ballot RECEIPT voting information by using at least one private encryption digital number (a private encryption key: PRI-KEY) and a private encryption algorithm (PRI-ENALG), and the further steps and methods whereby each original ballot RECEIPT information is recoverable from the correlated public encrypted ballot RECEIPT code (PUB-EBRC) by applying manually or by computer, the correlated private RECEIPT encryption key (PRI-KEY) and the correlated private RECEIPT encryption algorithm (PRI-ENALG) to the correlated public encrypted ballot RECEIPT code (PUB-EBRC);
and the further steps and methods, such as but not limited to: (i) whereby any number of public encrypted ballot RECEIPT codes (PUB-EBRC) are each correlated to their respective ballot RSID;
(ii) whereby any number of public encrypted ballot RECEIPT codes (PUB-EBRC) are optionally printed on the face of the ballot; (iii) whereby any number of ballot information data elements are NOT printed on each ballot to preserve privacy of data (such as, but not limited to: ballot RSID);
(iv) whereby any number of private encryption algorithms (PRI-ENALG) of this step are unique overall this invention and at least at least one private encryption key (PRI-KEY) is unique for each PRI-ENALG of this invention; (v) whereby any number of public encryption algorithms (PUB-ENALG) and public encryption keys (PUB-KEY) are provided and employed to enable general public validation of ballot RECEIPTs data and ballot RECEIPT codes without revealing the private encryption algorithms (PRI-ENALG) or private encryption keys (PRI-KEY); (vi) whereby to facilitate machine scanning, any number of barcodes and/or other symbolic marking codes are generated and correlated to any number of ballot information data elements and any number of public encrypted ballot RECEIPT codes, then printed on or otherwise incorporated into the ballot RECEIPT;
(vii) whereby to facilitate machine scanning, any number of geometric shapes, lines and/or other symbolic marking codes to be used for orientation or alignment are generated then printed on, or otherwise incorporated into the ballot RECEIPT; (viii) and the further steps of any combination of any number of other steps, methods and processes employing people, procedures, software or equipment so as to ensure accuracy, integrity and availability of the voting system.

19. The inventor also claims the further steps, and methods, embodiments of this invention are to include any further supplemental methods such as, but not limited to: providing, tracking, auditing, tallying and reporting any type of and any number of RSID's according to (but not limited to) claim 3, correlating any number of barcodes or other symbolic codes to each Random RSID, any number of Security Elements according to (but not limited to) claim 6, any number of steps and methods of processing according to (but not limited to) claims 1 to 20, to any number of any types of objects (such as, but not limited to: documents, monetary currency, money orders, vehicles, electronic mail, data containers, electronic files, database system files and records, n-tree electronic data storage structures, sparse matrices, electronic data search methods, internet webpages, industrial products) in any number of formats (such as, but not limited to: electronic file, internet webpage, printed paper, embossed plastic) so as to enable any number and any type of actions—such as, but not limited to: unique object registration, object authentication, document tracking, document encryption and decryption, item auditing and inventory, determination of object status, uniquely labeling recorded events, statistical analysis (such as, but not limited to: locations, timing, frequency), uniquely labeling messages, encrypting and decrypting messages, uniquely certifying reports and internal contents, uniquely identifying industrial products.

20. The steps and methods according to claims 1 to 19 of this invention whereby: (i) any number of Officials generate any number of internet webpages correlated to each voter registration via at least one Voter Registration ID; and (ii) the further steps and methods whereby any number of Officials generate any number of internet web pages correlated to each MASTER Ballot via one unique Ballot Voting RSID or SID; and (iii) the further steps and methods whereby a voter can use any number of electronic devices of this invention (such as, but not limited to: computers, cell phones, PDA's) the Internet and/or any number of other communications methods of this invention to securely access, input, verify, validate, review, amend, print and save copies of, and/or securely submit—personal information to complete at least one voter registration, and any number of other forms or documents pertaining to the voting session and voter, (iv) and the further steps and methods of submitting privately and securely to Officials for evaluation any items of prior sub-claim (18.iii); (v) and the further steps and methods whereby a voter may apply the same or similar electronic devices and communications systems of claims 1 to 19 of this invention so as to securely access, verify, validate, input, amend, review, print or save copies of, and/or securely submit any number of MASTER Ballots to Officials by providing all necessary data (such as, but not limited to: Ballot Voting RSID, Ballot PassCode) relevant to Ballot status (such as, but not limited to: ready2vote, votedOK, Cancelled) so as to enable reviewing or casting of any number of ballots for each registered voter, proxy or appointees; (vi) and the further steps and methods according to claims 1 to 19 whereby Officials and Voters repeat any number of steps 1 to 19, any number of times, for any number of voting entities, non-voting entities or officials until satisfactorily completing all requirements according to Voting Session Rules; (vii) and the further steps and methods according to claims 1 to 19 whereby Officials then verify, validate, certify then finalize then publish the final amended records, tallies, calculations, summaries and reports pertaining Voter Registrations, Ballots, and any other relevant aspect of the Voting Session, and (viii) the further steps and methods of providing any number of information items such a, but not limited to: list of all Eligible Voters, list of all Ballot Voting RSIDs) to Voters, political candidates, and interested third parties via methods (such as, but not limited to: internet webpages, cell phone text messages, email, TV News, newspapers); (ix) and the further steps whereby at least one Official declares the Voting Session as completed.
